(19) United States
(12) Patent Application Publication
(10) Pub. No.: US 2006/0147852 A1
(43) Pub. Date: Jul. 6, 2006

(54) Photothermographic material

(76) Inventors: Tomoyuki Ohzeki, Kanagawa (JP); Hiroyuki Mifune, Kanagawa (JP); Katsuyuki Watanabe, Kanagawa (JP); Eiichi Okutsu, Kanagawa (JP)

Correspondence Address: TAIYO CORPORATION, 401 HOLLAND LANE, #407, ALEXANDRIA, VA, 22314, US

(21) Appl. No.: 10/771,674

(22) Filed: Feb. 5, 2004

(30) Foreign Application Priority Data
Feb. 6, 2003 (JP) 2003-29780
Feb. 21, 2003 (JP) 2003-43851

(51) Int. Cl. G03C 1/00

(52) U.S. Cl. 430/619

(57) ABSTRACT

A photothermographic material including, on a support, a photosensitive silver halide, a non-photosensitive organic silver salt, a reducing agent and a binder, wherein the photothermographic material contains a compound having a group adsorptive to silver halide and a reducible group or a precursor of the compound, and satisfies one of the following conditions: 1) a silver behenate content of the non-photosensitive organic silver salt is at least 30% by mole and less than 80% by mole, and the binder has a glass transition temperature (Tg) of 45° C. or higher; or 2) the photosensitive silver halide comprises iridium.

### CROSS-REFERENCE TO RELATED APPLICATION

This application claims priority under 35 USC 119 from Japanese Patent Application Nos. 2003-29780 and 2003-43851, the disclosures of which are incorporated by reference herein.

### BACKGROUND OF THE INVENTION

1. Field of the Invention

The present invention relates to a photothermographic material, and more particularly, to a photothermographic material that has a high sensitivity with a low degree of fogging and is excellent in image stability.

2. Description of the Related Art

In the medical imaging field and the graphic arts field, there has been, in recent years, a strong desire for a dry photographic process from the viewpoints of environmental conservation and space saving. Further, the development of digitization in these fields has resulted in the rapid development of systems in which image information is captured and stored in a computer, whereafter the image information is processed, if necessary, by the computer which outputs the image information through communication to a desired location, and the image information is further output, at the site, onto a photosensitive material using a laser image setter or a laser imager, followed by development thereof to form an image on the photosensitive material. It is required that the photosensitive material be able to record an image under exposure to a laser with a high intensity and that a clear black-tone image with a high resolution and sharpness can be formed. While various kinds of hard copy systems using a pigment or a dye such as an ink-jet printer or an electrophotographic system have been distributed as a general image forming system using such a digital imaging recording material, images in the digital imaging recording material obtained by such a general image forming system are insufficient in terms of image qualities required for medical images. To facilitate diagnosis, image qualities such as sharpness, granularity, gradation, tone and high recording speed (sensitivity) are required. However, digital imaging recording materials have not reached a level at which they can replace medical silver salt film processed by conventional wet development.

Thermographic systems using organic silver salts are described in, for example, U.S. Pat. Nos. 3,152,904 and 3,457,075; and D. Klosterboer, “Thermally Processed Silver Systems”, in “Imaging Processes and Materials” coedited by J. Sturge, V. Walworth and A. Shepp, Neblette 8th Ed., Chapter 9, pp. 279-291, 1989, the disclosures of which are incorporated by reference herein.

Generally, a photothermographic material, in particular, comprises an image forming layer in which a photosensitive silver halide, a reducing agent, a reducible silver salt (for example, an organic silver salt) and if necessary, a toner controlling a color tone of developed silver are dispersed in a binder matrix.

A black-toned silver image is formed in a photothermographic material by heating the photothermographic material to a high temperature (for example, 80° C. or higher) after imagewise exposure to cause an oxidation-reduction reaction between the silver halide or the reducible silver salt (functioning as an oxidizing agent) and the reducing agent. The oxidation-reduction reaction is accelerated by a catalytic action of a latent image generated on the silver halide by exposure. As a result, a black-toned silver image is formed in an exposed region. Such a photothermographic material is disclosed in the literature including, for example, U.S. Pat. No. 2,910,377 and Japanese Patent Application Publication (JP-B) No. 43-4924.

On the other hand, a gas laser (Ar⁺, He—Ne, or He—Cd), a YAG laser, a dye laser, a laser diode or the like is generally used as a laser beam. A laser diode and a second harmonic generation element or the like can also be used. With regard to an emitting wavelength, lasers in a wide wavelength range from the blue region to the infrared region are used. Among these, an infrared laser diode is particularly suitable for design of a laser image output system which is inexpensive and can obtain stable light emission, and which, in particular, is compact, excellent in operability, and not restricted with respect to an installation location. For this reason, the photothermographic material is required to have infrared sensitivity. Various efforts have been made for enhancing infrared sensitivity. However, infrared spectrum sensitization has a problem in that it is generally unstable and decomposes during storage of the photosensitive material, leading to decrease in sensitivity, and there is an increased demand for improvement in preservation stability, together with increased sensitivity.

Recently, a blue laser diode has been developed, enabling image recording with high precision, and stable output can be obtained with increased recording density and long life. Therefore, demand for the blue laser diode is expanding and a photothermographic recording material compatible with the blue laser diode is required.

Since the above-described thermographic system using an organic silver salt has no fixing step, there has been a considerable problem in image stability after development, particularly with respect to worsening of print-out when exposed to light. As means for improving the print-out, a method in which silver iodide formed through conversion of an organic silver salt is employed is disclosed in U.S. Pat. No. 6,143,488 and European Patent (EP) No. 0922995. As to other photosensitive materials using silver iodide, description thereof is given in JP-B No. 58-118639 and U.S. Pat. No. 6,274,297. However, in all of these, neither a sufficient sensitivity nor a sufficient fogging level is achieved, leading to a poor photosensitive material which is not suitable for practical use.

There has been a demand for higher sensitivity in a photothermographic material using an organic silver salt, in order to increase an image recording speed, and there has also been a demand for reduced fogging to improve the capacity for medical diagnosis. Further, it is extremely important to improve dark stability of a thermally developed image in order for it to replace medical silver salt film processed by conventional wet development.

### SUMMARY OF THE INVENTION

A first aspect of the invention provides a photothermographic material comprising, on a support, at least a photosensitive silver halide, a non-photosensitive organic silver salt, a reducing agent and a binder, wherein the photothermographic material contains a compound having a group adsorptive to silver halide and a reducible group, or a precursor of the compound, a silver behenate content of the non-photosensitive organic silver salt is at least 30% by mole and less than 80% by mole, and the binder has a glass transition temperature (Tg) of 45° C. or higher.

A second aspect of the invention provides a photothermographic material containing, on a support, an image forming layer comprising at least a photosensitive silver halide, a non-photosensitive organic silver salt, a reducing agent and a binder, wherein the photothermographic material contains a compound having an adsorptive group and a reducible group, or a precursor of the compound, and the photosensitive silver halide comprises iridium.

### DETAILED DESCRIPTION OF THE INVENTION

The photothermographic material of the invention has an image forming layer comprising at least a photosensitive silver halide, a non-photosensitive organic silver salt, a reducing agent and a binder. The image forming layer or the layer adjacent to the image forming layer comprises a compound having an adsorptive group and a reducible group or a precursor of the compound.

The image forming layer may be a single layer or may be constituted of a plurality of layers. Further, the image forming layer may carry thereon an intermediate layer or a surface protective layer, or may carry a back layer, a back protective layer and the like on the opposite surface.

The constitutions and preferable components of these layers will be illustrated in detail below.

1. Compound Having Adsorptive Group and Reducible Group

The photothermographic material of the present invention is characterized by comprising a compound having an adsorptive group and a reducible group in a molecule. It is preferred that the compound having an adsorptive group and a reducible group used in the invention is represented by the following formula (I).
A-(W)n-B Formula (I)

In formula (I), A represents a group capable of adsorption to a silver halide (hereafter, it is called an adsorptive group) and W represents a divalent connecting group and n represents 0 or 1 and B represents a reducible group.

Next, formula (I) is explained in more detail.

In formula (I), the adsorptive group represented by A is a group to adsorb directly to a silver halide or a group to promote adsorption to a silver halide. As typical examples, a mercapto group (or the salt thereof), a thione group (—C(═S)—), a nitrogen atom, a heterocyclic ring containing at least one atom selected from a nitrogen atom, a sulfur atom, a selenium atom and a tellurium atom, a sulfide group, a disulfide group, a cationic group, an ethynyl group and the like are described.

The mercapto group as an adsorptive group means a mercapto group (and the salt thereof) itself and simultaneously more preferably represents a heterocyclic ring group or an aryl group or an alkyl group substituted by at least one mercapto group (or the salt thereof). Herein, as the heterocyclic ring group, a monocyclic or a condensed aromatic or nonaromatic heterocyclic ring group having at least a 5 to 7 membered ring, e.g., an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group and the like are described. A heterocyclic ring having quarternalized nitrogen atom may also be adopted, wherein a mercapto group as a substituent may dissociate to form a mesoion. As examples of such heterocyclic ring group, an imidazolium ring group, a pyrazolium ring group, a thiazolium ring group, a triazolium ring group, a tetrazolium ring group, a thiadiazolium ring group, a pyridinium ring group, a pyrimidinium ring group, a triazinium ring group and the like are described and among them, a triazolium ring group (e.g., a 1,2,4-triazolium-3-thiolate ring group) is preferable. As an aryl group, a phenyl group or a naphthyl group is described. As an alkyl group, a straight chain, branched chain or cyclic alkyl group having 1 to 30 carbon atoms is described. As a counter ion, whereby a mercapto group forms the salt thereof, a cation such as an alkali metal, an alkali earth metal, a heavy metal and the like (Li⁺, Na⁺, K⁺, Mg²⁺, Ag⁺, Zn²⁺ and the like), an ammonium ion, a heterocyclic ring group having quaternalized nitrogen atom, a phosphonium ion and the like are described. Further, the mercapto group as an adsorptive group may become a thione group by a tautomerization. For example, a thioamide group (herein —C(═S)—NH— group) and the group containing the said thioaminde group as a partial structure, namely a chain or a cyclic thioamide, thioureide, thiourethane or dithiocarbanic ester group and the like are described. Herein, as cyclic examples, a thiazolidine-2-thione group, an oxazolidine-2-thione group, a 2-thiohydantoin group, a rhodanine group, an isorhodanine group, a thiobarbituric acid group, a 2-thioxo-oxazolidine-4-one group and the like are described.

The thione group as an adsorptive group may also contain a chain or a cyclic thioamide group, a thioureido group, a thiouretane group or a thioester group which can not tautomerize to a mercapto group (having no hydrogen atom on the α-position of a thione group) with containing a mercapto group capable to become a thion group by tautomerization.

The heterocyclic ring group containing at least one atom selected from a nitrogen atom, a sulfur atom, a selenium atom and a tellurium atom represents a nitrogen atom containing heterocyclic ring group having —NH— group, as a partial structure of hetero ring, capable to form a silver iminate (>NAg) or a heterocyclic ring group, having —S— group, —Se— group, —Te— group or ═N— group as a partial structure of hetero ring, and capable to coordinate to a silver ion by a chelate bonding. As the former examples, a benzotriazole group, a triazole group, an indazole group, a pyrazole group, a tetrazole group, a benzimidazole group, a purine group and the like are described. As the latter examples, a thiophene group, a thiazole group, a benzoxazole group, a thiadiazole group, an oxadiazole group, a triazine group, a selenoazole group, a benzoselenazole group, a tellurazole group, a benzotellurazole group and the like are described. The former is preferable.

The sulfide group or disulfide group as an adsorptive group contains all groups having “—S—” or “—S—S—” as a partial structure, but the group having alkyl (or an alkylene)-X-alkyl (or alkylene), aryl (or arylene)-X— alkyl (or alkylene), and “aryl (or arylene)-X— aryl (or arylene)”, as a partial structure are preferably, wherein X represents “—S— group” or “—S—S— group”. Further, these sulfide groups or disulfide groups may form a cyclic structure. As typical examples of a cyclic structure formation, the group containing a thiorane ring, a 1,3-dithiorane ring, a 1,2-dithiorane ring, a thiane ring, a dithiane ring, a thiomorphorine ring and the like are described. As a sulfide group, the group having “alkyl (or alkylene)-S-alkyl (or alkylene)” as a partial structure and as a disulfide group, a 1,2-dithiorane ring group are particularly preferably described.

The cationic group as an adsorptive group means the group containing a quaternalized nitrogen atom, such as an ammonio group or a nitrogen containing heterocyclic ring group containing a quaternalized nitrogen atom. Herein, an ammonio group means a trialkylammonio group, a dialkylarylammonio group, an alkyldiarylammonio group, such as a benzyldimethylammonio group, a trihexylammonio group, a phenyldiethylammonio group and the like are described. As examples of the heterocyclic ring group containing a quaternalized nitrogen atom, a pyridinio group, a quinolinio group, an isoquinolinio group, an imidazolio group and the like are described. A pyridinio group and an imidazolio group are preferable and a pyridinio group is particularly preferable. These nitrogen containing heterocyclic ring groups containing a quaternalized nitrogen atom may have any substituent, but in the case of a pyridinio group and an imidazolio group, an alkyl group, an aryl group, an acylamino group, a chlorine atom, an alkoxycarbonyl group, a carbamoyl group and the like are preferably as a substituent and in a pyridinio group, a phenyl group is particularly preferable as a substituent.

The ethynyl group as an adsorptive group means —C≡CH group and the said hydrogen atom may be substituted.

The adsorptive group described above may have any substituent. As examples of a substituent, a halogen atom (a fluorine atom, a chlorine atom, a bromine atom or an iodine atom), an alkyl group (a straight chain alkyl group, a branched chain alkyl group, a cyclic alkyl group and a bicyclic alkyl group and an active methine group are contained), an alkenyl group, an alkynyl group, an aryl group, a heterocyclic ring group (irrelevant to a substituting position), an acyl group, an alkoxycarbonyl group, an aryloxycarbonyl group, a heterocyclic oxycarbonyl ring group, a carbamoyl group, a N-hydroxycarbamoyl group, a N-acylcarbamoyl group, a N-sulfonylcarbamoyl group, a N-carbamoylcarbamoyl group, a thiocarbamoyl group, a N-sulfamoylcarbamoyl group, a carbazoyl group, a carboxy group or a salt thereof, an oxalyl group, an oxamoyl group, a cyano group, a carbonimidoyl group, a formyl group, a hydroxy group, an alkoxy group (a group containing an ethyleneoxy group or a propyleneoxy group as repeating unit is contained), an aryloxy group, an oxy group substituted to heterocyclic ring, an acyloxy group, (an alkoxy or an aryloxy)carbonyloxy group, a carbamoyloxy group, a sulfonyloxy group, an amino group, (an alkyl, an aryl or a heterocyclic ring)amino group, an acylamino group, a sulfonamide group, an ureido group, a thioureido group, a N-hydroxyureido group, an imide group, (an alkoxy or aryloxy)carbonylamino group, a sulfamoylamino group, a semicarbazide group, a thiosemicarbazide group, a hydrazino group, an ammonio group, an oxamoylamino group, a N-(alkyl or aryl)sulfonylureido group, a N-acylureido group, a N-acylsulfamoylamino group, a hydroxyamino group, a nitro group, a heterocyclic ring group containing quaternalized nitrogen atom (e.g., a pyridinio group, an imidazolio group, a quinolinio group, an isoquinolinio group), an isocyano group, an imino group, a mercapto group, (an alkyl, an aryl or a heterocyclic ring)thio group, (an alkyl, an aryl or a heterocyclic ring)dithio group, (an alkyl, or an aryl)sulfonyl group, (an alkyl or an aryl)sulfinyl group, a sulfo group and the salt thereof, a sulfamoyl group, a N-acylsulfamoyl group, a N-sulfonylsulfamoyl group and a salt thereof, a phosphino group, a phosphinyl group, a phosphinyloxy group, a phosphinylamino group, a silyl group and the like are described. Herein, the active methine group means a mathine group subsutituted by two electron-withdrawing group, wherein the electron-withdrawing group means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group and a carbonimidoyl group. Herein, two electron-withdrawing groups may bind each other to form a cyclic structure. The salt means a cation such as from an alkali metal, an alkali earth metal and a heavy metal and an organic cation such as an ammonium ion, a phosphonium ion and the like.

Further, as typical examples of an adsorptive group, the compounds described in pages 4 to 7 in the specification of JP-A No. 11-95355 are described.

As an adsorptive group represented by A in general formula (I), a heterocyclic ring group substituted by a mercapto group (e.g., a 2-mercaptothiadiazole group, a 3-mercapto-1,2,4-triazole group, a 5-mercaptotetrazole group, a 2-mercapto-1,3,4-oxadiazole group, a 2-mercaptobenzothiazole group, a 2-mercaptobenzimidazole group, a 1,5-dimethyl-1,2,4-triazorium-3-thiolate group and the like), a heterocyclic ring group substituted by two mercapto groups (e.g., a 2,4-dimercaptopyrimidine group, a 2,4-dimercatotriazine group, a 3,5-dimercapto-1,2,4-triazole group, a 2,5-dimercapto-1,3-thiazole group and the like) or a nitrogen atom containing heterocyclic ring group having a —NH— group capable to form an imino-silver (>NAg) as a partial structure of heterocyclic ring (e.g., a benzotriazole group, a benzimidazole group, an indazole group and the like) are more preferably and a heterocyclic ring group substituted by two mercapto groups is particularly preferable.

In formula (I), W represents a divalent connection group. The said connection group may be any divalent connection group, as far as it does not give a bad effect toward a photographic property. For example, a divalent connection group composed of a carbon atom, a hydrogen atom, an oxygen atom a nitrogen atom and a sulfur atom can be used. As typical examples, an alkylene group having 1 to 20 carbon atoms (e.g., a methylene group, an ethylene group, a trimethylene group, a tetramethylene group, a hexamethylene group and the like), an arylene group having 6 to 20 carbon atoms (e.g., a phenylene group, a nephthylene group and the like), —CONR₁—, —SO₂NR₂—, —O—, —S—, —NR₃—, —NR₄CO—, —NRSO₂—, —NR₆CONR₇—, —COO—, —OCO— and the combination of these connecting groups are described. Herein, R₁, R₂, R₃, R₄, R₅, R₆ and R₇ independently represent a hydrogen atom, an aliphatic group and an aryl group. As preferred aliphatic group represented by R₁, R₂, R₃, R₄, R₅, R₆ and R₇, a straight chain, branched chain or cyclic alkyl group, an alkenyl group, an alkynyl group, an aralkyl group having 1 to 30 carbon atoms, particularly 1 to 20 carbon atoms (e.g., a methyl group, an ethyl group, an isopropyl group, a t-butyl group, a n-octyl group, a n-decyl group, a n-hexadecyl group, a cyclopropyl group, a cyclopentyl group, a cyclohexyl group, an aryl group, a 2-butenyl group, a 3-pentenyl group, a propargyl group, a 3-pentynyl group, a benzyl group and the like) are described. In formula (I), as an aryl group represented by R₁, R₂, R₃, R₄, R₅, R₆ and R₇, a monocyclic or condensed ring aryl group having 6 to 30 carbon atoms is preferable and that having 6 to 20 carbon atoms is more preferable. For example, a phenyl group and a naphthyl group and the like are described. The above substituent represented by R₁, R₂, R₃, R₄, R₅, R₆ and R₇ may have still more any substituent, whereby the substituent defined as similar to the substituent for an adsorptive group described above.

In formula (I), a reducible group represented by B represents the group capable to reduce a silver ion. As the examples, a formyl group, an amino group, a triple bond group such as an acetylene group, a propargyl group and the like, an alkylmercapto group or an arylmercapto group, hydroxylamines, hydroxamic acids, hydroxyureas, hydroxyurethanes, hydroxysemicarbazides, reductones (reductone derivatives are contained), anilines, phenols (chroman-6-ols, 2,3-dihydrobenzofuran-5-ols, aminophenols, sulfonamidophenols and polyphenols such as hydroquinones, catechols, resorcinols, benzenetriols, bisphenols are contained), hydrazines, hydrazides and phenidones can be described.

In formula (I), a preferable reducible group represented by B is the residue derived from the compound represented by general fomula (B1) to (B13).

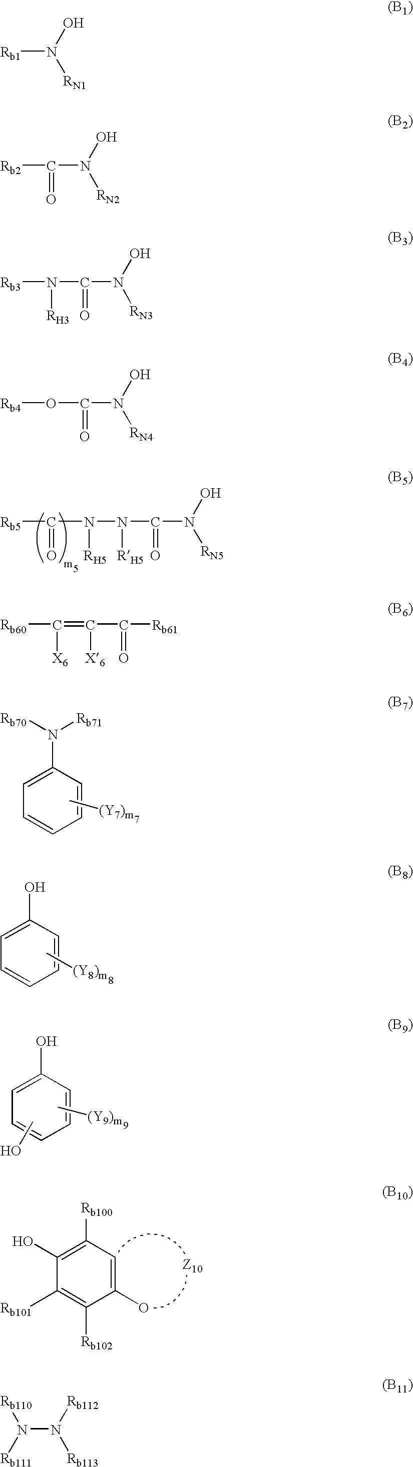

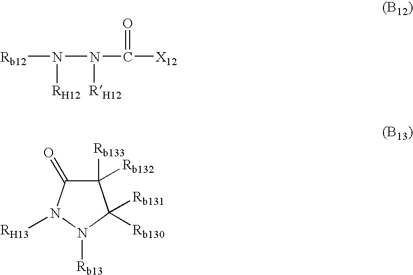

In formulae (B1) to (B13), R_{b1}, R_{b2}, R_{b3}, R_{b4}, R_{b5}, R_{b70}, R_{b71}, R_{b110}, R_{b111}, R_{b112}, R_{b113}, R_{b12}, R_{b13}, R_{N1}, R_{N2}, R_{N3}, R_{N4}, and R_{N5} represent a hydrogen atom, an alkyl group, an aryl group or a heterocyclic ring group; and R_{H3}, R_{H5}, R′_{H5}, R_{H12}, R′_{H12}, and R_{H13} represent a hydrogen atom, an alkyl group, an aryl group, an acyl group, an alkylsulfonyl group or an arylsulfonyl group; and among them, R_{H3} may still more represent a hydroxy group. R_{b100}, R_{b101}, R′_{b102} and R_{b130} to R_{b133} represent a hydrogen atom or a substituent. Y₇ and Y₈ represent a substituent except for a hydroxy group and Y₉ represents a substituent and m₅ represents 0 or 1 and m₇ represents an integer from 0 to 5 and m₈ represents an integer from 1 to 5 and m₉ represents an integer from 0 to 4. Y₇, Y₈ and Y₉ may still more represent an aryl group condensed to a benzene ring (e.g., a benzene condensed ring) and further more may have a substituent. Z₁₀ represents a non-metal atomic group capable to form a ring and X12 represents a hydrogen atom, an alkyl group, an aryl group, a heterocyclic ring group, an alkoxy group, an amino group (an alkylamino group, an arylamino group, an amino group substituted to a heterocyclic ring or a cyclic amino group are contained) and a carbamoyl group.

In formula (B6), X₆ and X′₆ each represent a hydroxy group, an alkoxy group, a mercapto group, an alkylthio group, an amino group (an alkylamino group, an arylamino group, an amino group substituted to a heterocyclic ring group or a cyclic amino group are contained), an acylamino group, a sulfonamide group, an alkoxycarbonylamino group, an ureido group, an acyloxy group, an acylthio group, an alkylaminocarbonyloxy group or an arylaminocarbonyloxy group. R_{b60} and R_{b61} represent an alkyl group, an aryl group, an amino group, an alkoxy group and an aryloxy group and R_{b60} and R_{b61} may bind each other to form a cyclic structure.

In the explanation of each group in above formula (B1) to (B13), an alkyl group means a straight chain, branched chain or cyclic and a substituted or unsubstituted alkyl group having 1 to 30 carbon atoms and an aryl group means a monocyclic or condensed and a substituted or unsubstituted aromatic alicyclic ring such as a phenyl group and a naphthyl group and a heterocyclic ring group means an aromatic or nonaromatic and a monocyclic or condensed and a substituted or unsubstituted heterocyclic ring group having at least one hetero atom.

And the substituent described in the explanation of each substituent in formula (B1) to (B13) means the same as the substituent for an adsorptive group described above. These substituents may be more substituted by these substituents.

In formula (B1) to (B5), R_{N1}, R_{N2}, R_{N3}, R_{N4} and R_{N5} are preferably a hydrogen atom or an alkyl group and herein, an alkyl group is preferably a straight, branched or cyclic and a substituted or unsubstituted alkyl group having 1 to 12 carbon atoms and more preferably a straight, branched or cyclic and a substituted or unsubstituted alkyl group having 1 to 6 carbon atoms such as a methyl group, an ethyl group, a propyl group, a benzyl group and the like.

In formula (B1), R_{b1} is preferably an alkyl group and a heterocyclic ring group and herein, an alkyl group means a straight, branched or cyclic and a substituted or unsubstituted alkyl group and is preferably an alkyl group having 1 to 30 carbon atoms and more preferably an alkyl group having 1 to 8 carbon atoms. A heterocyclic ring group means a 5 or 6 membered monocyclic or condensed ring and an aromatic or nonaromatic heterocyclic ring group and may have a substituent. As a heterocyclic ring group, an aromatic heterocyclic ring group is preferable, for examples, a pyridine ring group, a pyrimidine ring group, a triazine ring group, a thiazole ring group, a benzothiazole ring group, an oxazole ring group, a benzoxazole ring group, an imidazole ring group, a benzimidazole ring group, a pyrazole ring group, an indazole ring group, an indole ring group, a purine ring group, a quinoline ring group, an isoquinoline ring group, a quinazoline ring group and the like are described. Especially, a triazine ring group and a benzothiazole ring group are preferable. The case, wherein an alkyl group or a heterocyclic ring group represented by R_{b1} further has one or two or more of —NH(R_{N1})OH group as its substituent is one of preferred embodiments of the compound represented by formula (B1).

In formula (B2), R_{b2} is preferably an alkyl group, an aryl group or a heterocyclic ring group and more preferably is an alkyl group or an aryl group. Preferred range of alkyl group is similar to that in the explanation of R_{b1}. As an aryl group, a phenyl group or a naphthyl group is preferable and a phenyl group is particularly preferable and may have a substituent. The case, wherein the group represented by R_{b2} further has one or two or more of —NH(R_{N2})OH group as its substituent is one of preferred embodiments of the compound represented by formula (B2).

In formula (B3), R_{b3} is preferably an alkyl group or an aryl group, wherein a preferred range thereof is similar to that in the explanation of R_{b1} and R_{b2}. R_{H3} is preferably a hydrogen atom, an alkyl group or a hydroxy group and more preferably a hydrogen atom. The case, wherein the group represented by R_{b3} further has one or two or more of —NH(R_{N3})CON(R_{N3})OH group as its substituent is one of preferred embodiments of the compound represented by formula (B3). And R_{b3} and R_{N3} may bind each other to form a cyclic structure (preferably a 5 or 6 membered saturated heterocyclic ring).

In formula (B4), R_{b4} is preferably an alkyl group, wherein a preferred range thereof is similar to that in the explanation of R_{b1}. The case where the group represented by R_{b4} further has one or two or more of —OCON(R_{N4})OH group as its substituent is one of preferred embodiments of the compound represented by formula (B4).

In formula (B5), R_{b5} preferably is an alkyl group or an aryl group and more preferably is an aryl group, wherein a preferred range is similar to that in the explanation of R_{b1} and R_{b2}. R_{H5} and R′_{H5} are preferably a hydrogen atom or an alkyl group and more preferably a hydrogen atom.

In formula (B6), it is preferred that R_{b60} and R_{b61} bind each other to form a cyclic structure. The cyclic structure formed herein is 5 to 7 membered nonaromatic carbon ring or a heterocyclic ring and may be monocyclic or condensed ring. As typical examples of preferred cyclic structure, a 2-cyclopentene-1-one ring, a 2,5-dihydrofurane-2-one ring, a 3-pyrroline-2-one ring, a 4-pyrazoline-3-one ring, a 2-cyclohexene-1-one ring, a 4-pyrazoline-3-one ring, a 2-cyclohexene-1-one ring, a 5,6-dihydro-2H-pyrane-2-one ring, a 5,6-dihydro-2-pyridone ring, a 1,2-dihydronaphthalene-2-one ring, a cumarin ring (a benzo-α-pyrane-2-one ring), a 2-quinolone ring, a 1,4-dihydronaphthalene-1-one ring, a chromone ring (a benzo-γ-pyrane-4-one ring), a 4-quinolone ring, an indene-1-one ring, a 3-pyrroline-2,4-dione ring, an uracil ring, a thiouracil ring, a dithiouracil ring and the like are described and a 2-cycolopentene-1-one ring, a 2,5-dihydrofurane-2-one ring, 3-pyrroline-2-one ring, a 4-pyrazoline-3-one ring, a 1,2-dihydronaphthalene-2-one ring, a cumarin ring (a benzo-α-pyrane-2-one ring), a 2-quinolone ring, a 1,4-dihydronaphthalene-1-one ring, a chromone ring (a benzo-γ-pyrane-4-one ring), a 4-quinolone ring, an indene-1-one ring, a dithiouracil ring and the like are more preferably and a 2-cycolopentene-1-one ring, a 2,5-dihydrofurane-2-one ring, a 3-pyrroline-2-one ring, an indene-1-one ring and a 4-pyrazoline-3-one ring are still more preferable.

When X₆ and X′₆ represent a cyclic amino group, a cyclic amino group means a nonaromatic nitrogen atom containing heterocyclic ring group bound at a nitrogen atom, e.g., a pyrrolidino group, a pyperidino group, a pyperadino group, a morphorino group, a 1,4-thiazine-4-yl group, a 2,3,5,6-tetrahydro-1,4-thiazine-4-yl group, an indolyl group and the like are included.

As X₆ and X′₆, a hydroxy group, a mercapto group, an amino group (an alkylamino group, an arylamino group or a cyclic amino group are contained), an acylamino group, a sulfonamide group, or an acyloxy group and an acylthio group are preferable and a hydroxy group, a mercapto group, an amino group, an alkylamino group, a cyclic amino group, a sulfonamide group, an acylamino group or an acyloxy group are more preferable and a hydroxy group, an amino group, an alkylamino group and a cyclic amino group are particularly preferable. Further, it is preferred that at least one of X₆ and X′₆ is a hydroxy group.

In formula (B7), R_{b70} and R_{b71} preferably are a hydrogen atom, an alkyl group or an aryl group and more preferably an alkyl group. The preferred range of alkyl group is similar to that in the explanation of R_{b1}. R_{b70} and R_{b71} may bind each other to form a cyclic structure (e.g., a pyrrolidine ring, a pyperidine ring, a morphorino ring, a thiomorphorino ring and the like). As the substituent represented by Y₇, an alkyl group (that preferred range is the same as the explanation of R_{b1}), an alkoxy group, an amino group, an acylamino group, a sulfonamide group, an ureido group, an acyl group, an alkoxycarbonyl group, a carbamoyl group, a sulfamoyl group, a chlorine atom, a sulfo group or the salt thereof, a carboxy group or the salt thereof and the like are preferable and m₇ preferably represents integer from 0 to 2.

In formula (B8), m₈ preferably is integer from 1 to 4 and the plural Y₈ may be same or different. Y₈ in the case, wherein m₈ is 1 or at least one of the plural Y₈ in the case, wherein m₈ is 2 or more, is preferably an amino group (an alkylamino group and an arylamino group are contained), a sulfonamide group or an acylamino group. In the case, wherein m₈ is 2 or more, remaining Y₈ is preferably a sulfonamide group, an acylamino group, an ureido group, an alkyl group, an alkylthio group, an acyl group, an alkoxycarbonyl group a carbamoyl group, a sulfo group or the salt thereof, a carboxy group or the salt thereof, a chlorine atom and the like. Herein, in the case, wherein o′-(or p′-)hydroxyphenylmethyl group (may have more substituents) is substituted at the ortho or para position toward a hydroxy group as the substituent represented by Y₈, these compounds represent a compound group generally called as a bisphenol. The said compound is one of the preferred examples represented by formula (B8) too. Further, the case, wherein Y₈ represent a benzene condensed ring and results to represent naphthols for formula (B8) is very preferable.

In formula (B9), the substitution position of two hydroxy groups may be each other an ortho position (catechols), a meta position (resorcinols) or a para position (hydroquinones). m₉ is preferably 1 or 2 and the plural Y₉ may be the same or different. As preferred substituents represented by Y₉, a chlorine atom, an acylamino group, an ureido group, a sulfonamide group, an alkyl group, an alkylthio group, an alkoxy group, an acyl group, an alkoxycarbonyl group, a carbamoyl group, a sulfo group or the salt thereof, a carboxy group or the salt thereof, a hydroxy group, an alkylsulfonyl group, an arylsulfonyl group and the like are described. The case where Y₉ represents a benzene condensed ring and results to represent 1,4-naphthohydroquinones for formula (B9) is also preferable. When formula (B9) represents catechols, Y₉ is particularly preferably a sulfo group or the salt thereof and a hydroxy group.

In formula (B10), when R_{b100}, R_{b101} and R_{b102} represent substituents, preferred examples of substituent are similar to that in preferred examples of Y₉. Among them, an alkyl group (particularly a methyl group) is preferable. As preferred examples of a cyclic structure to form Z₁₀, are a chroman ring and a 2,3-dihydrobenzofurane ring are described and these cyclic structures may have a substituent and may form a spiro ring.

In formula (B11), as preferred examples of R_{b111}, R_{b112} and R_{b113} are an alkyl group, an aryl group or a heterocyclic ring group and their preferred ranges are similar to that in the explanation of R_{b1} and R_{b2}. Among them, an alkyl group is preferable and two alkyl groups in R_{b110} to R_{b113} may bind to form a cyclic structure. Herein, a cyclic structure means 5 to 7 membered nonaromatic heterocyclic ring, e.g., a pyrrolidine ring, a pyperidine ring, a morphorino group, a thiomorphorino group, a hexahydropyridazine ring and the like.

In formula (B12), R_{b12} preferably is an alkyl group, an aryl group or a heterocyclic ring group and their preferred ranges are similar to that in the explanation of R_{b1} and R_{b2}. X₁₂ preferably is an alkyl group, an aryl group (particularly a phenyl group), a heterocyclic ring group, an alkoxy group, an amino group (an alkylamino group, an arylamino group, an amino group sunstitiuted to a heterocyclic ring or a cyclic amino group are contained), and a carbamoyl group and more preferably is an alkyl group (particularly, an alkyl group having 1 to 8 carbon atoms is preferable), an aryl group (particularly, a phenyl group is preferable), an amino group (an alkylamino group, an arylamino group or a cyclic amino group are contained). R_{H12} and R′_{H12}, preferably are a hydrogen atom or an alkyl group and more preferably are a hydrogen atom.

In formula (B13), R_{b13} preferably is an alkyl group or an aryl group and their preferred ranges are similar to that in the explanation of R_{b1} and R_{b2}. R_{b130}, R_{b131}, R_{b132} and R_{b133} preferably are a hydrogen atom, an alkyl group (particularly, an alkyl group having 1 to 8 carbon atoms are preferable) and an aryl group (particularly, a phenyl group is preferable). R_{H13} preferably is a hydrogen atom or an acyl group and more preferably is a hydrogen atom.

In formula (I), a reducible group represented by B preferably is hydroxylamines, hydroxamic acids, hydroxyureas, hydroxysemicarbazides, phenols, hydrazines, hydrazides and phenidones and more preferably is hydroxyureas, hydroxysemicarbazides, phenols, hydrazides and phenidones.

The oxidation potential of a reducible group represented by B in formula (I), can be measured by using the measuring method described in Akira Fujishima, “DENKIKAGAKU SOKUTEIHO”, pages 150 to 208, GIHODO SHUPPAN and NIHON KAGAKUKAI, “ZIKKEN KAGAKUKOUZA”, 4th ed., vol. 9, pages 282 to 344, MARUZEN. For example, the method of rotating disc voltammetry can be used; namely the sample is dissolved in the solution (methanol:pH 6.5 Britton-Robinson buffer=10%:90% (% by volume)) and after bubbling with nitrogen gas during 10 minutes the voltamograph can be measured under the condition of 1000 rotations/minute, the sweep rate 20 mV/second, at 25° C. by using a rotating disc electrode (RDE) made by glassy carbon as a working electrode, a platinum electrode as a counter electrode and a saturated calomel electrode as a reference electrode. The half wave potential (E½) can be calculated by that obtained voltamograph.

When a reducible group represented by B in the present invention is measured by the method described above, an oxidation potential preferably is in the range of about −0.3 V to about 1.0 V, more preferably about −0.1 V to about 0.8 V, and most preferably about 0 V to about 0.7 V.

Most of the reducible groups represented by B in the present invention are known in the photographic industry and those examples are described in the following patents. For example, JP-A Nos. 2001-42466, 8-114884, 8-314051, 8-333325, 9-133983, 11-282117, 10-246931, 10-90819, 9-54384, 10-171060 and 7-77783 can be described. And as an example of phenols, the compound described in U.S. Pat. No. 6,054,260 is described too.

The compound of formula (I) in the present invention may have the ballasted group or polymer chain in it generally used in the nonmoving photographic additives as a coupler. And as a polymer, for example, the polymer described in JP-A No. 1-100530 can be described.

The compound of formula (I) in the present invention may be bis or tris type of compound. The molecular weight of the compound represented by formula (I) in the present invention is preferably 100 to 10000 and more preferably 120 to 1000 and particularly preferably 150 to 500.

The examples of the compound represented by formula (I) in the present invention are shown below, but the present invention is not limited in these. The compounds shown in JP-A Nos. 2000-330247 and 2001-42446 are also preferable examples.

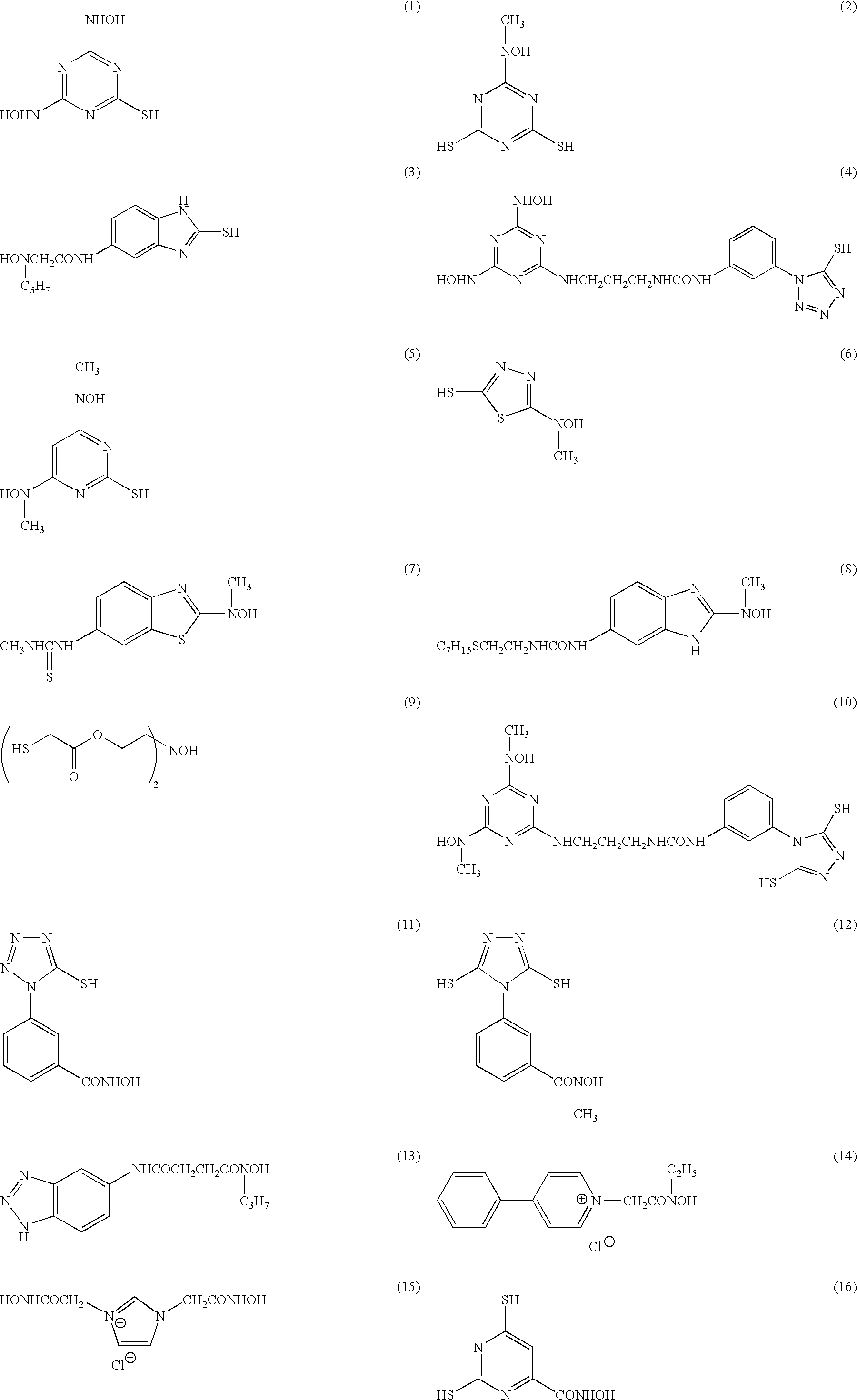

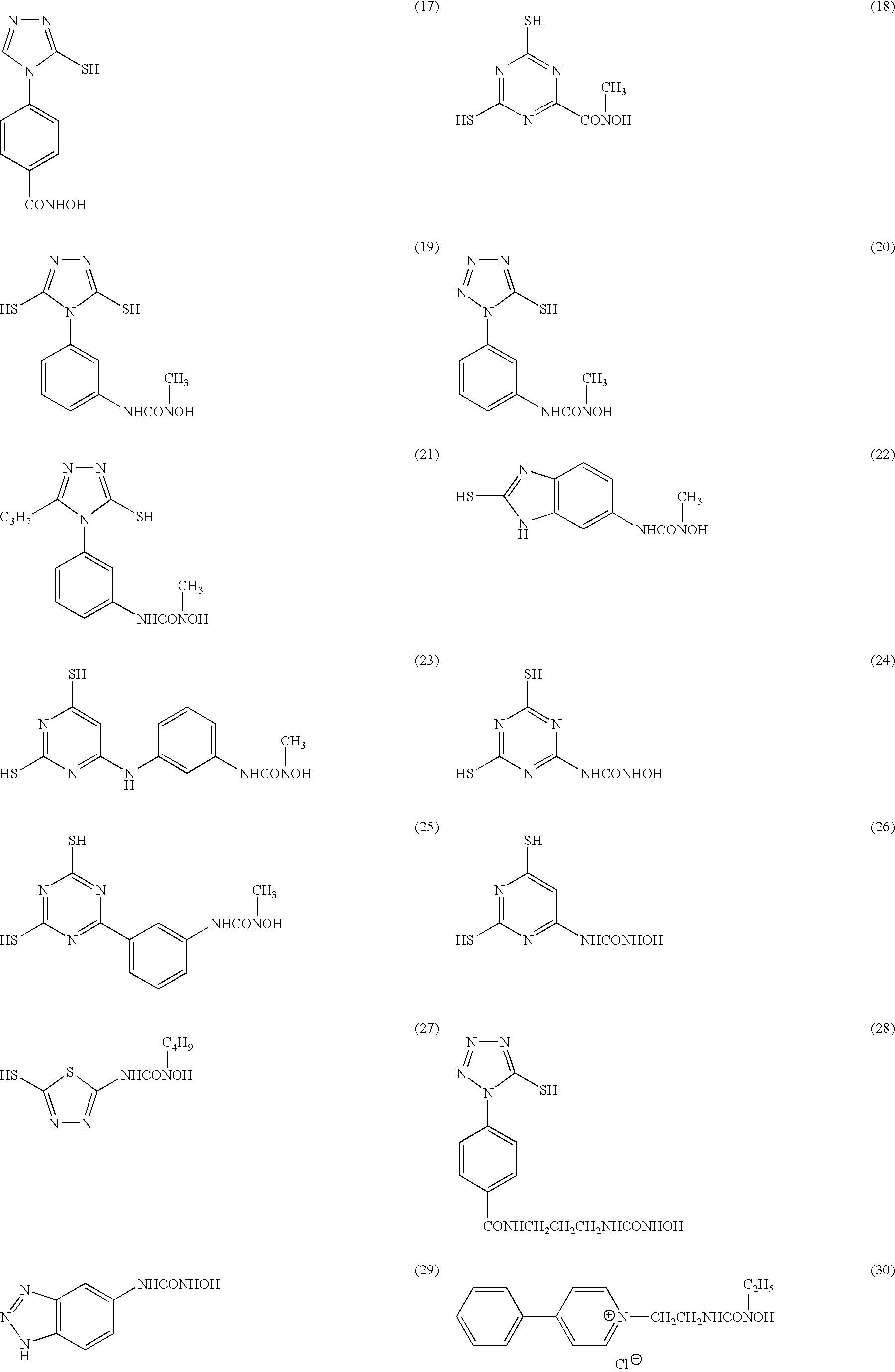

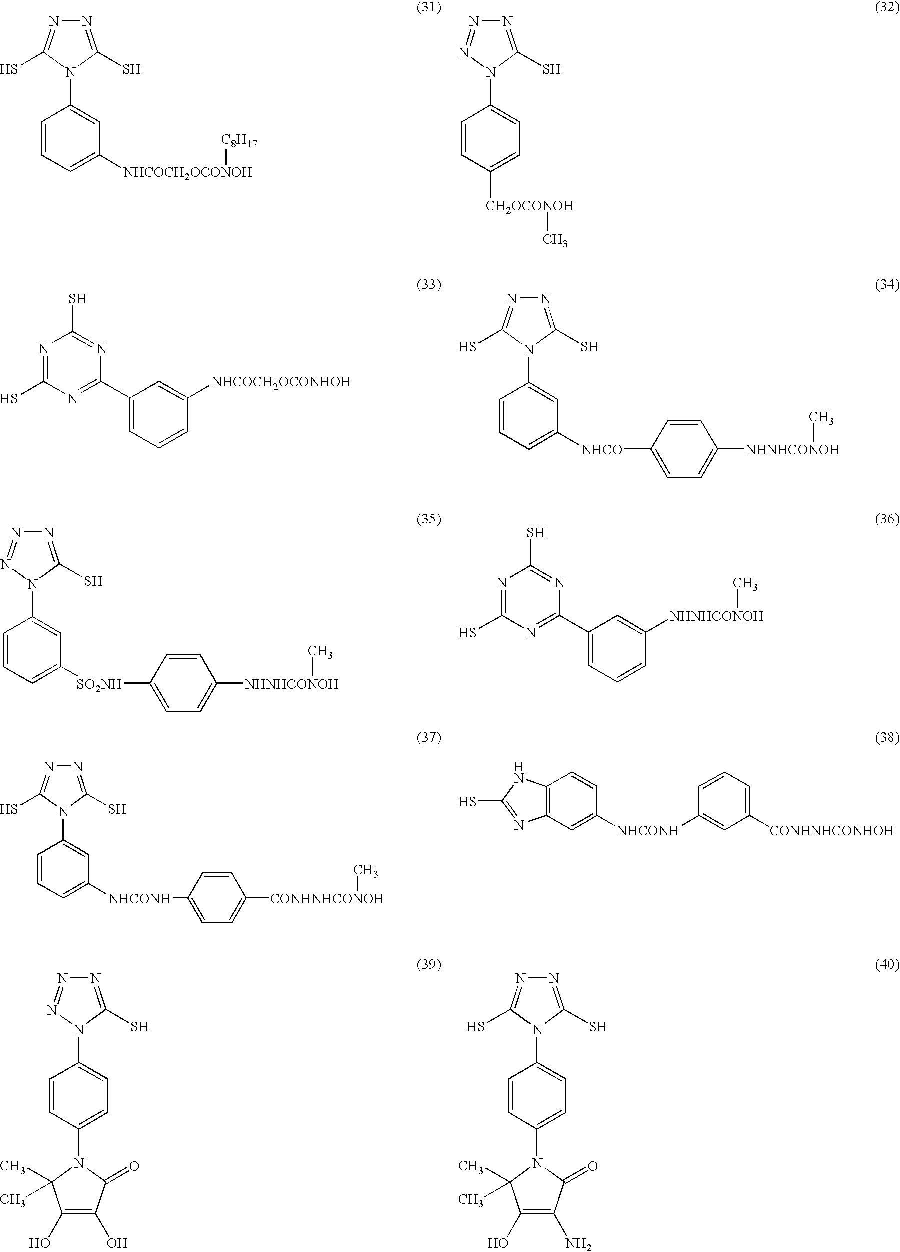

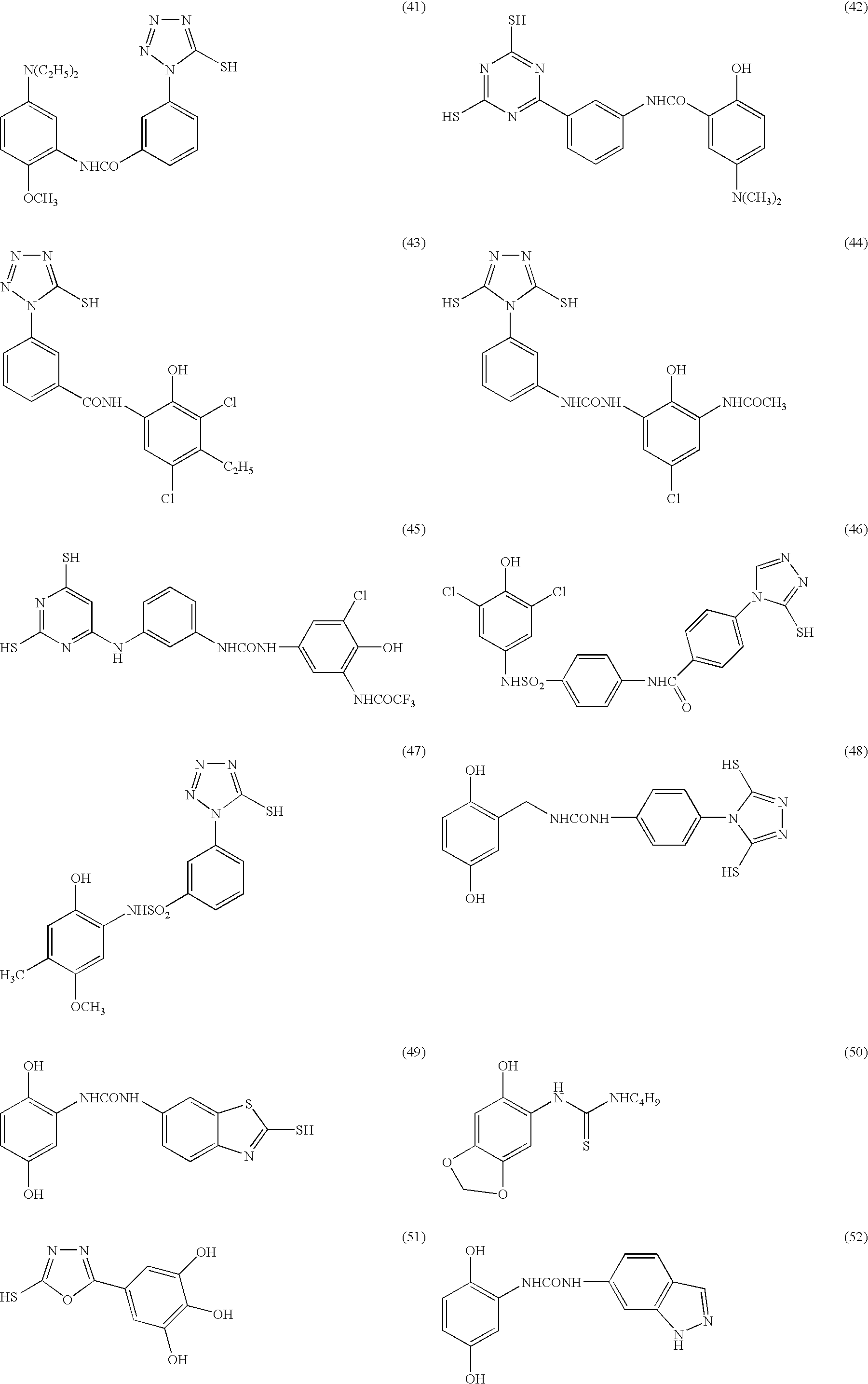

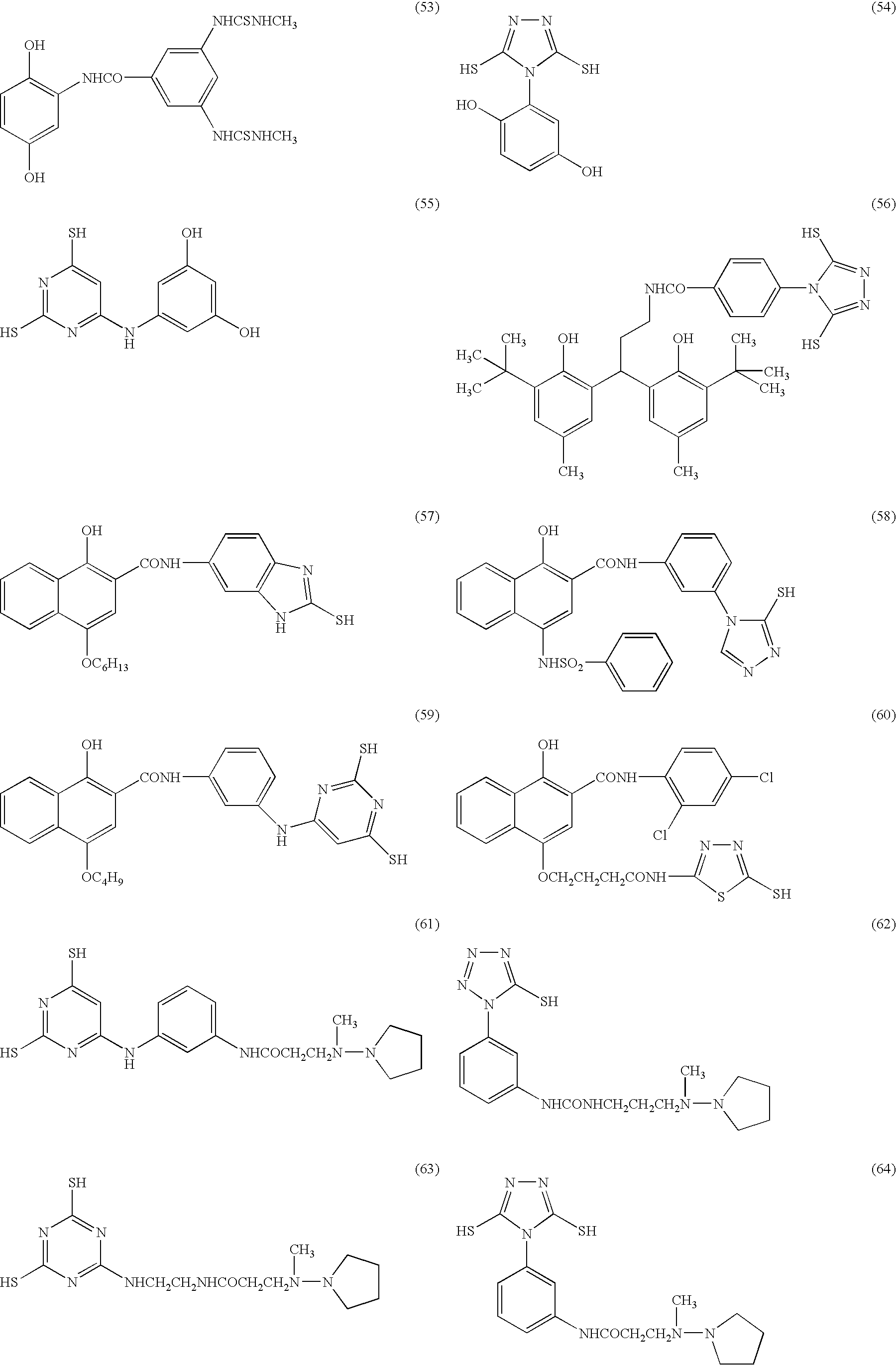

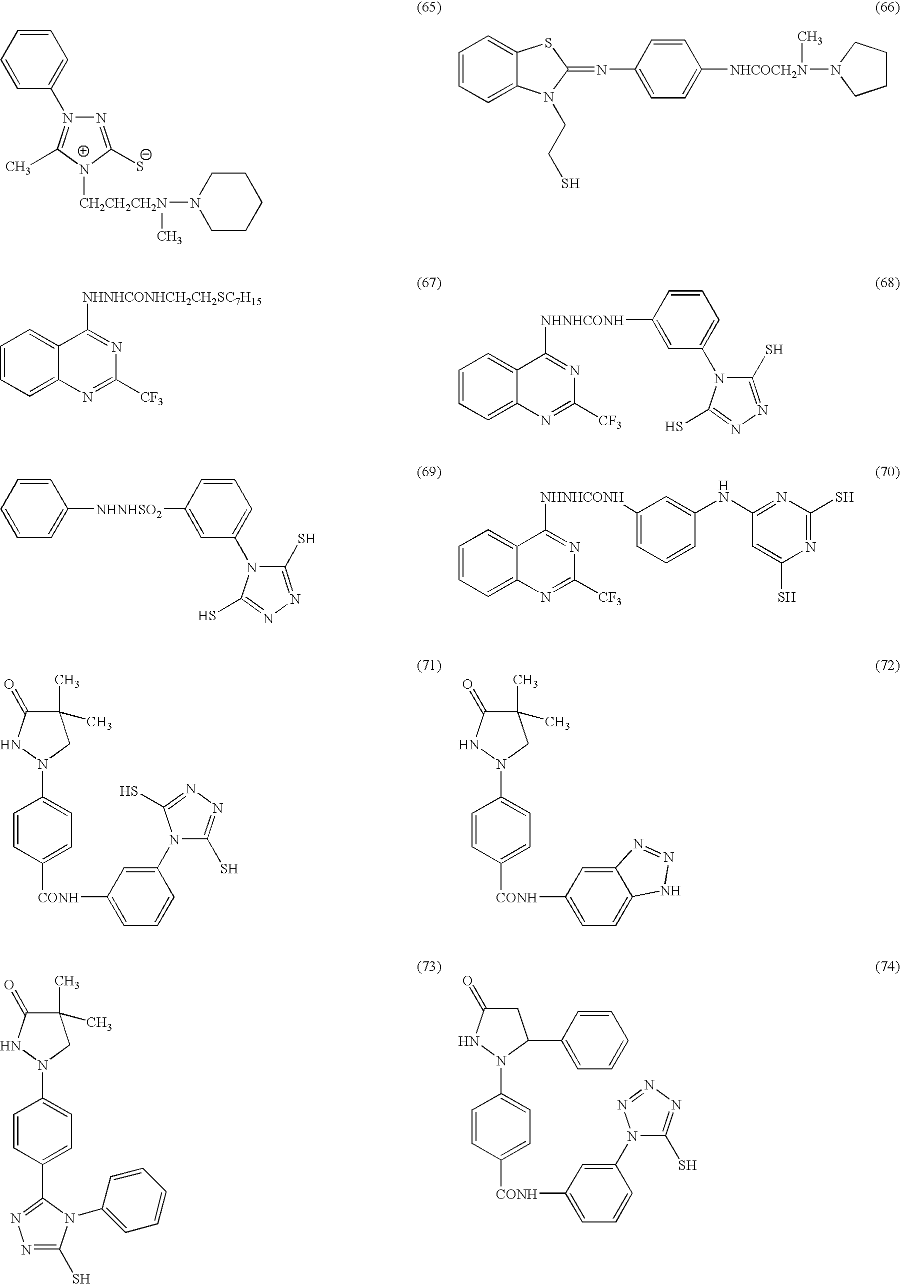

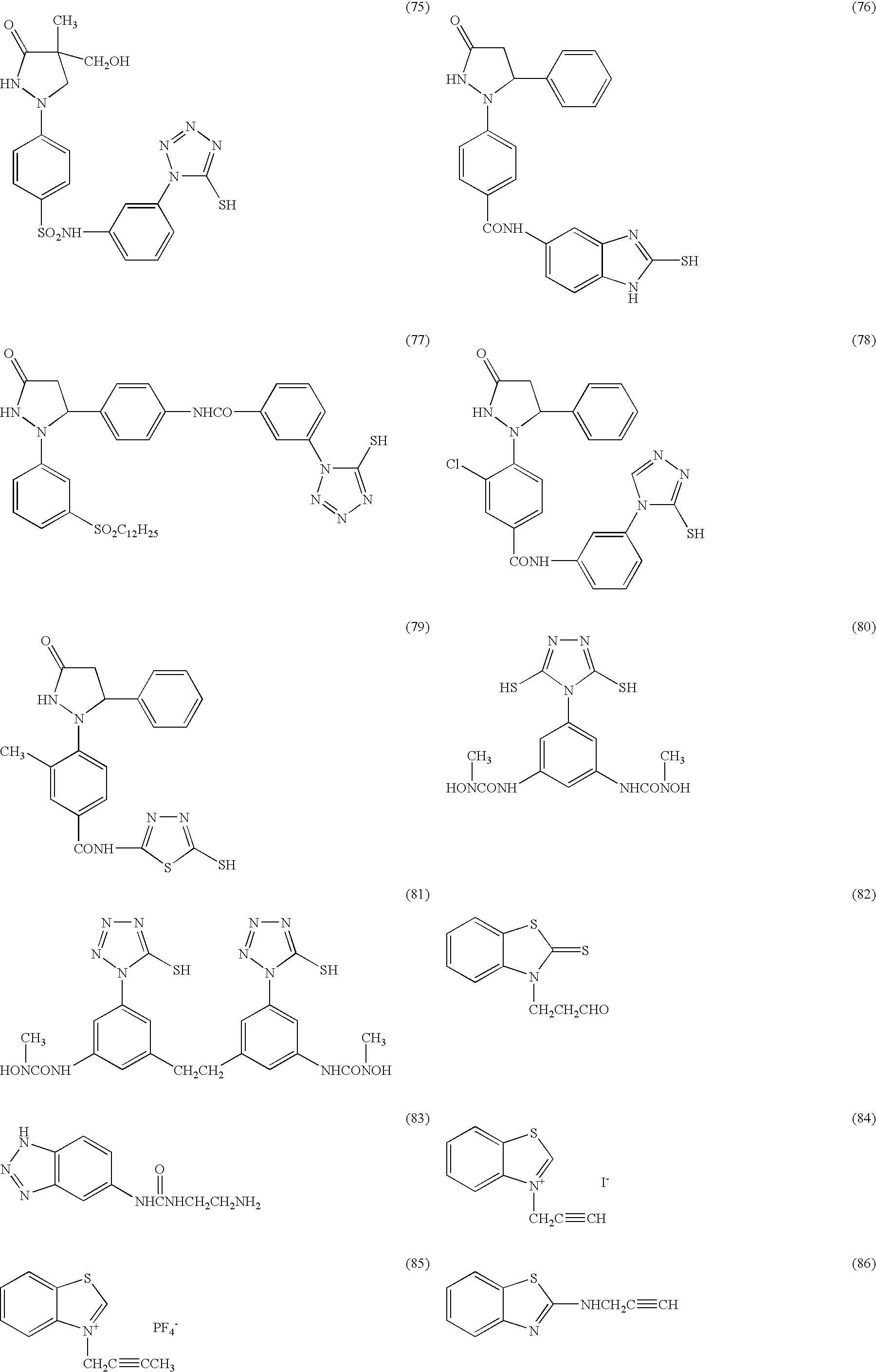

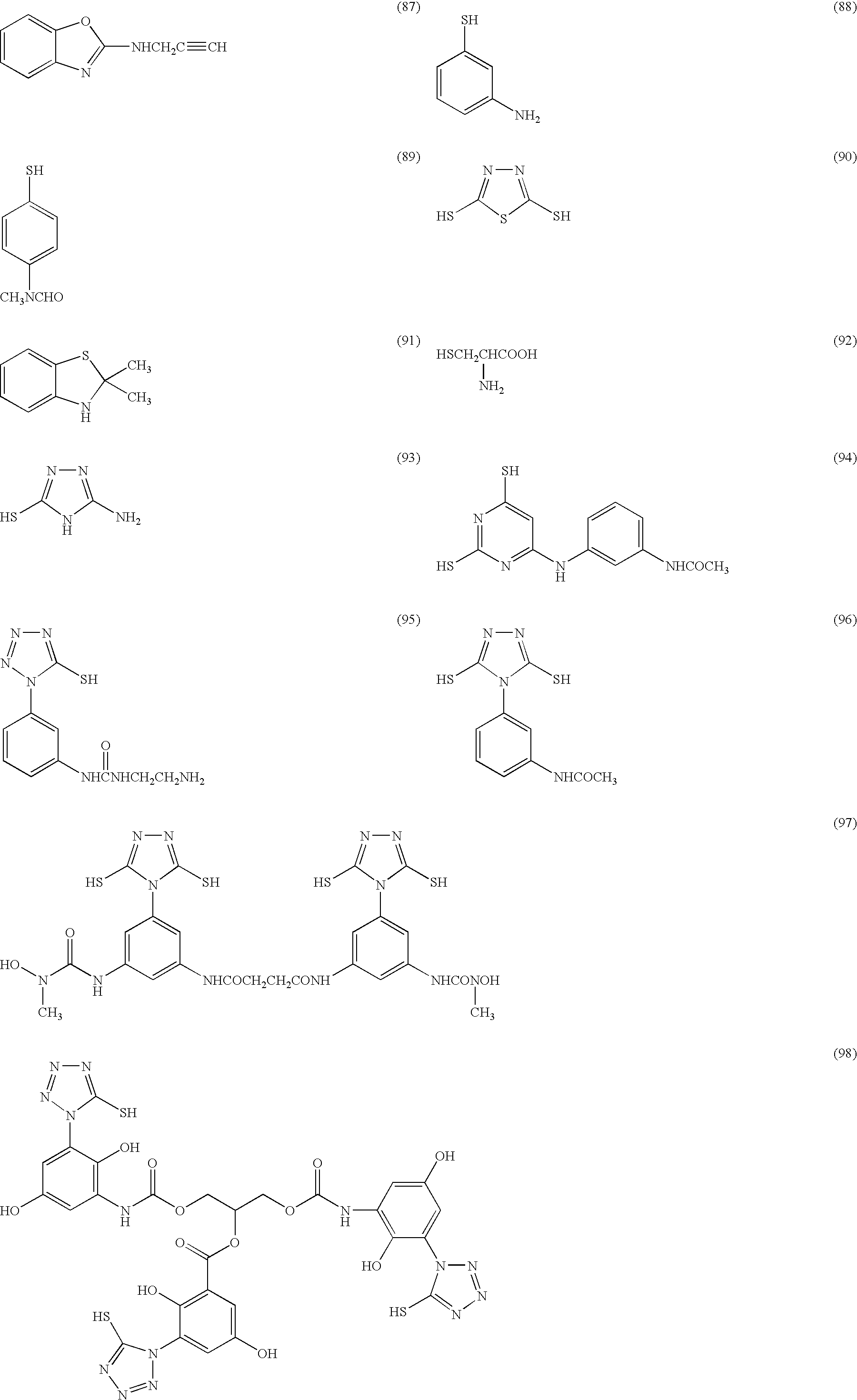

These compounds can be easily synthesized by the known method.

The compound of formula (I) in the present invention can be used independently as only one compound, but it is preferred to use two compounds or more in combination. When two or more types of compounds are used in combination, those may be added to the same layer or the different layers, whereby addition methods may be different from each other.

The compound represented by general formula (I) in the present invention preferably is added to a image forming layer and more preferably is to be added at an emulsion making process. In the case, wherein these compounds are added at an emulsion making process, these compounds may be added at any step in the process. For example, the silver halide grain forming step, a step before starting of salt washing-out step, the salt washing-out step, the step before chemical ripening, the chemical ripening step, the step before prepraring a final emulsion and the like are described. Also, the addition can be performed in the plural divided steps in the process. It is preferred to be added in an image forming layer, but also to be diffused at a coating step from a protective layer or an intermediate layer adjacent to the image forming layer, wherein these compounds are added in the protective layer or the intermediate layer in combination with their addition to the image forming layer.

The preferred addition amount is largely depend on the addition method or the type of compound described above, but generally 1×10⁻⁶ mol to 1 mol per one mol of photosensitive silver halide, preferably 1×10⁻⁵ mol to 5×10⁻¹ mol, and more preferably 1×10⁻⁴ mol to 1×10⁻¹ mol.

The compound represented by general formula (I) in the present invention can be added by dissolving in water or water-soluble solvent such as methanol, ethanol and the like or a mixed solution thereof. At this time, pH may be arranged suitably by an acid or an alkaline and a surfactant can be coexisted. Further, these compounds may be added by dissolving in an organic solvent having high boiling point as an emulsified dispersion and also may be added as a solid dispersion.

2. Photosensitive Silver Halide

1) Iridium

As an embodiment, the photosensitive silver halide according to the invention preferably contains iridium.

A portion thereof which contains iridium is not particularly limited and also an iridium compound may be added in any stage at the time the silver halide grain is formed. For example, the iridium compound may be present at an initial stage of a grain formation step, or added at a later stage of the grain formation step or during the grain growth step.

The iridium compound to be used in the invention may be of a water-soluble type. Examples of such water-soluble iridium compounds include an iridium (III) halide, a iridium (IV) halide and an iridium complex salt having a halogen, any of amines, oxalate or the like as a ligand. Examples of such salts include hexachloroiridium (III), a hexachloroiridium (IV) complex salt, hexammineiridium (III) and a hexammineiridium (IV) complex salt, trioxalateiridium (III) and a trioxalateiridium (IV) complex salt. According to the invention, a combination of a trivalent compound and a tetravalent compound selected from there may be used. These iridium compounds may each be dissolved in water or other appropriate solvents to form an iridium compound solution and, then, used. In order to stabilize the thus formed iridium compound solution, a method ordinarily employed may be used. Particularly, an aqueous solution of a hydrogen halide (for example, hydrochloric acid or hydrobromic acid) or an aqueous solution of an alkali halide (for example, KCl, NaCl, KBr or NaBr) may be added to the iridium compound solution. Instead of using the water-soluble iridium compound, a separate silver halide grain which has previously been doped with iridium may be used at the time the silver halide grain is formed, thereby allowing the iridium compound to be dissolved in the system.

As examples of the iridium compound used in the invention, halogenamines and oxalate complex salts such as primary iridium (III) chloride, primary iridium (III) bromide, secondary iridium (IV) chloride, sodium hexachloroiridate (III), hexachloroiridium (III) salt, hexammineiridium (IV) salt, trioxalateiridium (III) salt and a trioxalateiridium (IV) salt can be described, but the present invention is not limited in these.

A quantity of iridium used in the silver halide according to the invention is preferably in the range of from 1×10⁻⁸ mol to 1×10⁻¹ mol and more preferably in the range of from 1×10⁻⁶ mol to 1×10⁻³ mol, per one mol of the silver halide in each case.

2) Heavy Metal

The photosensitive silver halide grain of the invention may contain other heavy metals together with iridium. Specifically, metals or complexes of metals belonging to groups 8 to 10 of the periodic table (showing groups 1 to 18) can be contained. The metal or the center metal of the metal complex from groups 8 to 10 of the periodic table is preferably rhodium, ruthenium, iron, cobalt, chromium, osmium or rhenium. The metal complex may be used alone, or two or more kinds of complexes comprising identical or different species of metals may be used together.

A preferred content is within a range from 1×10⁻⁹ mol to 1×10⁻³ mol per one mol of silver. The heavy metals, metal complexes and the addition method thereof are described in JP-A No. 7-225449, in paragraph Nos. 0018 to 0024 of JP-A No. 11-65021 and in paragraph Nos. 0227 to 0240 of JP-A No. 11-119374.

3) Doping Method of Iridium or Other Heavy Metals

In the present invention, a silver halide grain preferably is doped using a hexacyano iridium complex or a hexacyano complex of other heavy metals. The hexacyano metal complex includes, for example, [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, hexacyano Fe complex is preferred.

Since the hexacyano complex exists in ionic form in an aqueous solution, paired cation is not important and alkali metal ion such as sodium ion, potassium ion, rubidium ion, cesium ion and lithium ion, ammonium ion, alkyl ammonium ion (for example, tetramethyl ammonium ion, tetraethyl ammonium ion, tetrapropyl ammonium ion, and tetra(n-butyl) ammonium ion), which are easily misible with water and suitable to precipitation operation of a silver halide emulsion are preferably used.

The hexacyano metal complex can be added while being mixed with water, as well as a mixed solvent of water and an appropriate organic solvent miscible with water (for example, alcohols, ethers, glycols, ketones, esters and amides) or gelatin.

In order to allow the hexacyano metal complex to be present on the outermost surface of a silver halide grain, the hexacyano metal complex is directly added in any stage of: after completion of addition of an aqueous solution of silver nitrate used for grain formation, before completion of emulsion forming step prior to a chemical sensitization step, of conducting chalcogen sensitization such as sulfur sensitization, selenium sensitization and tellurium sensitization or noble metal sensitization such as gold sensitization, during washing step, during dispersion step and before chemical sensitization step. In order not to grow the fine silver halide grain, the hexacyano metal complex is rapidly added preferably after the grain is formed, and it is preferably added before completion of the emulsion forming step.

Addition of the hexacyano complex may be started after addition of 96% by weight of an entire amount of silver nitrate to be added for grain formation, more preferably started after addition of 98% by weight and, particularly preferably, started after addition of 99% by weight.

When any of the hexacyano metal complex is added after addition of an aqueous silver nitrate just before completion of grain formation, it can be adsorbed to the outermost surface of the silver halide grain and most of them form an insoluble salt with silver ions on the surface of the grain. Since the hexacyano iron (II) silver salt is a less soluble salt than AgI, re-dissolution with fine grains can be prevented and fine silver halide grains with smaller grain size can be prepared.

Metal atoms that can be contained in the silver halide grain used in the invention (for example, [Fe(CN)₆]⁴⁻), desalting method of a silver halide emulsion and chemical sensitization method are described in paragraph Nos. 0046 to 0050 of JP-A No. 11-84574, in paragraph Nos. 0025 to 0031 of JP-A No. 11-65021, and paragraph Nos. 0242 to 0250 of JP-A No. 11-119374.

4) Halogen Composition

It is preferred that the photosensitive silver halide in the present invention has a silver iodide content of at least 5 mol % or more. Other components are not particularly limited and can be selected from silver chloride and silver bromide and organic silver salts such as silver thiocyanate, silver phosphate and the like, and particularly, silver bromide and silver chloride are preferable. By using such a silver halide having a high silver iodide content, a preferable photothermographic material having excellent image stability after development treatment, particularly showing remarkably small increase in fogging in irradiation with light can be designed.

Further, it is more preferable that the silver iodide content is 40 mol % or more, and it is extremely preferable from the standpoint of image stability against irradiation with light after treatment when the silver iodide content is 85 mol % or more, or 90 mol % or more.

The distribution of the halogen composition in a grain may be uniform or the halogen composition may be changed stepwise, or it may be changed continuously. Further, a silver halide grain having a core/shell structure can be preferably used. Preferred structure is a twofold to fivefold structure and, more preferably, core/shell grain having a twofold to fourfold structure can be used. A core-high-silver iodide-structure which has a high content of silver iodide in the core part, and a shell-high-silver iodide-structure which has a high content of silver iodide in the shell part can also be preferably used. Further, a technique of localizing silver bromide or silver iodide on the surface of a grain as form epitaxial parts can also be preferably used.

5) Grain Size

When silver halide with high content of silver iodide is used, it is necessary that the size of a silver halide grain is sufficiently smaller as compared with conventional silver bromide and silver iodobromide having low iodine content for attaining sufficient maximum optical density. The average grain size of silver halide of high iodide content is preferably 5 nm to 70 nm, more preferably 5 nm to 55 nm. It is particularly preferably 10 nm to 45 nm. The grain size referred to here is observed by an electron microscope, and means the average diameter of a converted circle having the same area as the projected area.

6) Application Amount

The application amount of silver halide grains in the invention is 0.5 mol % to 15 mol %, preferably 0.5 mol % to 12 mol %, and further preferably 0.5 mol % to 10 mol % per one mol of silver of a non-photosensitive organic silver salt described later. It is more preferably 1 mol % to 9 mol %, particularly preferably 1 mol % to 7 mol %.

7) Grain Formation Method

A forming method of photosensitive silver halide has been well known in the industry to which the invention pertains and methods can be employed that are disclosed in, for example, Research Disclosure, No. 17029, June, 1978 and U.S. Pat. No. 3,700,458 and to be concrete, a method is employed in which a silver supplying compound and a halogen supplying compound are added into a gelatin solution or another polymer solution to thereby prepare a photosensitive silver halide, followed by mixing with an organic silver salt. Other preferable methods are also disclosed in paragraphs from 0217 to 0224 of JP-A No. 11-119374, JP-A No. 11-352627, and Japanese Patent Application No. 2000-42336.

8) Grain Form

While examples of forms of silver halide grains in the invention are cube grains, octahedron grains, dodecahedron grains, tetrahedron grains, flat plate grains, sphere grains, rod grains, potato grains and the like, particularly preferable in the invention are dodecahedron grains and tetrahedron grains. The term “dodecahedron grain” means a grain having planes of (001), {1(−1)0} and {101} and the term “tetrahedron grain” means a grain having planes of (001), {100} and {101}. The {100} expresses a family of crystallographic planes equivalent to a (100) plane.

Silver iodide of the invention can assume any of a β phase or a γ phase contained. The term “β phase” described above means a high silver iodide structure having a wurtzite structure of a hexagonal system and the term “γ phase” means a high silver iodide structure having a zinc blend structure of a cubic crystal system.

An average content of γ phase in the present invention is determined by a method presented by C. R. Berry. In the method, an average content of γ phase is calculated from the peak ratio of the intensity owing to γ phase (111) to that owing to β phase (100), (101), 002) in powder X ray diffraction method. Detail description, for example, is described in Physical Review, Volume 161, No. 3, p. 848 to 851 (1967).

According to the method of forming flat plate grains of silver iodide, preferably used are those described in JP-A Nos. 59-119350 and 59-119344. As for forming dodecahedron grains, tetrahedron grains and octahedron grains, the methods described in Japanese Patent Application Nos. 2002-081020, 2002-87955 and 2002-91756 can be used for reference.

The silver halide having high silver iodide content of the invention can take a complicated form, and as the preferable form, there are listed, for example, connecting particles as shown in R. L. JENKINS et al., J. of Phot. Sci. Vol. 28 (1980), p 164, FIG. 1. Flat plate particles as shown in FIG. 1 of the same literature can also be preferably used. Particles obtained by rounding corners of silver halide particles can also be preferably used. The surface index (Mirror index) of the outer surface of a photosensitive silver halide particle is not particularly restricted, and it is preferable that the ratio occupied by the [100] surface is rich, because of showing high spectral sensitization efficiency when a spectral sensitizer is adsorbed. The ratio is preferably 50% or more, more preferably 65% or more, further preferably 80% or more. The ratio of the [100] surface, Mirror index, can be determined by a method described in T. Tani; J. Imaging Sci., 29, 165 (1985) utilizing adsorption dependency of the [111] surface and [100] surface in adsorption of a sensitizing dye.

9) Gelatin

As the gelatin contained the photosensitive silver halide emulsion used in the invention, various kinds of gelatins can be used. It is necessary to maintain an excellent dispersion state of a photosensitive silver halide emulsion in an organic silver salt containing coating solution, and low molecular weight gelatin having a molecular weight of 10,000 to 1,000,000 is preferably used. And phthalated gelatin is also preferably used. These gelatins may be used at grain formation or at the time of dispersion after desalting treatment and it is preferably used during grain formation.

10) Chemical Sensitization

The photosensitive silver halide in this invention can be used without chemical sensitization, but is preferably chemically sensitized by at least one of chalcogen sensitization method, gold sensitization method and reduction sensitization method. The chalcogen sensitization method includes sulfur sensitization method, selenium sensitization method and tellurium sensitization method.

In sulfur sensitization, unstable sulfur compounds can be used. Such unstable sulfur compounds are described in P. Grafkides, Chemie et Pysique Photographique (Paul Momtel, 1987, 5th ed.,) and Research Disclosure (vol. 307, Item 307105), and the like.

As typical examples of sulfur sensitizer, known sulfur compounds such as thiosulfates (e.g., hypo), thioureas (e.g., diphenylthiourea, triethylthiourea, N-ethyl-N′-(4-methyl-2-thiazolyl)thiourea and carboxymethyltrimethylthiourea), thioamides (e.g., thioacetamide), rhodanines (e.g., diethylrhodanine, 5-benzylydene-N-ethylrhodanine), phosphinesulfides (e.g., trimethylphosphinesulfide), thiohydantoins, 4-oxo-oxazolidin-2-thione derivatives, disulfides or polysulfides (e.g., dimorphorinedisulfide, cystine, hexathiocan-thione), polythionates, sulfur element and active gelatin can be used. Specifically, thiosulfates, thioureas and rhodanines are preferred.

In selenium sensitization, unstable selenium compounds can be used. These unstable selenium compounds are described in JP-B Nos. 43-13489 and 44-15748, JP-A Nos. 4-25832, 4-109340, 4-271341, 5-40324, and 5-11385, Japanese Patent Application Nos. 4-202415, 4-330495, 4-333030, 5-4203, 5-4204, 5-106977, 5-236538, 5-241642 and 5-286916, and the like.

As typical examples of selenium sensitizer, colloidal metal selenide, selenoureas (eg., N,N-dimethylselenourea, trifluoromethylcarbonyl-trimethylselenourea and acetyltrimethylselemourea), selenamides (eg., selenamide and N,N-diethylphenylselenamide), phosphineselenides (eg., triphenylphosphineselenide and pentafluorophenyl-triphenylphosphineselenide), selenophosphates (e.g., tri-p-tolylselenophosphate and tri-n-butylselenophosphate), selenoketones (e.g., selenobenzophenone), isoselenocyanates, selenocarbonic acids, selenoesters, diacylselenides can be used. Furthermore, non-unstable selenium compounds such as selenius acid, selenocyanic acid, selenazoles and selenides described in JP-B Nos. 46-4553 and 52-34492 can also be used. Specifically, phosphineselenides, selenoureas and salts of selenocyanic acids are preferred.

In the tellurium sensitization, unstable tellurium compounds are used. Unstable tellurium compounds described in JP-A Nos. 4-224595, 4-271341, 4-333043, 5-303157, 6-27573, 6-175258, 6-180478, 6-208186, 6-208184, 6-317867, 7-140579, 7-301879, 7-301880 and the like, can be used as tellurium sensitizer.

As typical examples of tellurium sensitizer, phosphinetellurides (e.g., butyl-diisopropylphosphinetelluride, tributylphosphinetelluride, tributoxyphosphinetelluride and ethoxy-diphenylphosphinetellride), diacyl(di)tellurides (e.g., bis(diphenylcarbamoyl)ditelluride, bis(N-phenyl-N-methylcarbamoyl)ditelluride, bis(N-phenyl-N-methylcarbamoyl)ditelluride, bis(N-phenyl-N-benzylcarbamoyl)telluride and bis(ethoxycarmonyl)telluride), telluroureas (e.g., N,N′-dimethylethylenetellurourea and N,N′-diphenylethylenetellurourea), telluramides, telluroesters are used. Specifically, diacyl(di)tellurides and phosphinetellurides are preferred. Especially, the compounds described in paragraph No. 0030 of JP-A No. 11-65021 and compounds represented by the general formula (II), (III) and (IV) in JP-A No. 5-313284 are more preferred.

Selenium sensitization and tellurium sensitization are preferred as chalcogen sensitization and specifically, tellurium sensitization is more preferred.

In gold sensitization, gold sensitizer described in P. Grafkides, Chemie et Pysique Photographique (Paul Momtel, 1987, 5th ed.,) and Research Disclosure (vol. 307, Item 307105) can be used. To speak concretely, chloroauric acid, potassium chloroaurate, potassium aurithiocyanate, gold sulfide, gold selenide and the like can be used. In addition to these, the gold compounds described in U.S. Pat. Nos. 2,642,361, 5,049,484, 5,049,485, 5,169,751, and 5,252,455, Belg. Patent No. 691857, and the like can also be used. And another novel metal salts except gold such as platinum, palladium, iridium and so on described in P. Grafkides, Chemie et Pysique Photographique (Paul Momtel, 1987, 5th ed.,) and Research Disclosure (vol. 307, Item 307, 105) can be used.

The gold sensitization can be used independently, but it is preferably used in combination with the above chalcogen sensitization. Specifically, these sensitizations are gold-sulfur sensitization (gold-plus-sulfur sensitization), gold-selenium sensitization, gold-tellurium sensitization, gold-sulfur-selenium sensitization, gold-sulfur-tellurium sensitization, gold-selenium-tellurium sensitization and gold-sulfur-selenium-tellurium sensitization.

In the invention, chemical sensitization can be applied at any time so long as it is after grain formation and before coating, and it can be applied, after desalting, (1) before spectral sensitization, (2) simultaneously with spectral sensitization, (3) after spectral sensitization and (4) just before coating.

The amount of chalcogen sensitizer used in the invention may vary depending on the silver halide grain used, the chemical ripening condition and the like and it is used by about 10⁻⁸ mol to 10⁻¹ mol, preferably, 10⁻⁷ mol to 10⁻² mol per one mol of the silver halide.

Similarly, the addition amount of the gold sensitizer used in the invention may vary depending on various conditions and it is generally about 10⁻⁷ mol to 10⁻² mol and, more preferably, 10⁻⁶ mol to 5×10⁻³ mol per one mol of the silver halide. There is no particular restriction on the condition for the chemical sensitization in the invention and, appropriately, pAg is 8 or less, preferably, 7.0 or less, more preferably, 6.5 or less and, particularly preferably, 6.0 or less, and pAg is 1.5 or more, preferably, 2.0 or more and, particularly preferably, 2.5 or more; pH is 3 to 10, preferably, 4 to 9; and temperature is at 20° C. to 95° C., preferably, 25° C. to 80° C.

In the invention, reduction sensitization can also be used in combination with the chalcogen sensitization or the gold sensitization. It is specifically preferred to use in combination with the chalcogen sensitization.

As the specific compound for the reduction sensitization, ascorbic acid, thiourea dioxide or dimethylamine borane is preferred, as well as use of stannous chloride, aminoimino methane sulfonic acid, hydrazine derivatives, borane compounds, silane compounds and polyamine compounds are preferred. The reduction sensitizer may be added at any stage in the photosensitive emulsion production process from crystal growth to the preparation step just before coating. Further, it is preferred to apply reduction sensitization by ripening while keeping pH to 8 or higher and pAg to 4 or lower for the emulsion, and it is also preferred to apply reduction sensitization by introducing a single addition portion of silver ions during grain formation.

The addition amount of the reduction sensitizer may also vary depending on various conditions and it is generally about 10⁻⁷ mol to 10⁻¹ mol and, more preferably, 10⁻⁶ mol to 5×10⁻² mol per one mol of the silver halide.

In the silver halide emulsion used in the invention, a thiosulfonic acid compound may be added by the method shown in EP-A No. 293917.

The photosensitive silver halide grain in the invention can be chemically unsensitized, but is preferably chemically sensitized by at least one method of gold sensitization method and chalcogen sensitization method for the purpose of designing a high-photosensitive photothermographic material.

11) Spectral Sensitizing Dye

The photosensitive silver halide used in the invention may be spectral sensitized by a spectral sensitizer represented by any one of the following formulae (3a) to (3d).

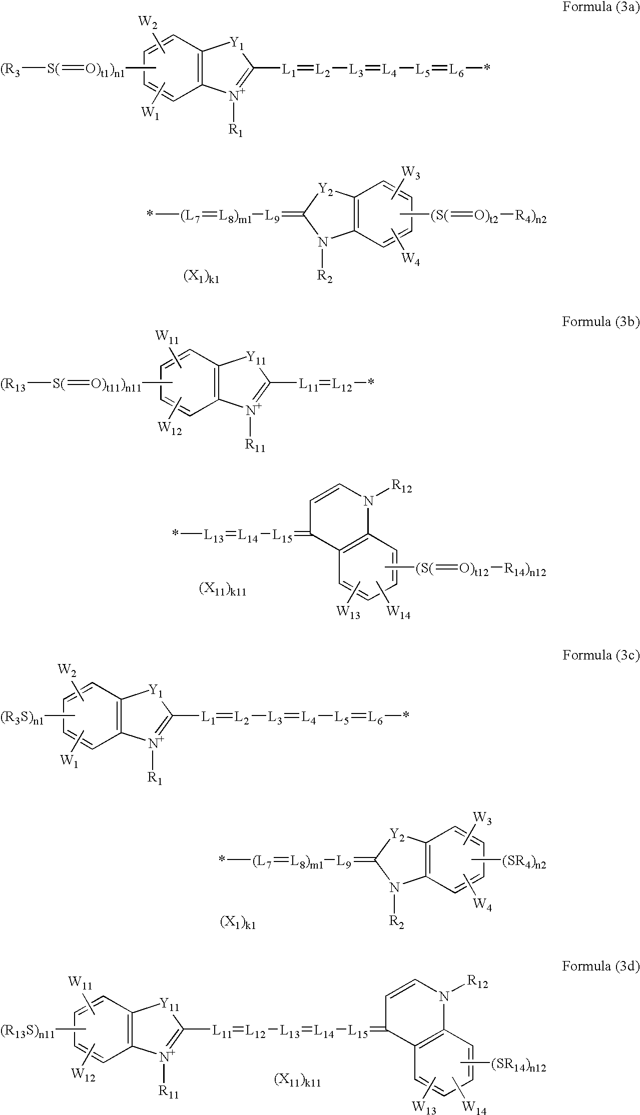

In formulae (3a) to (3d), Y₁, Y₂ and Y₁₁ each represent an oxygen atom, a sulfur atom, a selenium atom or a —CH═CH— group, and L₁ to L₉ and L₁₁ to L₁₅ each represent a methine group. R₁, R₂, R₁₁ and R₁₂ each represent an aliphatic group. R₃, R₄, R₁₃ and R₁₄ each represent a lower alkyl group, a cycloalkyl group, an alkenyl group, an aralkyl group, an aryl group or a heterocyclic group. W₁, W₂, W₃, W₄, W₁₁, W₁₂, W₁₃ and W₁₄ each represent a hydrogen atom or a substituent. Alternatively, W₁ and W₂, W₃ and W₄, W₁₁ and W₁₂, and W₁₃ and W₁₄ may bond together to be a nonmetallic atomic group forming a condensed ring, respectively. Alternatively, R₃ and W₁, R₃ and W₂, R₁₃ and W₁₁, R₁₃ and W₁₂, R₄ and W₃, R₄ and W₄, R₁₄ and W₁₃, and R₁₄ and W₁₄ may bond together to be a nonmetallic atomic group forming a 5- or 6-membered condensed ring, respectively. X₁ and X₁₁ each represent an ion necessary for neutralizing a charge in a molecule. k1 and k11 each represent a number of the ion necessary for neutralizing a charge in a molecule. m1 represents 0 or 1. n1, n2, n11 and n12 each represent 0, 1 or 2. Incidentally, at least one of n1 and n2, and at least one of n11 and n12 are 1 or 2, respectively. t1, t2, t11 and t12 each represent an integer of 1 or 2.

In formulae (3a) to (3d), examples of the aliphatic group represented by R₁, R₂, R₁₁ and R₁₂ include branched or straight alkyl groups with 1 to 10 carbon atom, such as a methyl group, an ethyl group, a propyl group, a butyl group, a pentyl group, an iso-pentyl group, a 2-ethylhexyl group, an octyl group and a decyl group; alkenyl groups with 3 to 10 carbon atoms, such as a 2-propenyl group, a 3-butenyl group, a 1-methyl-3-propenyl group, a 3-pentenyl group, a 1-methyl-3-butenyl group and a 4-hexenyl group; and aralkyl groups with 7 to 10 carbon atoms, such as a benzyl group and a phenethyl group. The aliphatic groups exemplified above may have a substituent with examples including lower alkyl groups such as a methyl group, an ethyl group and a propyl group; halogen atoms such as a fluorine atom, a chlorine atom and a bromine atom; a vinyl group; aryl groups such as a phenyl group, a p-tolyl group and a p-bromophenyl group; a trifluoromethyl group; alkoxy groups such as a methoxy group, an ethoxy group and a methoxyethoxy group; aryloxy groups such as a phenoxy group and a p-tolyloxy group; a cyano group; sulfonyl groups such as a methanesulfonyl group, a trifluoromethanesulfonyl group and a p-toluenesulfonyl group; alkoxycarbonyl groups such as an ethoxycarbonyl group and a butoxycarbonyl group; amino groups such as an amino group and a biscarboxymethylamino group; aryl groups such as a phenyl group and a carboxyphenyl group; heterocyclic groups such as a tetrahydrofurfuryl group and a 2-pyrrolidinone-1-yl group; acyl groups such as an acetyl group and a benzoyl group; ureide groups such as an ureide group, a 3-methylureide group and a 3-phenylureide group; thiouredide groups such as a thiouredide group and a 3-methylthiouredide group; alkylthio groups such as a methylthio group and an ethylthio group; arylthio groups such as a phenylthio group; heterocyclic thio groups such as a 2-thienylthio group, a 3-thienylthio group and a 2-imidazolylthio group; carbonyloxy groups such as an acetyloxy group, a propanoyloxy group and a benzoyloxy group; acylamino groups such as an acetylamino group and a benzoylamino group; thioamide groups such as a thioacetoamide group and a thiobenzoylamino group; and hydrophilic groups.

Examples of the hydrophilic group include a sulfo group; a carboxy group; a phosphono group; a sulfate group; a hydroxy group; a mercapto group; a sulfino group; carbamoyl groups such as a carbamoyl group, an N-methylcarbamoyl group and an N,N-tetramethylenecarbamoyl group; sulfamoyl groups such as a sulfamoyl group and an N,N-3-oxapentamethyleneaminosulfonyl group; sulfoneamide groups such as a methanesulfoneamide group and a butanesulfoneamide group; sulfonylaminocarbonyl groups such as a methanesulfonylaminocarbonyl group and an ethanesulfonylaminocarbonyl group; acylaminosulfonyl groups such as an acetoamidosulfonyl group and a methoxyacetoamidosulfonyl group; acylaminocarbonyl groups such as an acetoamidocarbonyl group and a methoxyacetoamidocarbonyl group; sulfinylaminocarbonyl groups such as a methanesulfonylaminocarbonyl group and an ethanesulfinylaminocarbonyl group; etc.

Specific examples of the aliphatic group having the hydrophilic group as a substituent include a carboxymethyl group, a carboxyethyl group, a carboxybutyl group, a carboxypentyl group, a 3-sulfatebutyl group, a 3-sulfopropyl group, a 2-hydroxy-3-sulfopropyl group, a 4-sulfobutyl group, a 5-sulfopentyl group, a 3-sulfopentyl group, a 3-sulfinobutyl group, a 3-phosphonopropyl group, a hydroxyethyl group, an N-methanesulfonylcarbamoylmethyl group, a 2-carboxy-2-propenyl group, an o-sulfobenzyl group, a p-sulfophenethyl group, a p-carboxybenzyl group, etc.

The lower alkyl group represented by R₃, R₄, R₁₃ and R₁₄ is a straight or branched alkyl group having 5 or less carbon atoms, and specific examples thereof include a methyl group, an ethyl group, a propyl group, a butyl group, a pentyl group, an isopropyl group, etc. Examples of the cycloalkyl group include a cyclopropyl group, a cyclobutyl group, a cyclopentyl group, etc. Examples of the alkenyl group include a 2-propenyl group, a 3-butenyl group, a 1-methyl-3-propenyl group, a 3-pentenyl group, a 1-methyl-3-butenyl group, a 4-hexenyl group, etc. EXAMPLEs of the aralkyl group include a benzyl group, a phenethyl group, a p-methoxyphenylmethyl group, an o-acetylaminophenylethyl group, etc. The aryl group may be substituted or unsubstituted, and examples thereof include a phenyl group, a 2-naphthyl group, a 1-naphthyl group, an o-tolyl group, an o-methoxyphenyl group, a m-chlorophenyl group, a m-bromophenyl group, a p-tolyl group, a p-ethoxyphenyl group, etc. The heterocyclic group may be substituted or unsubstituted, and examples thereof include a 2-furyl group, a 5-methyl-2-furyl group, a 2-thienyl group, a 3-thienyl group, a 2-imidazolyl group, a 2-methyl-1-imidazolyl group, a 4-phenyl-2-thiazolyl group, a 5-hydroxy-2-benzothiazolyl group, a 2-pyridyl group, a 1-pyrrolyl group, etc.

Each of these groups may have a substituent with examples including lower alkyl groups such as a methyl group and an ethyl group; lower alkoxy groups such as a methoxy group and an ethoxy group; a hydroxy group; halogen atoms such as a fluorine atom, a chlorine atom, a bromine atom and an iodine atom; aryl groups such as a phenyl group, a tolyl group and a chlorophenyl group; a mercapto group; lower alkylthio groups such as a methylthio group and an ethylthio group; etc.

Specific examples of the substituent represented by each of W₁ to W₄ and W₁₁ to W₁₄ include alkyl groups such as a methyl group, an ethyl group, a butyl group and an isobutyl group; aryl groups, which may be monocyclic or polycyclic, such as a phenyl group and a naphthyl group; heterocyclic groups such as a thienyl group, a furyl group, a pyridyl group, a carbazolyl group, a pyrrolyl group and an indolyl group; halogen atoms such as a fluorine atom, a chlorine atom and a bromine atom; a vinyl group; an aryl group such as a phenyl group, a p-tolyl group and a p-bromophenyl group; a trifluoromethyl group; alkoxy groups such as a methoxy group, an ethoxy group and a methoxyethoxy group; aryloxy groups such as a phenoxy group and a p-tolyloxy group; sulfonyl groups such as a methanesulfonyl group and a p-toluenesulfonyl group; alkoxycarbonyl groups such as an ethoxycarbonyl group and a butoxycarbonyl group; amino groups such as an amino group and a biscarboxymethylamino group; aryl groups such as a phenyl group and a carboxyphenyl group; heterocyclic groups such as a tetrahydrofurfuryl group and a 2-pyrrolidinone-1-yl group; acyl groups such as an acetyl group and a benzoyl group; ureide groups such as an ureide group, a 3-methylureide group and a 3-phenylureide group; thiouredide groups such as a thiouredide group and a 3-methylthiouredide group; alkylthio groups such as a methylthio group and an ethylthio group; arylthio groups such as a phenylthio group; a hydroxy group; a styryl group; etc.

These groups may have a substituent with examples the same as those of the substituent on the aliphatic group represented by R₁, etc. Specific examples of the substituted alkyl group include a 2-methoxyethyl group, a 2-hydroxyethyl group, a 3-ethoxycarbonylpropyl group, a 2-carbamoylethyl group, a 2-methanesulfonylethyl group, a 3-methanesulfonylaminopropyl group, a benzyl group, a phenethyl group, a carboxymethyl group, a carboxyethyl group, aryl groups, a 2-furylethyl group, etc. Specific examples of the substituted aryl group include a p-carboxyphenyl group, a p-N,N-dimethylaminophenyl group, a p-morpholinophenyl group, a p-methoxyphenyl group, a 3,4-dimethoxyphenyl group, a 3,4-methylenedioxyphenyl group, a 3-chlorophenyl group, a p-nitrophenyl group, etc. Specific examples of the substituted heterocyclic group include a 5-chloro-2-pyridyl group, a 5-ethoxycarbonyl-2-pyridyl group, a 5-carbamoyl-2-pyridyl group, etc.

The condensed ring formed by W₁ and W₂, W₃ and W₄, W₁₁ and W₁₂, W₁₃ and W₁₄, R₃ and W₁, R₃ and W₂, R₁₃ and W₁₁, R₁₃ and W₁₂, R₄ and W₃, R₄ and W₄, R₁₄ and W₁₃, and R₁₄ and W₁₄, respectively may be, for example, a 5- or 6-membered, saturated or unsaturated, condensed, carbocyclic ring. The condensed ring may have a substituent at an optional position, examples of the substituent being the same as those of above-mentioned substituent on the aliphatic group.

In formulae (3a) to (3d), the methine groups represented by L₁ to L₉ and L₁₁ to L₁₅ are independently a substituted or unsubstituted methine group. Specific examples of a substituent on the methine group include substituted or unsubstituted, lower alkyl groups such as a methyl group, an ethyl group, an iso-propyl group and a benzyl group; alkoxy groups such as a methoxy group and an ethoxy group; aryloxy groups such as a phenoxy group and a naphthoxy group; aryl groups such as a phenyl group, a naphthyl group, a p-tolyl group and a o-carboxyphenyl group; —N(V₁,V₂); —SR; and heterocyclic groups such as a 2-thienyl group, a 2-furyl group and an N,N′-bis(methoxyethyl)barbituric acid group. R represents a lower alkyl group, an aryl group or a heterocyclic group as above. V₁ and V₂ each represent a substituted or unsubstituted, lower alkyl group or aryl group. V₁ and V₂ may bond together to form a 5- or 6-membered, nitrogen-containing heterocycle. Further, the methine group may bond to the other methine group, adjacent thereto or connecting thereto with one methine group between, to form a 5- or 6-membered ring.

When the compounds represented by formulae (3a) to (3d) have a group with a cation or anion charge, the compounds may comprise an equivalent counter ion of an anion or a cation to counterbalance the charge. In the case where the ion necessary for neutralizing the charge, represented by each of X₁ and X₁₁, is a cation, specific examples of the cation include proton; organic ammonium ions such as a triethylammonium ion and a triethanol ammonium ion; and inorganic cations such as a lithium cation, a sodium cation and a potassium cation. Specific examples of an acid anion represented by each of X₁ and X₁₁ include halogen ions such as a chlorine ion, a bromine ion and an iodine ion; a p-toluenesulfonate ion; a perchlorate ion; a boron tetrafluoride ion; a sulfate ion; a methylsulfate ion; an ethylsulfate ion; a methanesulfonate ion; and a trifluoromethanesulfonate ion.

Specific examples of the sensitizing dyes represented by formulae (3a) to (3d) are illustrated below without intention of restricting the scope of the invention.

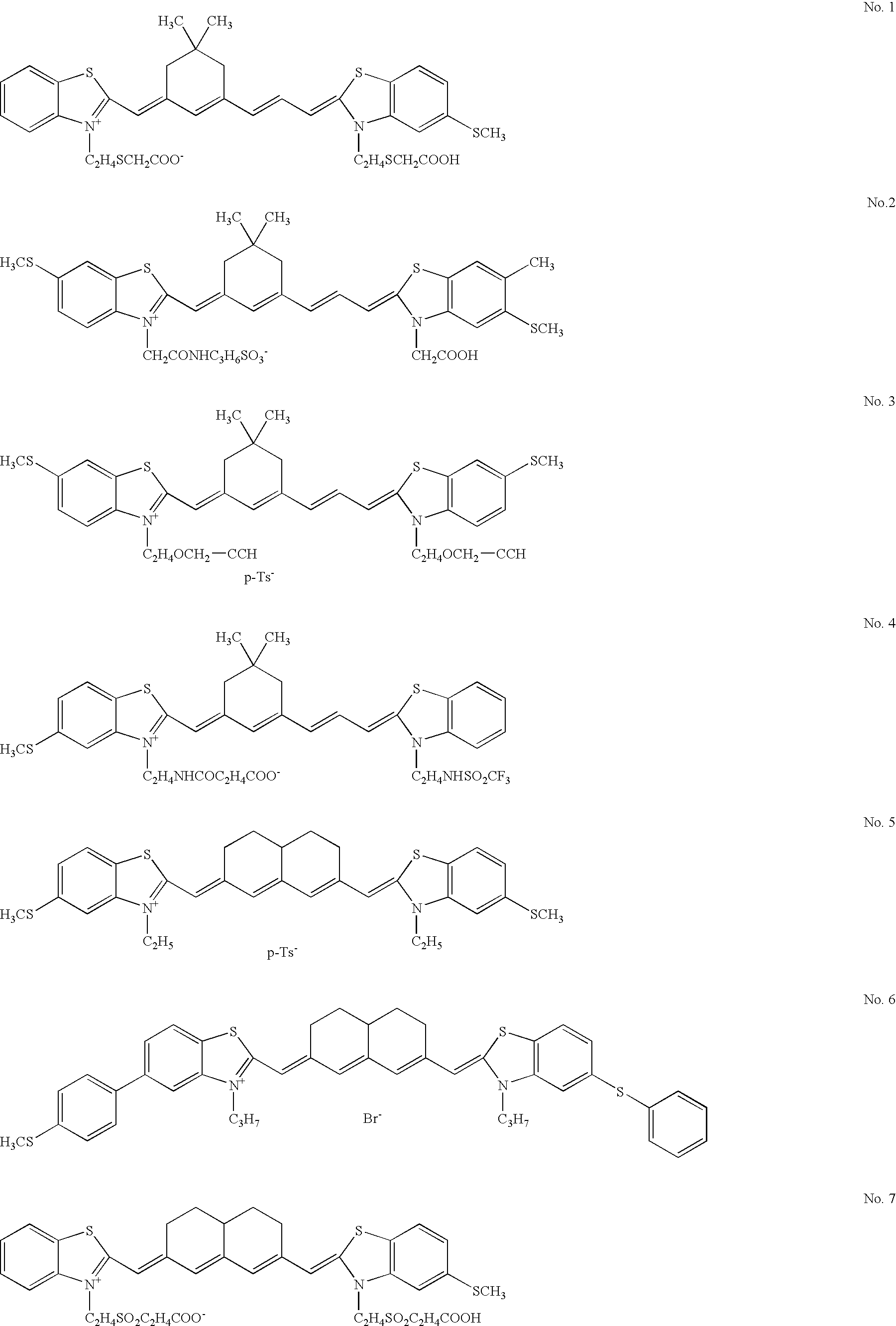

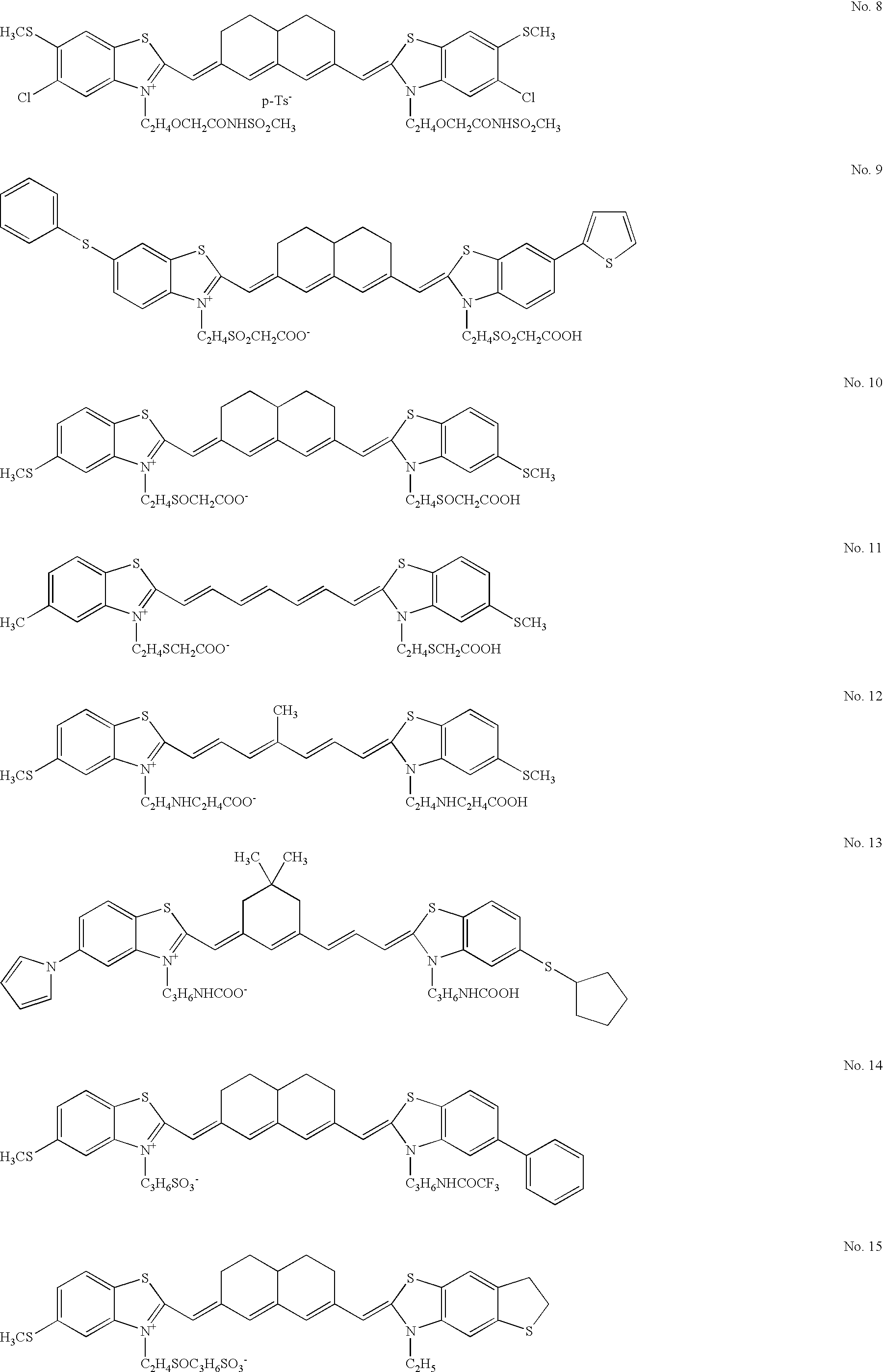

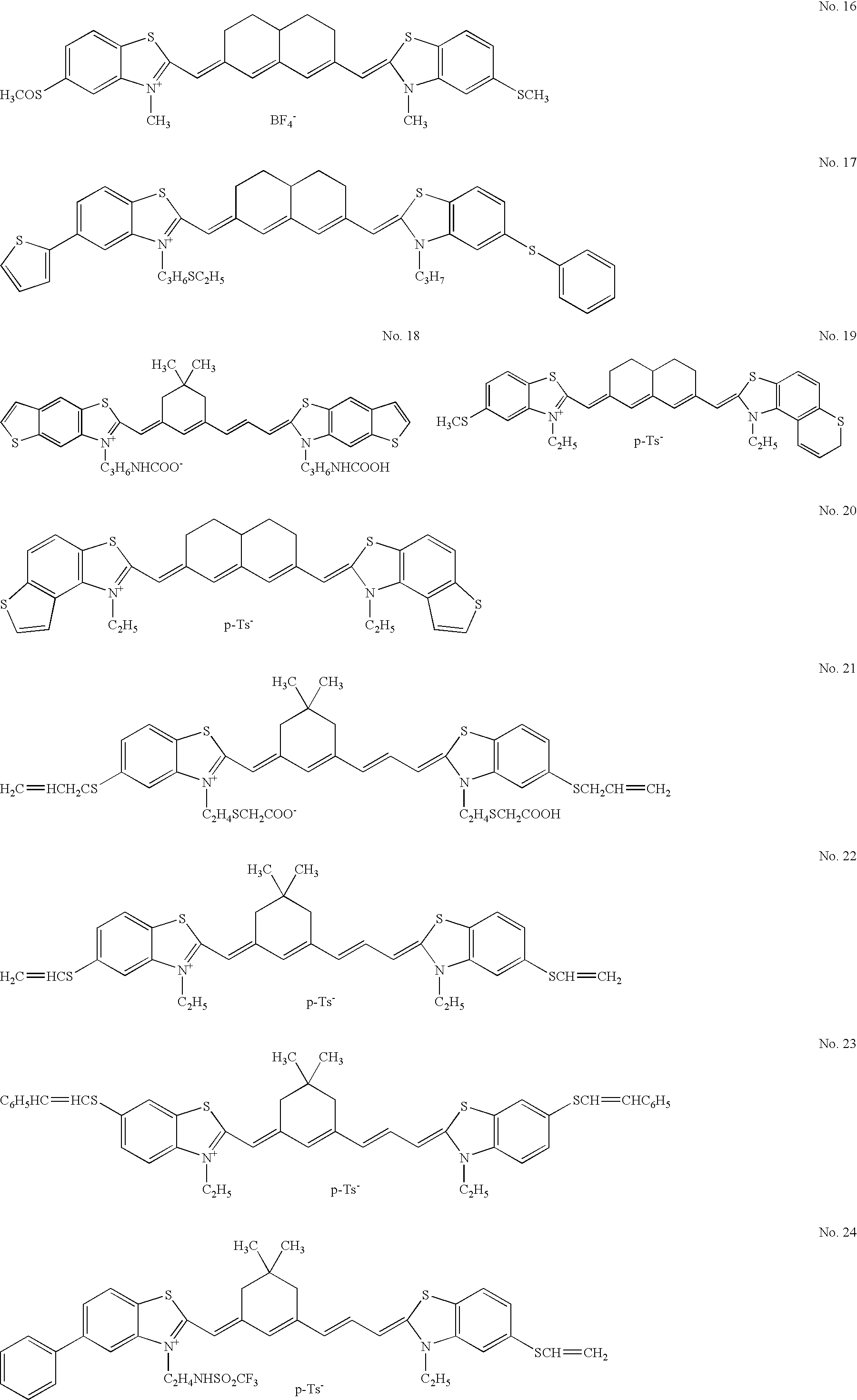

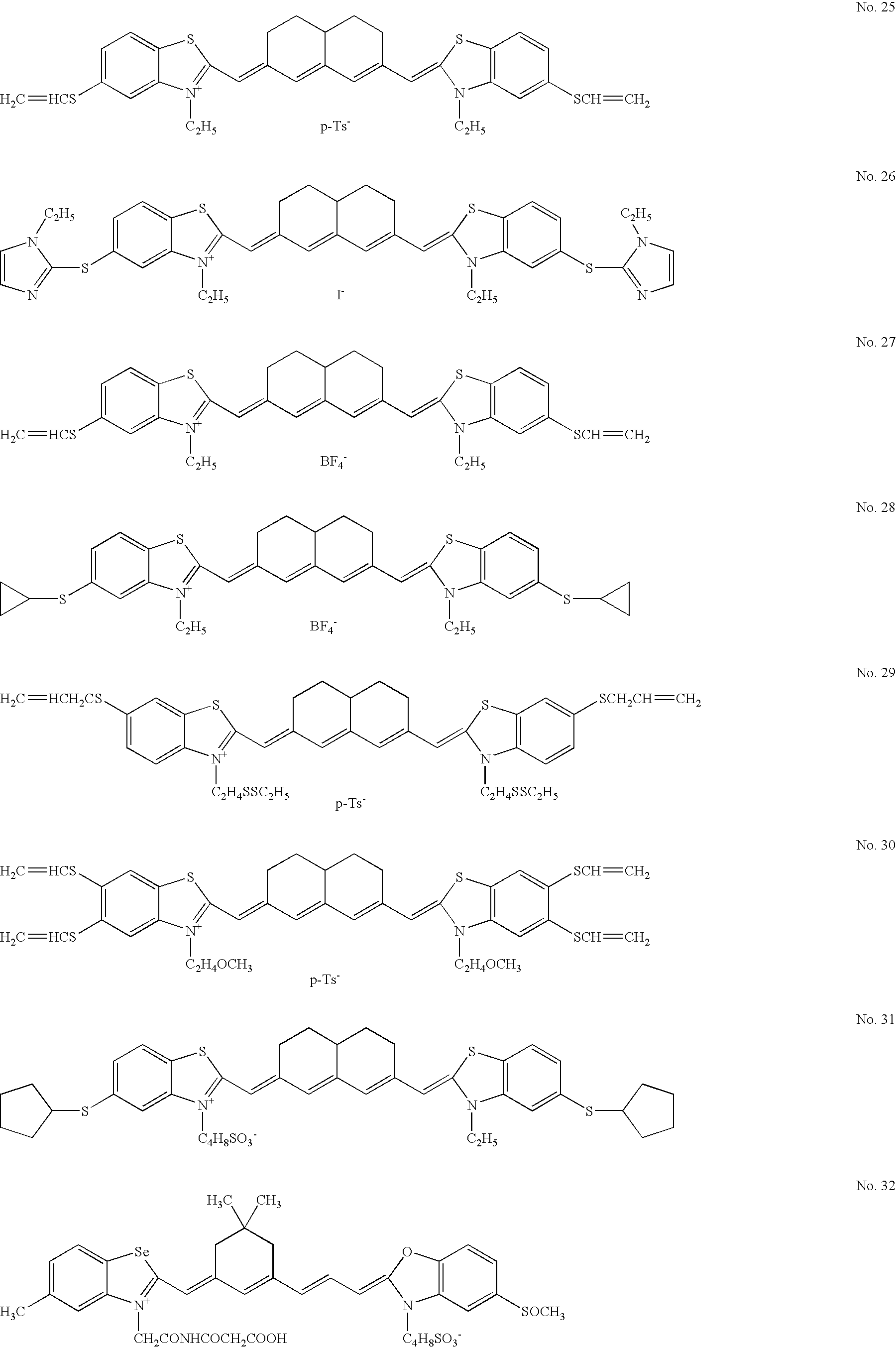

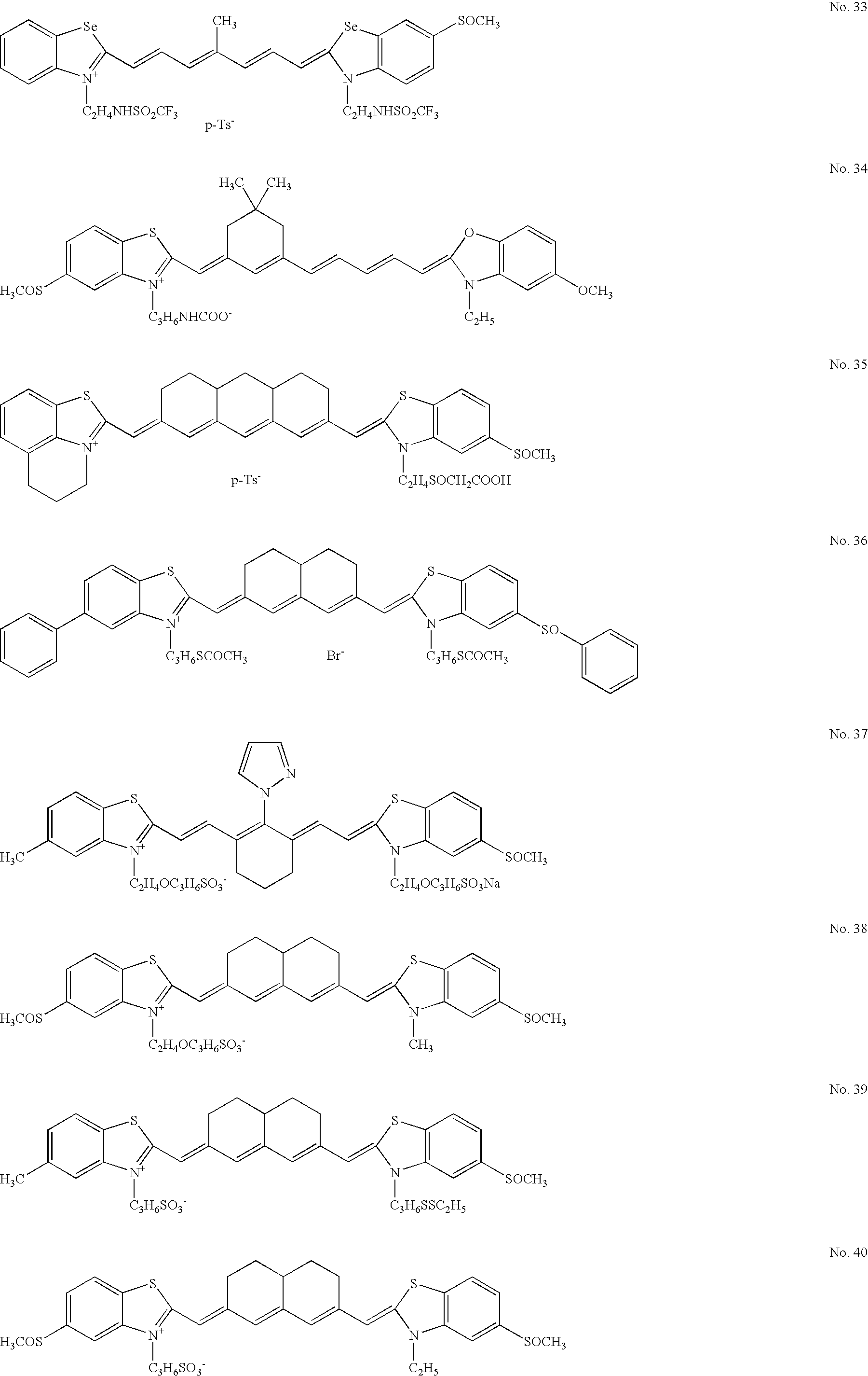

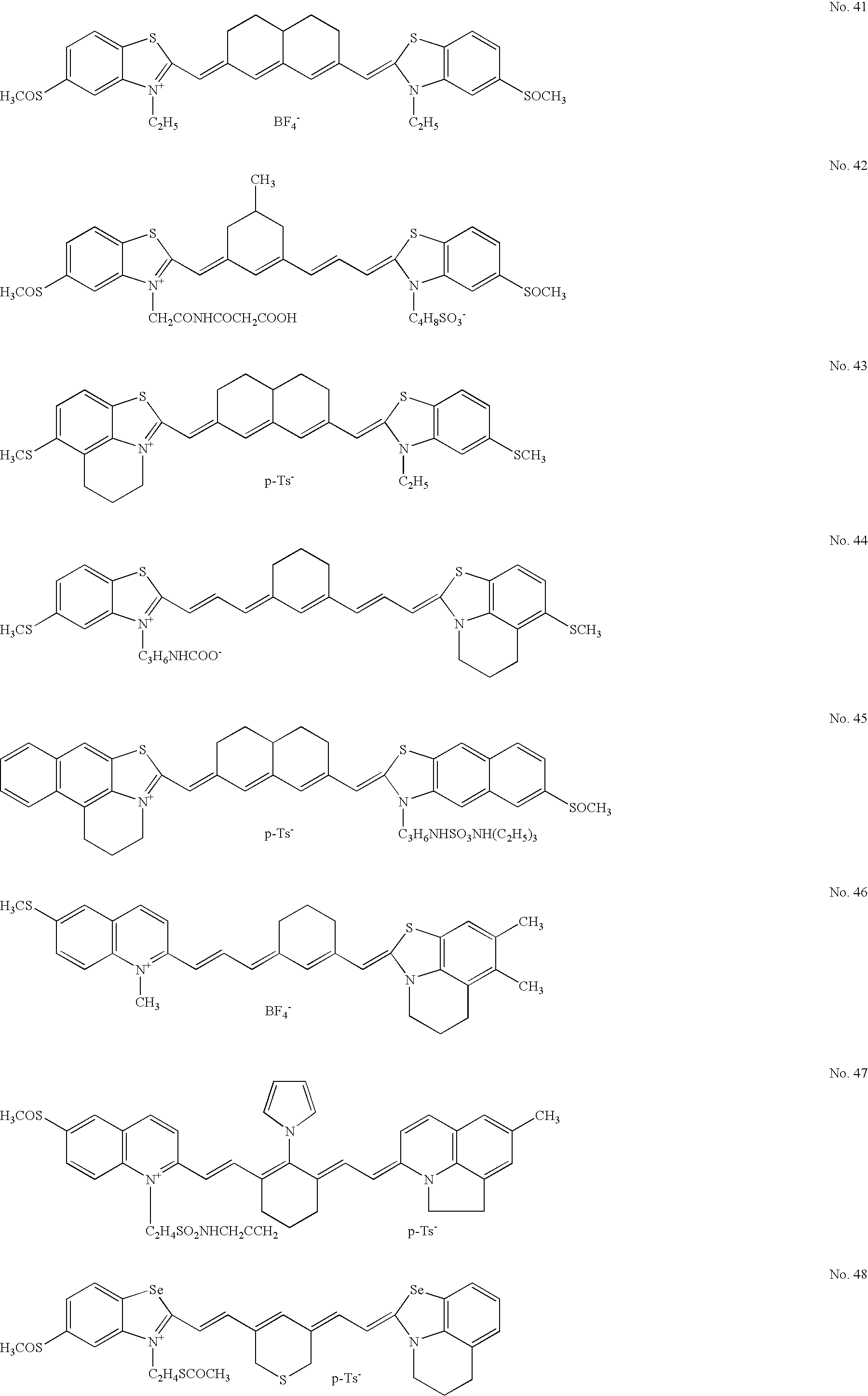

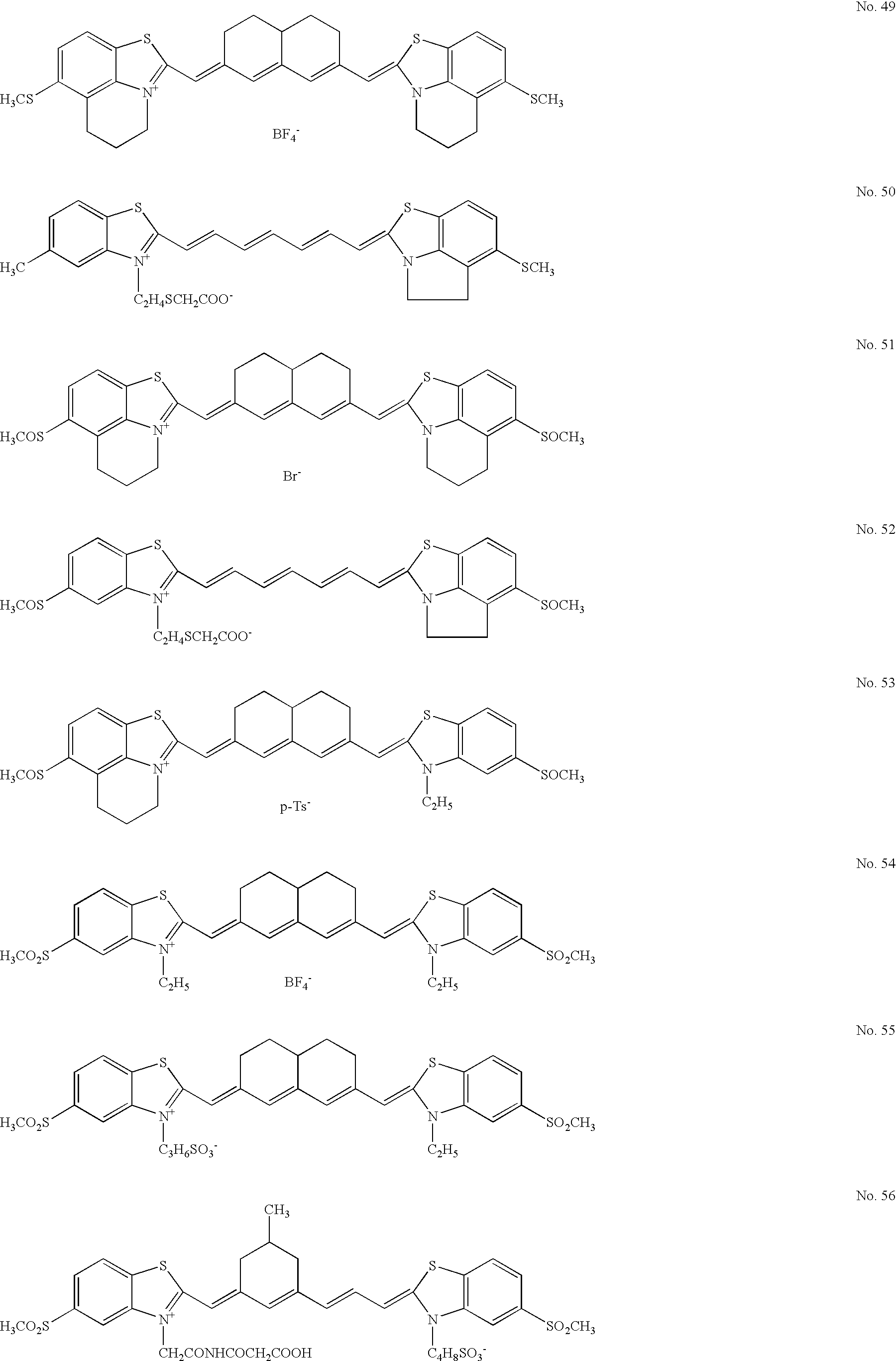

Infrared sensitizing dyes represented by formulae (3a) to (3d) used in the invention may be synthesized by methods described, for example, in F. M. Hamer, The Chemistry of Heterocyclic Compounds, Vol. 18, The Cyanine Dyes and Related Compounds, A. weissberger ed., Interscience, New York, 1964; JP-A Nos. 3-138638 and 10-73900; JP-W No. 9-510022; U.S. Pat. No. 2,734,900; British Patent No. 774779; and Japanese Patent Application Nos. 10-269843 and 11-58686.

In this invention, the infrared sensitizing dyes represented by formulae (3a) to (3d) may be used singly, or in combination with each other. A mol value of the singly used dye or the total of the dyes used in combination is 1×10⁻⁶ to 5×10⁻³ mol, preferably 1×10⁻⁵ to 2.5×10⁻³ mol, more preferably 4×10⁻⁵ to 1×10⁻³ mol, per one mol of the silver halide, in the silver halide emulsion. In the invention, in the case of using a plurality of sensitizing dyes in combination, the sensitizing dyes may be used with an optional mixing ratio in the silver halide emulsion.

In the invention, a conventionally known sensitizing dye may be used with the spectral sensitizer of formulae (3a) to (3d) for the photosensitive silver halide. The known sensitizing dyes and methods for adding the dyes are described in: JP-A No. 11-65021, paragraphs 0103 to 0109; JP-A No. 10-186572, compounds represented by general formula (II); JP-A No. 11-119374, dyes represented by general formula (I) and paragraph 0106; U.S. Pat. No. 5,510,236; U.S. Pat. No. 3,871,887, dyes described in Example 5; JP-A No. 2-96131; JP-A No. 59-48753, dyes disclosed therein; EP 0803764A1, page 19, line 38 to page 20, line 35; Japanese Patent Application Nos. 2000-86865, 2000-102560 and 2000-205399; etc. These sensitizing dyes may be used singly or in combination of a plurality thereof. The sensitizing dye is preferably added to the silver halide emulsion after the desalting step and before the application step.

A supersensitizer may be used in the invention to increase spectral sensitization efficiency. Examples of the supersensitizer used in the invention include compounds disclosed in EP-A No. 587,338; U.S. Pat. Nos. 3,877,943 and 4,873,184; JP-A Nos. 5-341432, 11-109547 and 10-111543; and the like.

12) Compound that can be One-Electron-Oxidized to Provide a One-Electron Oxidation Product which Releases One or More Electrons

The photothermographic material of the invention preferably contains a compound that can be one-electron-oxidized to provide a one-electron oxidation product which releases one or more electrons. The said compound can be used in combination with various chemical sensitizers described above to increase the sensitivity of silver halide.

As the compound that can be one-electron-oxidized to provide a one-electron oxidation product which releases one or more electrons is a compound selected from the following Groups 1 to 5.

(Group 1) a compound that can be one-electron-oxidized to provide a one-electron oxidation product which further releases at least two electrons, due to being subjected to a subsequent bond cleavage reaction;

(Group 2) a compound that has at least two groups adsorptive to the silver halide and can be one-electron-oxidized to provide a one-electron oxidation product which further releases one electron, due to being subjected to a subsequent bond cleavage reaction;

(Group 3) a compound that can be one-electron-oxidized to provide a one-electron oxidation product, which further releases at least one electron after being subjected to a subsequent bond formation;

(Group 4) a compound that can be one-electron-oxidized to provide a one-electron oxidation product which further releases at least one electron after a subsequent intramolecular ring cleavage reaction; and

(Group 5) a compound represented by X—Y, in which X represents a reducible group and Y represents a leaving group, and convertable by one-electron-oxidizing the reducible group to a one-electron oxidation product which can be converted into an X radical by eliminating the leaving group in a subsequent X—Y bond cleavage reaction, one electron being released from the X radical.

Each compound of Group 1 and Groups 3 to 5 preferably is a “compound having a sensitizing dye moiety” or a “compound having an adsorptive group to the silver halide”. More preferred is a “compound having an adsorptive group to the silver halide”. Each compound of Groups 1 to 4 more preferably is a “compound having a heterocyclic group containing nitrogen atoms substituted by two or more mercapto groups”.

The compound of Groups 1 to 5 will be described in detail below.

In the compound of Group 1, the term “the bond cleavage reaction” specifically means a cleavage reaction of a bond of carbon-carbon, carbon-silicon, carbon-hydrogen, carbon-boron, carbon-tin or carbon-germanium. Cleavage of a carbon-hydrogen bond may be followed after the cleavage reaction. The compound of Group 1 can be one-electron-oxidized to be converted into the one-electron oxidation product, and thereafter can release further two or more electrons, preferably three or more electrons with the bond cleavage reaction.

The compound of Group 1 is preferably represented by any one of general formulae (A), (B), (1), (2) and (3).

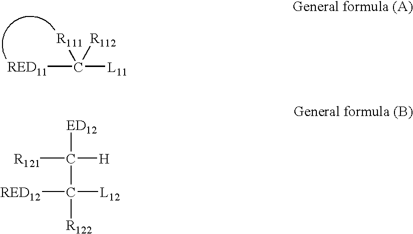

In general formula (A), RED₁₁ represents a reducible group that can be one-electron-oxidized, and L₁₁ represents a leaving group. R₁₁₂ represents a hydrogen atom or a substituent. R₁₁₁ represents a nonmetallic atomic group forming a tetrahydro-, hexahydro- or octahydro-derivative of a 5- or 6-membered aromatic ring including aromatic heterocycles.

In general formula (B), RED₁₂ represents a reducible group that can be one-electron-oxidized, and L₁₂ represents a leaving group. R₁₂₁ and R₁₂₂ each represent a hydrogen atom or a substituent. ED₁₂ represents an electron-donating group. In general formula (B), R₁₂₁ and RED₁₂, R₁₂₁, and R₁₂₂, and ED₁₂ and RED₁₂ may bond together to form a ring structure, respectively.

In the compound represented by general formula (A) or (B), the reducible group of RED₁₁ or RED₁₂ is one-electron-oxidized, and thereafter the leaving group of L₁₁ or L₁₂ is spontaneously eliminated in the bond cleavage reaction. Further two or more, preferably three or more electrons can be released with the bond cleavage reaction.

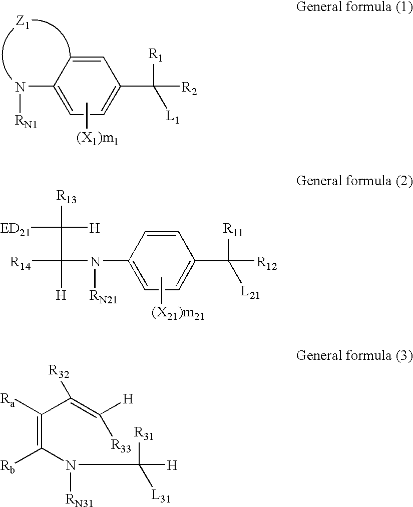

In general formula (1), Z₁ represents an atomic group forming a 6-membered ring with a nitrogen atom and 2 carbon atoms in a benzene ring; R₁, R₂ and R_{N1} each represent a hydrogen atom or a substituent; X₁ represents a substituent capable of substituting for a hydrogen atom on a benzene ring; m₁ represents an integer from 0 to 3; and L₁ represents a leaving group. In general formula (2), ED₂₁ represents an electron-donating group; R₁₁, R₁₂₁ R_{N21}, R₁₃ and R₁₄ each represent a hydrogen atom or a substituent; X₂₁ represents a substituent capable of substituting for a hydrogen atom on a benzene ring; m₂₁ represents an integer from 0 to 3; and L₂₁ represents a leaving group. R_{N21}, R₁₃, R₁₄, X₂₁ and ED₂₁ may bond to each other to form a ring structure. In general formula (3), R₃₂, R₃₃, R₃₁, R_{N31}, Rₐ and R_{b} each represent a hydrogen atom or a substituent; and L₃₁ represents a leaving group. Incidentally, Rₐ and R_{b} bond together to form an aromatic ring when R_{N31} is not an aryl group.

After the compound is one-electron-oxidized, the leaving group of L₁, L₂₁ or L₃₁ is spontaneously eliminated in the bond cleavage reaction. Further two or more, preferably three or more electrons can be released with the bond cleavage reaction.

First, the compound represented by general formula (A) will be described in detail below.

In general formula (A), the reducible group of RED₁₁ can be one-electron-oxidized and can bond to after-mentioned R₁₁₁ to form the particular ring structure. Specifically, the reducible group may be a divalent group provided by removing one hydrogen atom from the following monovalent group at a position suitable for ring formation.

The monovalent group may be an alkylamino group; an arylamino group such as an anilino group and a naphthylamino group; a heterocyclic amino group such as a benzthiazolylamino group and a pyrrolylamino group; an alkylthio group; an arylthio group such as a phenylthio group; a heterocyclic thio group; an alkoxy group; an aryloxy group such as a phenoxy group; a heterocyclic oxy group; an aryl group such as a phenyl group, a naphthyl group and an anthranil group; or an aromatic or nonaromatic heterocyclic group, containing at least one heteroatom selected from the group consisting of a nitrogen atom, a sulfur atom, an oxygen atom and a selenium atom, which has a 5- to 7-membered, monocyclic or condensed ring structure such as a tetrahydroquinoline ring, a tetrahydroisoquinoline ring, a tetrahydroquinoxaline ring, a tetrahydroquinazoline ring, an indoline ring, an indole ring, an indazole ring, a carbazole ring, a phenoxazine ring, a phenothiazine ring, a benzothiazoline ring, a pyrrole ring, an imidazole ring, a thiazoline ring, a piperidine ring, a pyrrolidine ring, a morpholine ring, a benzimidazole ring, a benzimidazoline ring, a benzoxazoline ring and a methylenedioxyphenyl ring. RED₁₁ is hereinafter described as the monovalent group for convenience. The monovalent groups may have a substituent.

Examples of the substituent include halogen atoms; alkyl groups including aralkyl groups, cycloalkyl groups, active methine groups, etc.; alkenyl groups; alkynyl groups; aryl groups; heterocyclic groups, which may bond at any position; heterocyclic groups containing a quaternary nitrogen atom such as a pyridinio group, an imidazolio group, a quinolinio group and an isoquinolinio group; acyl groups; alkoxycarbonyl groups; aryloxycarbonyl groups; carbamoyl groups; a carboxy group and salts thereof; sulfonylcarbamoyl groups; acylcarbamoyl groups; sulfamoylcarbamoyl groups; carbazoyl groups; oxalyl groups; oxamoyl groups; a cyano group; carbonimidoyl groups; thiocarbamoyl groups; a hydroxy group; alkoxy groups, which may contain a plurality of ethyleneoxy groups or propyleneoxy groups as a repetition unit; aryloxy groups; heterocyclic oxy groups; acyloxy groups; alkoxy or aryloxy carbonyloxy groups; carbamoyloxy groups; sulfonyloxy groups; amino groups; alkyl, aryl or heterocyclic amino groups; acylamino groups; sulfoneamide groups; ureide groups; thioureide groups; imide groups; alkoxy or aryloxy carbonylamino groups; sulfamoylamino groups; semicarbazide groups; thiosemicarbazide groups; hydrazino groups; ammonio groups; oxamoylamino groups; alkyl or aryl sulfonylureide groups; acylureide groups; acylsulfamoylamino groups; a nitro group; a mercapto group; alkyl, aryl or heterocyclic thio groups; alkyl or aryl sulfonyl groups; alkyl or aryl sulfinyl groups; a sulfo group and salts thereof; sulfamoyl groups; acylsulfamoyl groups; sulfonylsulfamoyl groups and salts thereof; groups containing a phosphoric amide or phosphate ester structure; etc. These substituents may be further substituted by these substituents.

RED₁₁ is preferably an alkylamino group, an arylamino group, a heterocyclic amino group, an aryl group, an aromatic heterocyclic group, or nonaromatic heterocyclic group. RED₁₁ is more preferably an arylamino group (particularly an anilino group), or an aryl group (particularly a phenyl group). When RED₁₁ has a substituent, preferred as a substituent include halogen atoms, alkyl groups, alkoxy groups, carbamoyl groups, sulfamoyl groups, acylamino groups, sulfoneamide groups. When RED₁₁ is an aryl group, it is preferred that the aryl group has at least one “electron-donating group”. The “electron-donating group” is a hydroxy group; an alkoxy group; a mercapto group; a sulfoneamide group; an acylamino group; an alkylamino group; an arylamino group; a heterocyclic amino group; an active methine group; an electron-excess, aromatic, heterocyclic group with a 5-membered monocyclic ring or a condensed-ring including at least one nitrogen atom in the ring such as an indolyl group, a pyrrolyl group, an imidazolyl group, a benzimidazolyl group, a thiazolyl group, a benzthiazolyl group and an indazolyl group; a nitrogen-containing, nonaromatic heterocyclic group that substitutes at the nitrogen atom, such as so-called cyclic amino group like pyrrolidinyl group, an indolinyl group, a piperidinyl group, a piperazinyl group and a morpholino group; etc.

The active methine group is a methine group having two “electron-withdrawing groups”, and the “electron-withdrawing group” is an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group or a carbonimidoyl group. The two electron-withdrawing groups may bond together to form a ring structure.

In general formula (A), specific examples of L₁₁ include a carboxy group and salts thereof, silyl groups, a hydrogen atom, triarylboron anions, trialkylstannyl groups, trialkylgermyl groups and a —CR_{C1}R_{C2}R_{C3} group. When L₁₁ represents a silyl group, the silyl group is specifically a trialkylsilyl group, an aryldialkylsilyl group, a triarylsilyl group, etc, and they may have a substituent.

When L₁₁ represents a salt of a carboxy group, specific examples of a counter ion to form the salt include alkaline metal ions, alkaline earth metal ions, heavy metal ions, ammonium ions, phosphonium ions, etc. Preferred as a counter ion are alkaline metal ions and ammonium ions, most preferred are alkaline metal ions such as Li⁺, Na⁺ and K⁺.

When L₁₁ represents a —CR_{C1}R_{C2}R_{C3} group, R_{C1}, R_{C2} and R_{C3} independently represent a hydrogen atom, an alkyl group, an aryl group, a heterocyclic group, an alkylthio group, an arylthio group, an alkylamino group, an arylamino group, a heterocyclic amino group, an alkoxy group, an aryloxy group or a hydroxy group. R_{C1}, R_{C2} and R_{C3} may bond to each other to form a ring structure, and may have a substituent. Incidentally, when one of R_{C1}, R_{C2} and R_{C3} is a hydrogen atom or an alkyl group, there is no case where the other two of them are a hydrogen atom or an alkyl group. R_{C1}, R_{C2} and R_{C3} are preferably an alkyl group, an aryl group (particularly a phenyl group), an alkylthio group, an arylthio group, an alkylamino group, an arylamino group, a heterocyclic group, an alkoxy group or a hydroxy group, respectively. Specific examples thereof include a phenyl group, a p-dimethylaminophenyl group, a p-methoxyphenyl group, a 2,4-dimethoxyphenyl group, a p-hydroxyphenyl group, a methylthio group, a phenylthio group, a phenoxy group, a methoxy group, an ethoxy group, a dimethylamino group, an N-methylanilino group, a diphenylamino group, a morpholino group, a thiomorpholino group, a hydroxy group, etc. Examples of the ring structure formed by R_{C1}, R_{C2} and R_{C3} include a 1,3-dithiolane-2-yl group, a 1,3-dithiane-2-yl group, an N-methyl-1,3-thiazolidine-2-yl group, an N-benzyl-benzothiazolidine-2-yl group, etc.

It is also preferred that the —CR_{C1}R_{C2}R_{C3} group is the same as a residue provided by removing L₁₁ from general formula (A) as a result of selecting each of R_{C1}, R_{C2} and R_{C3} as above.

In general formula (A), L₁₁ is preferably a carboxy group or a salt thereof, or a hydrogen atom, more preferably a carboxy group or a salt thereof.

When L₁₁ represents a hydrogen atom, the compound represented by general formula (A) preferably has a base moiety. After the compound represented by general formula (A) is oxidized, the base moiety acts to eliminate the hydrogen atom of L₁₁ and to release an electron.

The base is specifically a conjugate base of an acid with a pKa value of approximately 1 to 10. For example, the base moiety may contain a structure of a nitrogen-containing heterocycle such as pyridine, imidazole, benzoimidazole and thiazole; aniline; trialkylamine; an amino group; a carbon acid such as an active methylene anion; a thioacetic acid anion; carboxylate (—COO⁻); sulfate (—SO₃⁻); amineoxide (>N⁺(O⁻)—); and derivatives thereof. The base is preferably a conjugate base of an acid with a pKa value of approximately 1 to 8, more preferably carboxylate, sulfate or amineoxide, particularly preferably carboxylate. When these bases have an anion, the compound of general formula (A) may have a counter cation. Examples of the counter cation include alkaline metal ions, alkaline earth metal ions, heavy metal ions, ammonium ions, phosphonium ions, etc. The base moiety may be at an optional position of the compound represented by general formula (A). The base moiety may be connected to RED₁₁, R₁₁₁ or R₁₁₂ in general formula (A), and to a substituent thereon.

In general formula (A), R₁₁₂ represents a substituent capable of substituting a hydrogen atom or a carbon atom therewith, provided that R₁₁₂ and L₁₁ do not represent the same group.

R₁₁₂ preferably represents a hydrogen atom, an alkyl group, an aryl group (such as a phenyl group), an alkoxy group (such as a methoxy group, a ethoxy group, a benzyloxy group), a hydroxy group, an alkylthio group, (such as a methylthio group, a butylthio group), and amino group, an alkylamino group, an arylamino group, a heterocyclic amino group or the like; and more preferably represents a hydrogen atom, an alkyl group, an alkoxy group, a hydroxy group, a phenyl group and an alkylamino group.

Ring structures formed by R₁₁₁ in general formula (A) are ring structures corresponding to a tetrahydro structure, a hexahydro structure, or an octahydro structure of a five-membered or six-membered aromatic ring (including an aromatic hetro ring), wherein a hydro structure means a ring structure in which partial hydrogenation is performed on a carbon-carbon double bond (or a carbon-nitrogen double bond) contained in an aromatic ring (an aromatic hetero ring) as a part thereof, wherein the tetrahydro structure is a structure in which 2 carbon-carbon double bonds (or carbon-nitrogen double bonds) are hydrogenated, the hexahydro structure is a structure in which 3 carbon-carbon double bonds (or carbon-nitrogen double bonds) are hydrogenated, and the octahydro structure is a structure in which 4 carbon-carbon double bonds (or carbon-nitrogen double bonds) are hydrogenated. Hydrogenation of an aromatic ring produces a partially hydrogenated non-aromatic ring structure.

Examples include a pyrrolidine ring, an imidazolidine ring, a thiazolidine ring, a pyrazolidine ring, an oxazolidine ring, a piperidine ring, a tetrahydropyridine ring, a tetrahydropyrimidine ring, a piperazine ring, a tetralin ring, a tetrahydroquinoline ring, a tetrahydroisoquinoline ring, a tetrahydroquinazoline ring and a tetrahydroquinoxaline ring, a tetrahydrocarbazole ring, an octahydrophenanthridine ring and the like. The ring structures may have any substituent therein.

More preferable examples of a ring structure forming R₁₁₁ include a pyrrolidine ring, an imidazolidine ring, a piperidine ring, a tetrahydropyridine ring, a tetrahydropyrimidine ring, a piperazine ring, a tetrahydroquinoline ring, a tetrahydroisoquinoline ring, a tetrahydroquinazoline ring, a tetrahydroquinoxaline ring and a tetracarbazole ring. Particularly preferable examples include a pyrrolidine ring, a piperidine ring, a piperazine ring, a tetrahydropyridine ring, a tetrahydroquinoline ring, a tetrahydroisoquinoline ring, a tetrahydroquinazoline ring and a tetrahydroquinoxaline ring; and most preferable examples include a pyrrolidine ring, a piperidine ring, a tetrahydropyridine ring, a tetrahydroquinoline ring and a tetrahydroisoquinoline ring.

In general formula (B), RED₁₂ and L₁₂ represent groups having the respective same meanings as RED₁₁ and L₁₁ in general formula (A), and have the respective same preferable ranges as RED₁₁ and L₁₁ in general formula (A). RED₁₂ is a monovalent group except a case where RED₁₂ forms the following ring structure and to be concrete, there are exemplified groups each with a name of a monovalent group described as RED₁₁. RED₁₂₁ and L₁₂₂ represent groups having the same meaning as R₁₁₂ in general formula (A), and have the same preferable range as R₁₁₂ in general formula (A). ED₁₂ represents an electron-donating group. Each pair of R₁₂₁ and RED₁₂; R₁₂₁ and R₁₂₂; or ED₁₂ and RED₁₂ may form a ring structure by bonding with each other.

An electron-donating group represented by RED₁₂ in general formula (B) is the same as an electron-donating group described as a substituent when RED₁₁ represents an aryl group. Preferable examples of RED₁₂ include a hydroxy group, an alkoxy group, a mercapto group, a sulfonamide group, an alkylamino group, an arylamino group, an active methine group, an electron-excessive aromatic heterocyclic group in a five-membered single ring or fused ring structure containing at least one nitrogen atom in a ring structure as part of the ring, a non-aromatic nitrogen containing hetrocyclic group having a nitrogen atom as a substitute, and a phenyl group substituted with an electron donating group described above, and more preferable examples thereof include a non-aromatic nitrogen containing heterocyclic group further substituted with a hydroxy group, a mercapto group, a sulfonamide group, an alkylamino group, an arylamino group, an active methine group, or a nitrogen atom; and a phenyl group substituted with an electron-donating group described above (for example, a p-hydroxyphenyl group, a p-dialkylaminophenyl group, an o- or p-dialkoxyphenyl group and the like).

In general formula (B), R₁₂, and RED₁₂; R₁₂₂ and R₁₂₁; or ED₁₂ and RED₁₂ may bond to each other to form a ring structure. A ring structure formed here is a non-aromatic carbon ring or hetero ring in a 5- to 7-membered single ring or fused ring structure which is substituted or unsubstituted. Concrete examples of a ring structure formed from R₁₂₁ and RED₁₂ include, in addition to the examples of the ring structure formed by R₁₁₁ in general formula (A), a pyrroline ring, an imidazoline ring, a thiazoline ring, a pyrazoline ring, an oxazoline ring, an indan ring, a morphorine ring, an indoline ring, a tetrahydro-1,4-oxazine ring, 2,3-dihydrobenzo-1,4-oxazine ring, a tetrahydro-1,4-thiazine ring, 2,3-dihydrobenzo-1,4-thiazine ring, 2,3-dihydrobenzofuran ring, 2,3-dihydrobenzothiophene ring and the like. In formation of a ring structure from ED₁₂ and RED₁₂, ED₁₂ is preferably an amino group, an alkylamino group or an arylamino group and concrete examples of the ring structure include a tetrahyropyrazine ring, a piperazine ring, a tetrahydroquinoxaline ring, a tetrahydroisoquinoline ring and the like. Concrete examples of a ring structure formed from R₁₂₂ and R₁₂₁ include a cyclohexane ring, a cyclopentane ring and the like.

Below, description will be given of general formulae (1) to (3).

In general formulae (1) to (3), R₁, R₂, R₁₁, R₁₂ and R₃₁ represent the same meaning as R₁₁₂ of general formula (A) and have the same preferable range as R₁₁₂ of general formula (A). L₁, L₂₁ and L₃₁ independently represents the same leaving groups as the groups shown as concrete examples in description of L₁₁ of general formula (A) and also have the same preferable range as L₁ of general formula (A). The substituents represented by X₁ and X₂₁ are the same as the examples of substituents of RED₁₁ of general formula (A) and have the same preferable range as RED₁₁ of general formula (A). m₁ and m₂ are preferably integers from 0 to 2 and more preferably integer of 0 or 1.

When R_{N1}, R_{N21} and R_{N31} each represent a substituent, preferred as a substituent include an alkyl group, an aryl group or a heterocyclic group, and may further have a substituent. Each of R_{N1}, R_{N21} and R_{N31} is preferably a hydrogen atom, an alkyl group or an aryl group, more preferably a hydrogen atom or an alkyl group.

When R₁₃, R₁₄, R₃₂, R₃₃, Rₐ and R_{b} independently represent a substituent, the substituent is preferably an alkyl group, an aryl group, an acyl group, an alkoxycarbonyl group, a carbamoyl group, a cyano group, an alkoxy group, an acylamino group, a sulfoneamide group, a ureide group, a thiouredide group, an alkylthio group, an arylthio group, an alkylsulfonyl group, an arylsulfonyl group, or a sulfamoyl group.

The 6-membered ring formed by Z₁ in general formula (1) is a nonaromatic heterocycle condensed with the benzene ring in general formula (1). The ring structure containing the nonaromatic heterocycle and the benzene ring to be condensed may be specifically a tetrahydroquinoline ring, a tetrahydroquinoxaline ring, or a tetrahydroquinazoline ring, which may have a substituent.

In general formula (2), ED₂₁ is the same as ED₁₂ in general formula (B) with respect to the meanings and preferred embodiments.

In general formula (2), any two of R_{N21}, R₁₃, R₁₄, X₂₁ and ED₂₁ may bond together to form a ring structure. The ring structure formed by R_{N21} and X₂₁ is preferably a 5- to 7-membered, carbocyclic or heterocyclic, nonaromatic ring structure condensed with a benzene ring, and specific examples thereof include a tetrahydroquinoline ring, a tetrahydroquinoxaline ring, an indoline ring, a 2,3-dihydro-5,6-benzo-1,4-thiazine ring, etc. Preferred are a tetrahydroquinoline ring, a tetrahydroquinoxaline ring and an indoline ring.

When R_{N31} is a group other than an aryl group in general formula (3), Rₐ and R_{b} bond together to form an aromatic ring. The aromatic ring is an aryl group such as a phenyl group and a naphthyl group, or an aromatic heterocyclic group such as a pyridine ring group, a pyrrole ring group, a quinoline ring group and an indole ring group, preferably an aryl group. The aromatic ring group may have a substituent.

In general formula (3), Rₐ and R_{b} preferably bond together to form an aromatic ring, particularly a phenyl group.

In general formula (3), R₃₂ is preferably a hydrogen atom, an alkyl group, an aryl group, a hydroxy group, an alkoxy group, a mercapto group or an amino group. When R₃₂ is a hydroxy group, R₃₃ is preferably an electron-withdrawing group. The electron-withdrawing group is the same as described above, preferably an acyl group, an alkoxycarbonyl group, a carbamoyl group or a cyano group.

The compound of Group 2 will be described below.

According to the compound of Group 2, the “bond cleavage reaction” is a cleavage reaction of a bond of carbon-carbon, carbon-silicon, carbon-hydrogen, carbon-boron, carbon-tin or carbon-germanium. Cleavage of a carbon-hydrogen bond may be caused with the cleavage reaction.

The compound of Group 2 has two or more, preferably 2 to 6, more preferably 2 to 4, adsorbent groups to the silver halide. The adsorptive group is further preferably a mercapto-substituted, nitrogen-containing, heterocyclic group. The adsorptive group will hereinafter be described.

The compound of Group 2 is preferably represented by the following general formula (C).

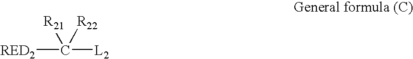

In the compound represented by general formula (C), the reducible group of RED₂ is one-electron-oxidized, and thereafter the leaving group of L₂ is spontaneously eliminated, thus a C (carbon atom)-L₂ bond is cleaved, in the bond cleavage reaction. Further one electron can be released with the bond cleavage reaction.

In general formula (C), RED₂ is the same as RED₁₂ in general formula (B) with respect to the meanings and preferred embodiments. L₂ is the same as L₁₁ in general formula (A) with respect to the meanings and preferred embodiments. Incidentally, when L₂ is a silyl group, the compound of general formula (C) has two or more mercapto-substituted, nitrogen-containing, heterocyclic groups as the adsorbent groups. R₂₁ and R₂₂ each represent a hydrogen atom or a substituent, and are the same as R₁₁₂ in general formula (A) with respect to the meanings and preferred embodiments. RED₂ and R₂₁ may bond together to form a ring structure.

The ring structure is a 5- to 7-membered, monocyclic or condensed, carbocyclic or heterocyclic, nonaromatic ring, and may have a substituent. Incidentally, there is no case where the ring structure corresponds to a tetrahydro-, hexahydro- or octahydro-derivative of an aromatic ring or an aromatic heterocycle. The ring structure is preferably such that corresponds to a dihydro-derivative of an aromatic ring or an aromatic heterocycle, and specific examples thereof include a 2-pyrroline ring, a 2-imidazoline ring, a 2-thiazoline ring, a 1,2-dihydropyridine ring, a 1,4-dihydropyridine ring, an indoline ring, a benzoimidazoline ring, a benzothiazoline ring, a benzoxazoline ring, a 2,3-dihydrobenzothiophene ring, a 2,3-dihydrobenzofuran ring, a benzo-α-pyran ring, a 1,2-dihydroquinoline ring, a 1,2-dihydroquinazoline ring, a 1,2-dihydroquinoxaline ring, etc. Preferred are a 2-imidazoline ring, a 2-thiazoline ring, an indoline ring, a benzoimidazoline ring, a benzothiazoline ring, a benzoxazoline ring, a 1,2-dihydro pyridine ring, a 1,2-dihydroquinoline ring, a 1,2-dihydroquinazoline ring and a 1,2-dihydroquinoxaline ring, more preferred are an indoline ring, a benzoimidazoline ring, a benzothiazoline ring and a 1,2-dihydroquinoline ring, particularly preferred is an indoline ring.

The compound of Group 3 will be described below.

According to the compound of Group 3, “bond formation” means that a bond of carbon-carbon, carbon-nitrogen, carbon-sulfur, carbon-oxygen, etc. is formed.

It is preferable that the one-electron oxidation product releases one or more electrons after an intramolecular bond-forming reaction between the one-electron-oxidized portion and a reactive site in the same molecular such as a carbon-carbon double bond, a carbon-carbon triple bond, an aromatic group and a benzo-condensed, nonaromatic heterocyclic group.

To be more detailed, a one-electron oxidized product (a cation radical species or a neutral radical species generated by elimination of a proton therefrom) formed by one electron oxidizing a compound of Group 3 reacts with a reactive group described above coexisting in the same molecule to form a bond and form a radical species having a new ring structure therein. The radical species have a feature to release a second electron directly or in company with elimination of a proton therefrom. One of compounds of Group 3 has a chance to further release one or more electrons, in a ordinary case two or more electrons, after formation of a two-electron oxidized product, after receiving a hydrolysis reaction in one case or after causing a tautomerization reaction accompanying direct migration of a proton in another case. Alternatively, compounds of Group 3 also include a compound having an ability to further release one or more electron, in an ordinary case two or more electrons directly from a two-electron oxidized product, not by way of a tautomerization reaction.

The compound of Group 3 is preferably represented by the following general formula (D).
RED₃-L₃-Y₃ General formula (D)

In general formula (D), RED₃ represents a reducible group that can be one-electron-oxidized, and Y₃ represents a reactive group that reacts with the one-electron-oxidized RED₃, specifically an organic group containing a carbon-carbon double bond, a carbon-carbon triple bond, an aromatic group or a benzo-condensed, nonaromatic heterocyclic group. L₃ represents a linking group that connects RED₃ and Y₃.

In general formula (D), RED₃ has the same meanings as RED₁₂ in general formula (B). In general formula (D), RED₃ is preferably an arylamino group, a heterocyclic amino group, an aryloxy group, an arylthio group, an aryl group, or an aromatic or nonaromatic heterocyclic group that is preferably a nitrogen-containing heterocyclic group. RED₃ is more preferably an arylamino group, a heterocyclic amino group, an aryl group, or an aromatic or nonaromatic heterocyclic group. Preferred as the heterocyclic group are a tetrahydroquinoline ring group, a tetrahydroquinoxaline ring group, a tetrahydroquinazoline ring group, an indoline ring group, an indole ring group, a carbazole ring group, a phenoxazine ring group, a phenothiazine ring group, a benzothiazoline ring group, a pyrrole ring group, an imidazole ring group, a thiazole ring group, a benzoimidazole ring group, a benzoimidazoline ring group, a benzothiazoline ring group, a 3,4-methylenedioxyphenyl-1-yl group, etc.

Particularly preferred as RED₃ are an arylamino group (particularly an anilino group), an aryl group (particularly a phenyl group), and an aromatic or nonaromatic heterocyclic group.

The aryl group represented by RED₃ preferably has at least one electron-donating group. The term “electron-donating group” means the same as above-mentioned electron-donating group.

When RED₃ is an aryl group, more preferred as a substituent on the aryl group are an alkylamino group, a hydroxy group, an alkoxy group, a mercapto group, a sulfoneamide group, an active methine group, and a nitrogen-containing, nonaromatic heterocyclic group that substitutes at the nitrogen atom, furthermore preferred are an alkylamino group, a hydroxy group, an active methine group, and a nitrogen-containing, nonaromatic heterocyclic group that substitutes at the nitrogen atom, and the most preferred are an alkylamino group, and a nitrogen-containing, nonaromatic heterocyclic group that substitutes at the nitrogen atom.

When Y₃ is an organic group containing carbon-carbon double bond (for example a vinyl group) having a substituent, more preferred as the substituent are an alkyl group, a phenyl group, an acyl group, a cyano group, an alkoxycarbonyl group, a carbamoyl group and an electron-donating group. The electron-donating group is preferably an alkoxy group; a hydroxy group (that may be protected by a silyl group, and examples of the silyl-protected group include a trimethylsilyloxy group, a t-butyldimethylsilyloxy group, a triphenylsilyloxy group, a triethylsilyloxy group, a phenyldimethylsilyloxy group, etc); an amino group; an alkylamino group; an arylamino group; a sulfoneamide group; an active methine group; a mercapto group; an alkylthio group; or a phenyl group having the electron-donating group as a substituent.

Incidentally, when the organic group containing the carbon-carbon double bond has a hydroxy group as a substituent, Y₃ contains a moiety of >C₁═C₂(—OH)—, which may be tautomerized into a moiety of >C₁H—C₂(═O)—. In this case, it is preferred that a substituent on the C₁ carbon is an electron-withdrawing group, and as a result, Y₃ has a moiety of an active methylene group or an active methine group. The electron-withdrawing group, which can provide such a moiety of an “active methylene group” or an “active methine group”, may be the same as above-mentioned electron-withdrawing group on the methine group of the “active methine group”.

When Y₃ is an organic group containing a carbon-carbon triple bond (for example a ethynyl group) having a substituent, preferred as the substituent is an alkyl group, a phenyl group, an alkoxycarbonyl group, a carbamoyl group, an electron-donating group, etc.

When Y₃ is an organic group containing an aromatic group, preferred as the aromatic group is an aryl group, particularly a phenyl group, having an electron-donating group as a substituent, and an indole ring group. The electron-donating group is preferably a hydroxy group, which may be protected by a silyl group; an alkoxy group; an amino group; an alkylamino group; an active methine group; a sulfoneamide group; or a mercapto group.

When Y₃ is an organic group containing a benzo-condensed, nonaromatic heterocyclic group, preferred as the benzo-condensed, nonaromatic heterocyclic group are groups having an aniline moiety, such as an indoline ring group, a 1,2,3,4-tetrahydroquinoline ring group, a 1,2,3,4-tetrahydroquinoxaline ring group and a 4-quinolone ring group.

The reactive group of Y₃ is more preferably an organic group containing a carbon-carbon double bond, an aromatic group, or a benzo-condensed, nonaromatic heterocyclic group. Furthermore preferred are an organic group containing a carbon-carbon double bond; a phenyl group having an electron-donating group as a substituent; an indole ring group; and a benzo-condensed, nonaromatic heterocyclic group having an aniline moiety. The carbon-carbon double bond more preferably has at least one electron-donating group as a substituent.

It is also preferred that the reactive group represented by Y₃ contains a moiety the same as the reducible group represented by RED₃ as a result of selecting the reactive group as above.

L₃ represents a linking group that connects RED₃ and Y₃, specifically a single bond, an alkylene group, an arylene group, a heterocyclic group, —O—, —S—, —NR_{N}—, —C(═O)—, —SO₂—, —SO—, —P(═O)—, or a combination thereof. R_{N} represents a hydrogen atom, an alkyl group, an aryl group or a heterocyclic group. The linking group represented by L₃ may have a substituent. The linking group represented by L₃ may bond to each of RED₃ and Y₃ at an optional position such that the linking group substitutes optional one hydrogen atom of each RED₃ and Y₃. Preferred examples of L₃ include a single bond; alkylene groups, particularly a methylene group, an ethylene group or a propylene group; arylene groups, particularly a phenylene group; a —C(═O)— group; a —O— group; a —NH— group; —N(alkyl)- groups; and divalent linking groups of combinations thereof.

When a cation radical (X⁺.) provided by oxidizing RED₃ or a radical (X.) provided by eliminating a proton therefrom reacts with the reactive group represented by Y₃ to form a bond, it is preferable that they form a 3 to 7-membered ring structure containing the linking group represented by L₃. Thus, the radical (X⁺. or X.) and the reactive group of Y are preferably connected though 3 to 7 atoms.

Next, the compound of Group 4 will be described below.

The compound of Group 4 has a reducible group-substituted ring structure. After the reducible group is one-electron-oxidized, the compound can release further one or more electrons with a ring structure cleavage reaction. The ring cleavage reaction proceeds as follows.

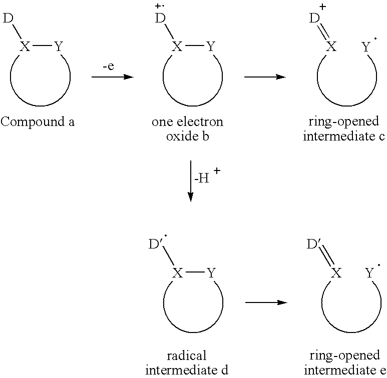

In the formula, compound a is the compound of Group 4. In compound a, D represents a reducible group, and X and Y each represent an atom forming a bond in the ring structure, which is cleaved after the one-electron oxidation. First, compound a is one-electron-oxidized to generate one-electron oxidation product b. Then, the X—Y bond is cleaved with conversion of the D-X single bond into a double bond, whereby ring-opened intermediate c is provided. Alternatively, there is a case where one-electron oxidation product b is converted into radical intermediate d with deprotonation, and ring-opened intermediate e is provided in the same manner. Subsequently, further one or more electrons are released form thus-provided ring-opened intermediate c or e.

The ring structure in the compound of Group 4 is a 3 to 7-membered, carbocyclic or heterocyclic, monocyclic or condensed, saturated or unsaturated, nonaromatic ring. The ring structure is preferably a saturated ring structure, more preferably 3- or 4-membered ring. Preferred examples of the ring structure include a cyclopropane ring, a cyclobutane ring, an oxirane ring, an oxetane ring, an aziridine ring, an azetidine ring, an episulphide ring and a thietane ring. More preferred are a cyclopropane ring, a cyclobutane ring, an oxirane ring, an oxetane ring and an azetidine ring, particularly preferred are a cyclopropane ring, a cyclobutane ring and an azetidine ring. The ring structure may have a substituent.

The compound of Group 4 is preferably represented by the following general formula (E) or (F).

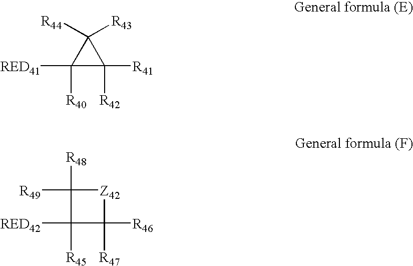

In general formulae (E) and (F), RED₄₁ and RED₄₂ are the same as RED₁₂ in general formula (B) with respect to the meanings and preferred embodiments, respectively. R₄₀ to R₄₄ and R₄₅ to R₄₉ each represent a hydrogen atom or a substituent. In general formula (F), Z₄₂ represents —CR₄₂₀R₄₂₁—, —NR₄₂₃—, or —O—. R₄₂₀ and R₄₂₁ each represent a hydrogen atom or a substituent, and R₄₂₃ represents a hydrogen atom, an alkyl group, an aryl group or a heterocyclic group.

In general formulae (E) and (F), each of R₄₀ and R₄₅ is preferably a hydrogen atom, an alkyl group or an aryl group, more preferably a hydrogen atom, an alkyl group or an aryl group. Each of R₄₁ to R₄₄ and R₄₆ to R₄₉ is preferably a hydrogen atom, an alkyl group, an alkenyl group, an aryl group, a heterocyclic group, an arylthio group, an alkylthio group, an acylamino group or a sulfoneamide group, more preferably a hydrogen atom, an alkyl group, an aryl group or a heterocyclic group,

It is preferred that at least one of R₄₁ to R₄₄ is a donor group, and it is also preferred that both of R₄₁ and R₄₂, or both of R₄₃ and R₄₄ are an electron-withdrawing group. It is more preferred that at least one of R₄₁ to R₄₄ is a donor group. It is furthermore preferred that at least one of R₄₁ to R₄₄ is a donor group and R₄₁ to R₄₄ other than the donor group are selected from a hydrogen atom and an alkyl group.

A donor group referred to here is an “electron-donating group” or an aryl group substituted with at least one “electron-donating group.” Preferable examples of donor groups include an alkylamino group, an arylamino group, a heterocyclicamino group, an electron-excessive aromatic heterocyclic group in a five-membered single ring or fused ring structure containing at least one nitrogen atom in a ring structure as part of the ring, a non-aromatic nitrogen containing hetrocyclic group having a nitrogen atom as a substitute and a phenyl group substituted with at least one electron-donating group. More preferable examples thereof include an alkylamino group, an aryamino group, an electron excessive aromatic heterocyclic group in a five-membered single ring or fused ring containing at least one nitrogen atom in a ring structure as a part (an indol ring, a pyrrole ring, a carbazole ring and the like), and a phenyl group substituted with an electron-donating group (a phenyl group substituted with three or more alkoxy groups, a phenyl group substituted with a hydroxy group, an alkylamino group, or an arylamino group and the like). Particularly preferable examples thereof include an aryamino group, an electron excessive aromatic heterocyclic group in a five-membered single ring or fused ring containing at least one nitrogen atom in a ring structure as a part (especially, a 3-indolyl group), and a phenyl group substituted with an electron-donating group (especially, a trialkoxyphenyl group and a phenyl group substituted with an alkylamino group or an arylamino group).

Z₄₂ is preferably —CR₄₂₀R₄₂₁— or —NR₄₂₃—, more preferably —NR₄₂₃—. Each of R₄₂₀ and R₄₂₁ is preferably a hydrogen atom, an alkyl group, an aryl group, a heterocyclic group, an acylamino group or a sulfoneamino group, more preferably a hydrogen atom, an alkyl group, an aryl group or a heterocyclic group. R₄₂₃ is preferably a hydrogen atom, an alkyl group, an aryl group or an aromatic heterocyclic group, more preferably a hydrogen atom, an alkyl group or an aryl group.

The substituent represented by each of R₄₀ to R₄₉, R₄₂₀, R₄₂₁ and R₄₂₃ preferably has 40 or less carbon atoms, more preferably has 30 or less carbon atoms, particularly preferably 15 or less carbon atoms. The substituents of R₄₀ to R₄₉, R₄₂₀, R₄₂₁ and R₄₂₃ may bond to each other or to the other portion such as RED₄₁, RED₄₂ and Z₄₂, to form a ring.

In the compounds of Groups 1 to 4 used in the invention, the adsorptive group to the silver halide is such a group that is directly adsorbed on the silver halide or promotes adsorption of the compound onto the silver halide. Specifically, the adsorptive group is a mercapto group or a salt thereof; a thione group (—C(═S)—); a heterocyclic group containing at least one atom selected from the group consisting of a nitrogen atom, a sulfur atom, a selenium atom and a tellurium atom; a sulfide group; a cationic group; or an ethynyl group. Incidentally, the adsorptive group in the compound of Group 2 is not a sulfide group.

The mercapto group or a salt thereof used as the adsorptive group may be a mercapto group or a salt thereof itself, and is more preferably a heterocyclic group, an aryl group or an alkyl group having a mercapto group or a salt thereof as a substituent. The heterocyclic group is a 5- to 7-membered, monocyclic or condensed, aromatic or nonaromatic, heterocyclic group. EXAMPLEs thereof include an imidazole ring group, a thiazole ring group, an oxazole ring group, a benzimidazole ring group, a benzthiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group, etc. The heterocyclic group may contain a quaternary nitrogen atom, and in this case, the mercapto group bonding to the heterocyclic group may be dissociated into a mesoion. Such heterocyclic group may be an imidazolium ring group, a pyrazolium ring group, a thiazolium ring group, a triazolium ring group, a tetrazolium ring group, a thiadiazolium ring group, a pyridinium ring group, a pyrimidinium ring group, a triazinium ring group, etc. Preferred among them is a triazolium ring group such as a 1,2,4-triazolium-3-thiolate ring group. Examples of the aryl group include a phenyl group and a naphthyl group. Examples of the alkyl group include straight, branched or cyclic alkyl groups having 1 to 30 carbon atoms. When the mercapto group forms a salt, a counter ion of the salt may be a cation of an alkaline metal, an alkaline earth metal, a heavy metal, etc. such as Li⁺, Na⁺, K⁺, Mg²⁺, Ag⁺ and Zn²⁺; an ammonium ion; a heterocyclic group containing a quaternary nitrogen atom; a phosphonium ion; etc.

Further, the mercapto group used as the adsorptive group may be tautomerized into a thione group. Specific examples of the thione group include a thioamide group (herein a —C(═S)—NH— group); and groups containing a structure of the thioamide group, such as linear or cyclic thioamide groups, a thiouredide group, a thiourethane group and a dithiocarbamic acid ester group. Examples of the cyclic thioamide group include a thiazolidine-2-thione group, an oxazolidine-2-thione group, a 2-thiohydantoin group, a rhodanine group, an isorhodanine group, a thiobarbituric acid group, a 2-thioxo-oxazolidine-4-one group, etc.

The thione group used as the adsorbent group, as well as the thione group derived from the mercapto group by tautomerization, may be a linear or cyclic, thioamide, thiouredide, thiourethane or dithiocarbamic acid ester group that cannot be tautomerized into the mercapto group or has no hydrogen atom at α-position of the thione group.

The heterocyclic group containing at least one atom selected from the group consisting of a nitrogen atom, a sulfur atom, a selenium atom and tellurium atom, which is used as the adsorbent group, is a nitrogen-containing heterocyclic group having a —NH— group that can form a silver imide (>NAg) as a moiety of the heterocycle; or a heterocyclic group having a —S— group, a —Se— group, a —Te— group or a ═N— group that can form a coordinate bond with a silver ion as a moiety of the heterocycle. Examples of the former include a benzotriazole group, a triazole group, an indazole group, a pyrazole group, a tetrazole group, a benzimidazole group, an imidazole group, a purine group, etc. Examples of the latter include a thiophene group, a thiazole group, an oxazole group, a benzothiazole group, a benzoxazole group, a thiadiazole group, an oxadiazole group, a triazine group, a selenazole group, a benzselenazole group, a tellurazole group, a benztellurazole group, etc. The former is preferable.

The sulfide group used as the adsorptive group may be any group with a —S— moiety, and preferably has a moiety of: alkyl or alkylene-5-alkyl or alkylene; aryl or arylene-S-alkyl or alkylene; or aryl or arylene-S-aryl or arylene. The sulfide group may form a ring structure, and may be a —S—S— group. Specific examples of the ring structure include groups with a thiolane ring, a 1,3-dithiolane ring, a 1,2-dithiolane ring, a thiane ring, a dithiane ring, a tetrahydro-1,4-thiazine ring (a thiomorpholine ring), etc. Particularly preferable as the sulfide groups are groups having a moiety of alkyl or alkylene-5-alkyl or alkylene.

The cationic group used as the adsorptive group is a quaternary nitrogen-containing group, specifically a group with an ammonio group or a quaternary nitrogen-containing heterocyclic group. Incidentally, there is no case where the cationic group partly composes an atomic group forming a dye structure, such as a cyanine chromophoric group. The ammonio group may be a trialkylammonio group, a dialkylarylammonio group, an alkyldiarylammonio group, etc., and examples thereof include a benzyldimethylammonio group, a trihexylammonio group, a phenyldiethylammonio group, etc. Examples of the quaternary nitrogen-containing heterocyclic group include a pyridinio group, a quinolinio group, an isoquinolinio group, an imidazolio group, etc. Preferred are a pyridinio group and an imidazolio group, and particularly preferred is a pyridinio group. The quaternary nitrogen-containing heterocyclic group may have an optional substituent. Preferred as the substituent in the case of the pyridinio group and the imidazolio group are alkyl groups, aryl groups, acylamino groups, a chlorine atom, alkoxycarbonyl groups and carbamoyl groups. Particularly preferred as the substituent in the case of the pyridinio group is a phenyl group.

The ethynyl group used as the adsorptive group means a —C≡CH group, in which the hydrogen atom may be substituted.

The adsorptive group may have an optional substituent.

Specific examples of the adsorptive group further include groups described in pages 4 to 7 of a specification of JP-A No. 11-95355.

Preferred as the adsorptive group used in the invention are mercapto-substituted, nitrogen-containing, heterocyclic groups such as a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzthiazole group and a 1,5-dimethyl-1,2,4-triazolium-3-thiolate group; and nitrogen-containing heterocyclic groups having a —NH— group that can form a silver imide (>NAg) as a moiety of the heterocycle, such as a benzotriazole group, a benzimidazole group and an indazole group. Particularly preferred are a 5-mercaptotetrazole group, a 3-mercapto-1,2,4-triazole group and a benzotriazole group, and the most preferred are a 3-mercapto-1,2,4-triazole group and a 5-mercaptotetrazole group.

Among these compounds, it is particularly preferred that the compound has two or more mercapto groups as a moiety. The mercapto group (—SH) may be converted into a thione group in the case where it can be tautomerized. The compound may have two or more adsorbent groups containing above-mentioned mercapto or thione group as a moiety, such as a cyclic thioamide group, an alkylmercapto group, an arylmercapto group and a heterocyclic mercapto group. Further, the compound may have one or more adsorptive group containing two or more mercapto or thione groups as a moiety, such as a dimercapto-substituted, nitrogen-containing, heterocyclic group.

Examples of the adsorptive group containing two or more mercapto group, such as a dimercapto-substituted, nitrogen-containing, heterocyclic group, include a 2,4-dimercaptopyrimidine group, a 2,4-dimercaptotriazine group, a 3,5-dimercapto-1,2,4-triazole group, a 2,5-dimercapto-1,3-thiazole group, a 2,5-dimercapto-1,3-oxazole group, a 2,7-dimercapto-5-methyl-s-triazolo(1,5-A)-pyrimidine group, a 2,6,8-trimercaptopurine group, a 6,8-dimercaptopurine group, a 3,5,7-trimercapto-s-triazolotriazine group, a 4,6-dimercaptopyrazolo pyrimidine group, a 2,5-dimercapto-imidazole group, etc. Particularly preferred are a 2,4-dimercaptopyrimidine group, a 2,4-dimercaptotriazine group, and a 3,5-dimercapto-1,2,4-triazole group.

The adsorptive group may be connected to any position of the compound represented by each of general formulae (A) to (F) and (1) to (3) Preferred portions, which the adsorptive group bonds to, are RED₁₁, RED₁₂, RED₂ and RED₃ in general formulae (A) to (D), RED₄₁, R₄₁, RED₄₂, and R₄₆ to R₄₈ in general formulae (E) and (F), and optional portions other than R₁, R₂, R₁₁, R₁₂, R₃₁, L₁, L₂₁ and L₃₁ in general formulae (1) to (3). Further, more preferred portions are RED₁₁ to RED₄₂ in general formulae (A) to (F).

The spectral sensitizer moiety is a group containing a spectral sensitizer chromophore, a residual group provided by removing an optional hydrogen atom or substituent from a spectral sensitizer compound. The spectral sensitizer moiety may be connected to any position of the compound represented by each of general formulae (A) to (F) and (1) to (3). Preferred portion, which the spectral sensitizer moiety bonds to, are RED₁₁, RED₁₂, RED₂ and RED₃ in general formulae (A) to (D), RED₄₁, R₄₁, RED₄₂, and R₄₆ to R₄₈ in general formulae (E) and (F), and optional portions other than R₁, R₂, R₁₁, R₁₂, R₃₁, L₁, L₂₁ and L₃₁ in general formulae (1) to (3). Further, more preferred portions are RED₁₁ to RED₄₂ in general formulae (A) to (F). The spectral sensitizer is preferably such that typically used in color sensitizing techniques. Examples thereof include cyanine dyes, composite cyanine dyes, merocyanine dyes, composite merocyanine dyes, homopolar cyanine dyes, styryl dyes, and hemicyanine dyes. Typical spectral sensitizers are disclosed in Research Disclosure, Item 36544, September 1994. The dyes can be synthesized by one skilled in the art according to procedures described in the above Research Disclosure and F. M. Hamer, The Cyanine dyes and Related Compounds, Interscience Publishers, New York, 1964. Further, dyes described in pages 4 to 7 of a specification of JP-A No. 11-95355 (U.S. Pat. No. 6,054,260) may be used in the invention.

The compounds of Groups 1 to 4 used in the invention has preferably 10 to 60 carbon atoms in total, more preferably 15 to 50 carbon atoms, furthermore preferably 18 to 40 carbon atoms, particularly preferably 18 to 30 carbon atoms.

When a silver halide photosensitive material using the compounds of Groups 1 to 4 is exposed, the compound is one-electron-oxidized. After the subsequent reaction, the compound is further oxidized while releasing one electron, or two or more electrons depending on Group. An oxidation potential in the first one-electron oxidation is preferably 1.4 V or less, more preferably 1.0 V or less. This oxidation potential is preferably 0 V or more, more preferably 0.3 V or more. Thus, the oxidation potential is preferably approximately 0 V to 1.4 V, more preferably approximately 0.3 V to 1.0 V.

The oxidation potential may be measured by a cyclic voltammetry technique. Specifically, a sample is dissolved in a solution of acetonitrile/water containing 0.1 M lithium perchlorate=80/20 (volume %), nitrogen gas is passed through the resultant solution for 10 minutes, and then the oxidation potential is measured at 25° C. at a potential scanning rate of 0.1 V/second by using a glassy carbon disk as a working electrode, using a platinum wire as a counter electrode, and using a calomel electrode (SCE) as a reference electrode. The oxidation potential per SCE is obtained at peak potential of cyclic voltammetric curve.

In the case where the compound of Groups 1 to 4 is one-electron-oxidized and release further one electron after the subsequent reaction, an oxidation potential in the subsequent oxidation is preferably −0.5 V to −2 V, more preferably −0.7 V to −2 V, furthermore preferably −0.9 V to −1.6 V.

In the case where the compound of Groups 1 to 4 is one-electron-oxidized and release further two or more electrons after the subsequent reaction, oxidation potentials in the subsequent oxidation are not particularly limited. The oxidation potentials in the subsequent oxidation often cannot be measured precisely, because an oxidation potential in releasing the second electron cannot be clearly differentiated from an oxidation potential in releasing the third electron.

Next, the compound of Group 5 will be described.

The compound of Group 5 is represented by X—Y, in which X represents a reducible group and Y represents a leaving group. The reducible group represented by X can be one-electron-oxidized to provide a one-electron oxidation product, which can be converted into an X radical by eliminating the leaving group of Y with a subsequent X—Y bond cleavage reaction. The X radical can release further one electron. The oxidation reaction of the compound of Group T5 may be represented by the following formula.

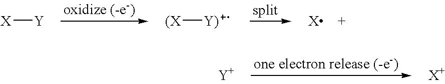

The compound of Group 5 exhibits an oxidation potential of preferably 0 V to 1.4 V, more preferably 0.3 V to 1.0 V. The radical X generated in the formula exhibits an oxidation potential of preferably −0.7 V to −2.0 V, more preferably −0.9 V to −1.6 V.

The compound of Group 5 is preferably represented by the following general formula (G).

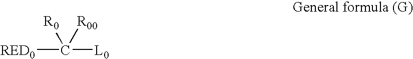

In general formula (G), RED₀ represents a reducible group, L₀ represents a leaving group, and R₀ and R₀₀ each represent a hydrogen atom or a substituent. RED₀ and R₀, and R₀ and R₀₀ may be bond together to form a ring structure, respectively. RED₀ is the same as RED₂ in general formula (C) with respect to the meanings and preferred embodiments. R₀ and R₀₀ are the same as R₂₁ and R₂₂ in general formula (C) with respect to the meanings and preferred embodiments, respectively. Incidentally, R₀ and R₀₀ are not the same as the leaving group of L₀ respectively, except for a hydrogen atom. RED₀ and R₀ may bond together to form a ring structure with examples and preferred embodiments the same as those of the ring structure formed by bonding RED₂ and R₂₁ in general formula (C). Examples of the ring structure formed by bonding R₀ and R₀₀ each other include a cyclopentane ring, a tetrahydrofuran ring, etc. In general formula (G), L₀ is the same as L₂ in general formula (C) with respect to the meanings and preferred embodiments.

The compound represented by general formula (G) preferably has an adsorptive group to the silver halide or a spectrally sensitizing dye moiety. However, the compound does not have two or more adsorptive groups when L₀ is a group other than a silyl group. Incidentally, the compound may have two or more sulfide groups as the adsorbent groups, not depending on L₀.

The adsorptive group to the silver halide in the compound represented by general formula (G) may be the same as those in the compounds of Groups 1 to 4, and further may be the same as all of the compounds and preferred embodiments described as “an adsorptive group to the silver halide” in pages 4 to 7 of a specification of JP-A No. 11-95355.

The spectral sensitizer moiety in the compound represented by general formula (G) is the same as in the compounds of Groups 1 to 4, and may be the same as all of the compounds and preferred embodiments described as “photoabsorptive group” in pages 7 to 14 of a specification of JP-A No. 11-95355.

Specific examples of the compounds of Groups 1 to 5 used in the invention are illustrated below without intention of restricting the scope of the invention.

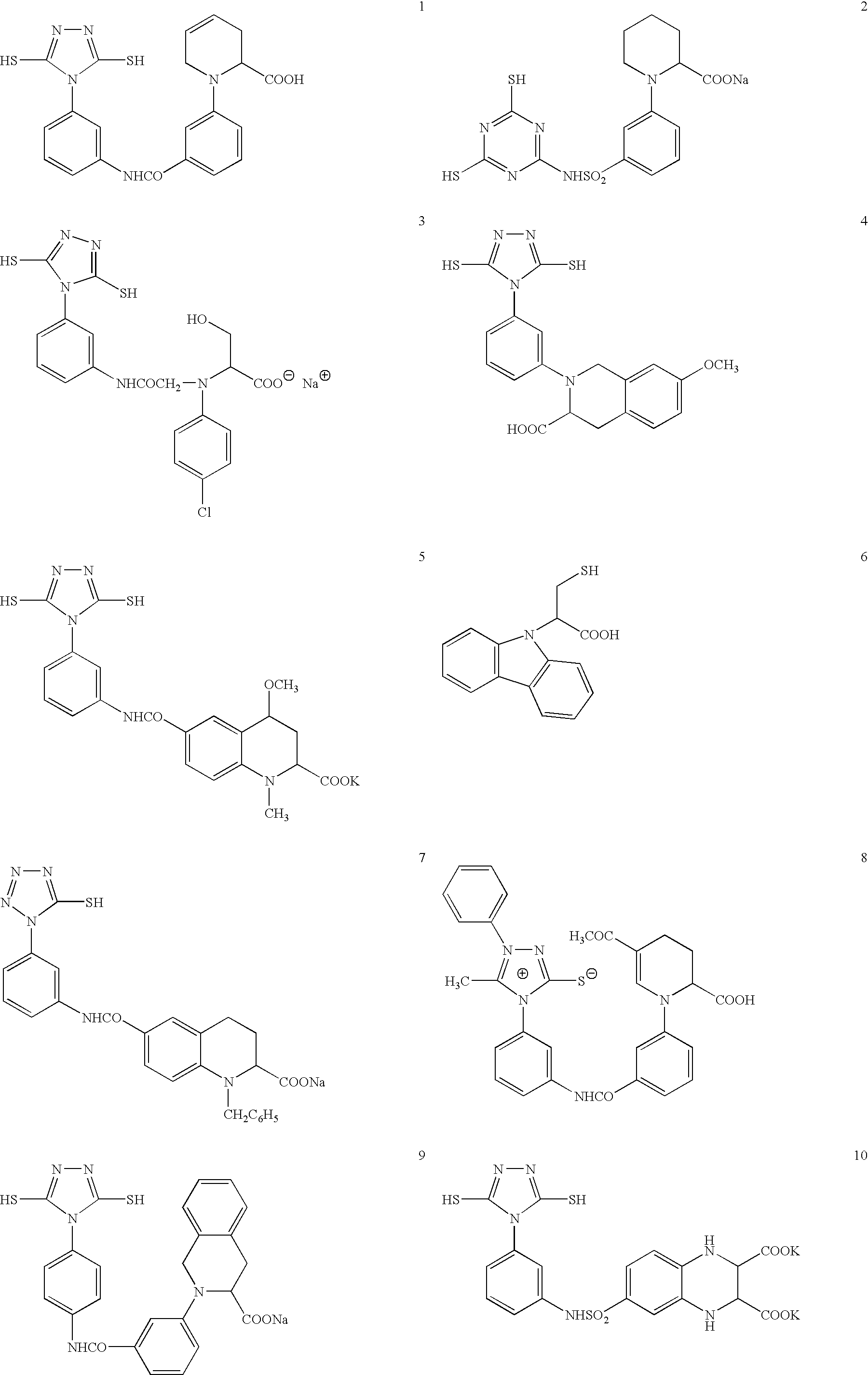

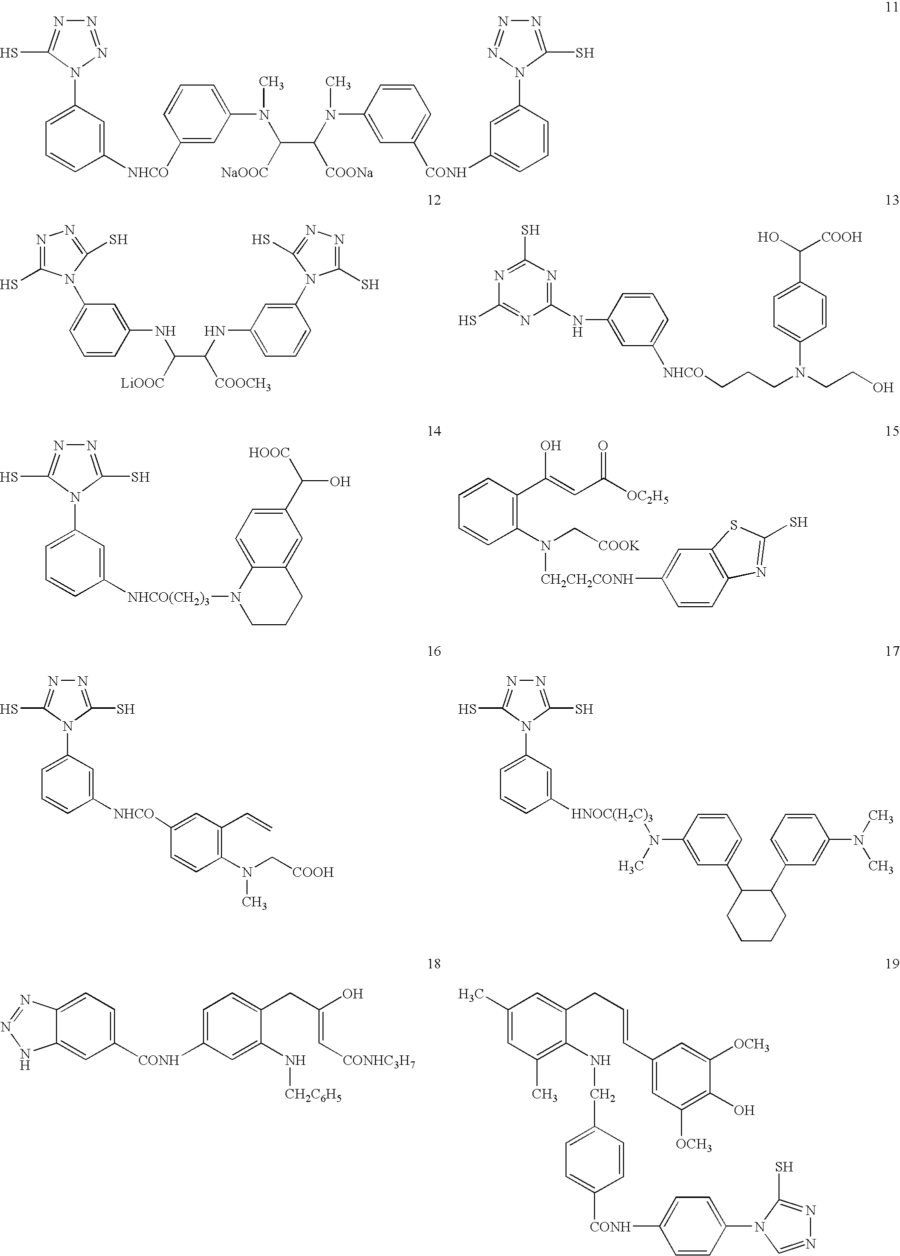

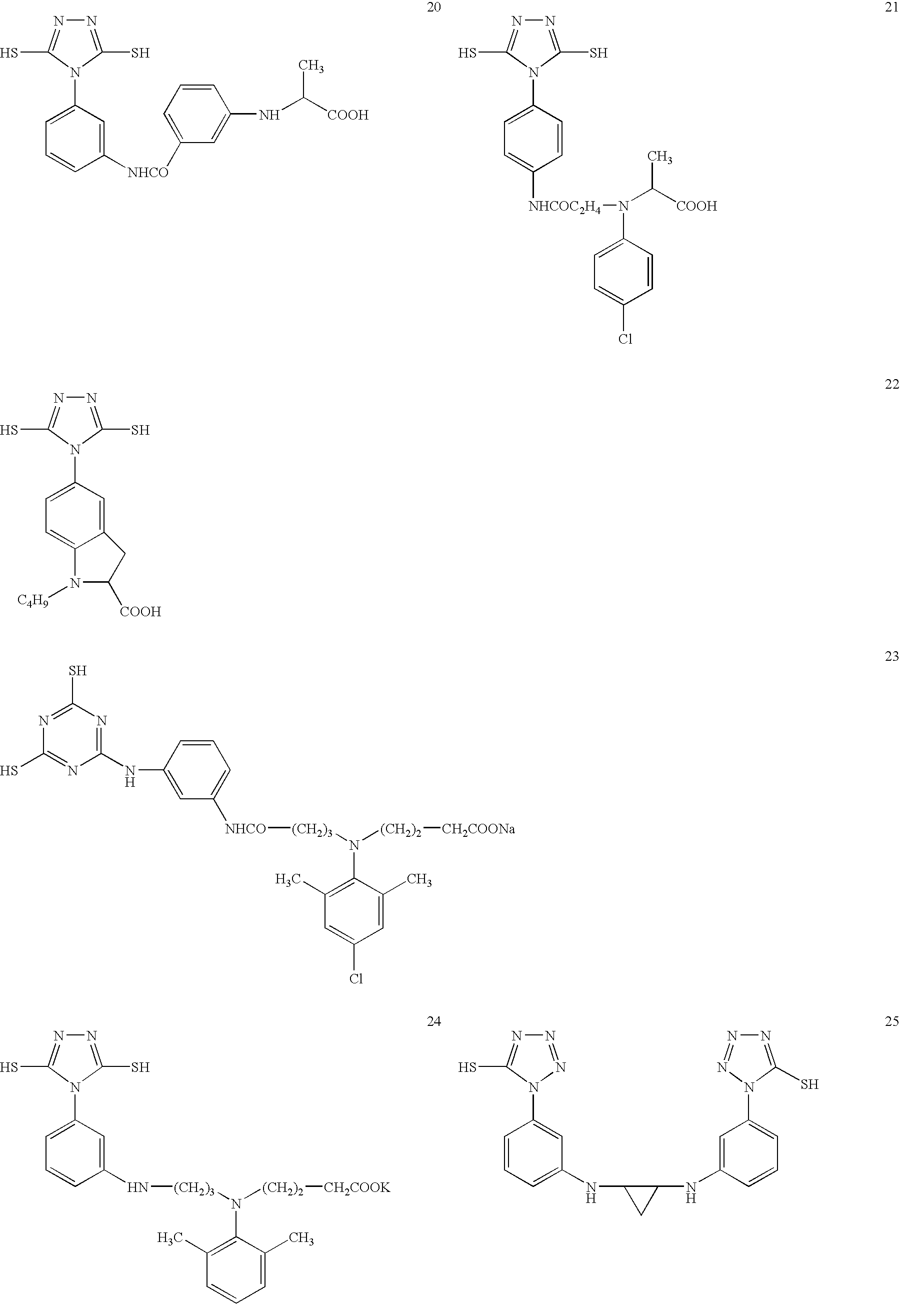

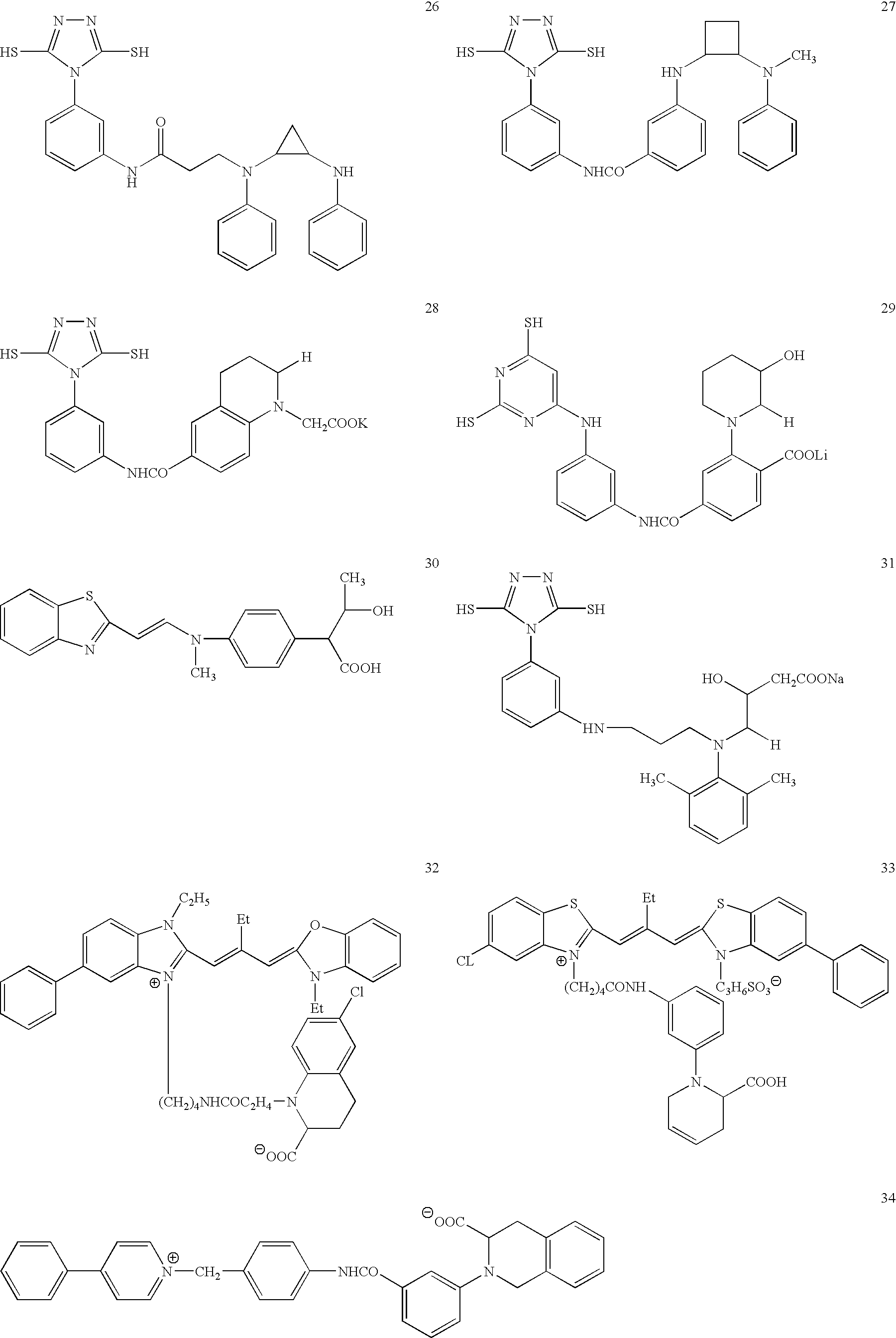

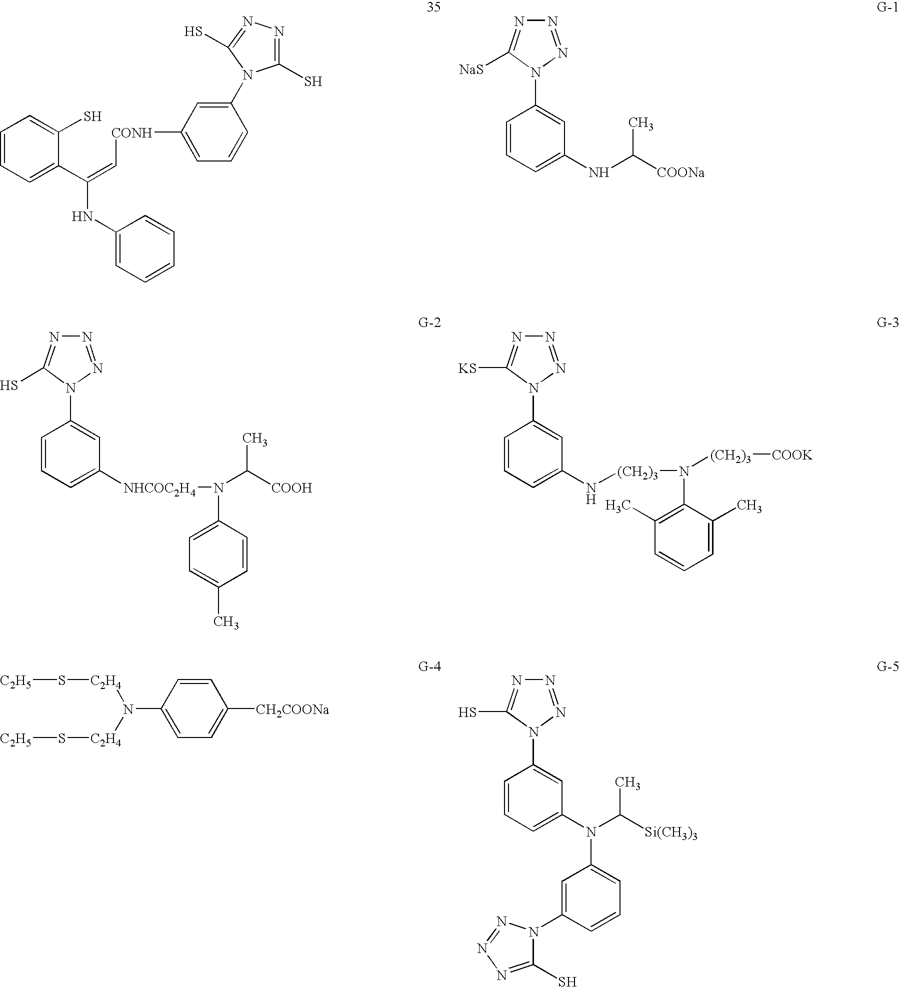

The compounds of Groups 1 to 4 used in the invention are the same as compounds described in detail in Japanese Patent Application Nos. 2002-192373, 2002-188537, 2002-188536, 2001-272137 and 2002-192374, respectively. The specific examples of the compounds of Groups 1 to 4 used in the invention further include compound examples disclosed in the specifications. Synthesis examples of the compounds of Groups 1 to 4 used in the invention may be the same as described in the specifications.

Specific examples of the compound represented by general formula (G) further include examples of compound referred to as “one photon two electrons sensitizer” or “deprotonating electron-donating sensitizer” described in JP-A No. 9-211769 (Compound PMT-1 to S-37 in Tables E and F, pages 28 to 32); JP-A No. 9-211774; JP-A No. 11-95355 (Compound INV 1 to 36); JP-W No. 2001-500996 (Compound 1 to 74, 80 to 87, and 92 to 122); U.S. Pat. Nos. 5,747,235 and 5,747,236; EP No. 786692 A1 (Compound INV 1 to 35); EP No. 893732 A1; U.S. Pat. Nos. 6,054,260 and 5,994,051; etc.

The compounds of Groups 1 to 5 may be used at any time during preparation of the photosensitive silver halide emulsion and production of the photothermographic material. For example, the compound may be used, in a photosensitive silver halide grain formation step, in a desalting step, in a chemical sensitization step, before application, etc. The compound may be added in several times, during these steps. The compound is preferably added, after the photosensitive silver halide grain formation step and before the desalting step; in the chemical sensitization step (just before the chemical sensitization to immediately after the chemical sensitization); or before the application. The compound is more preferably added, just before the chemical sensitization step to before mixing with the non-photosensitive organic silver salt.

It is preferred that the compound of Groups 1 to 5 used in the invention is dissolved in water, a water-soluble solvent such as methanol and ethanol, or a mixed solvent thereof, to be added. In the case where the compound is dissolved in water and solubility of the compound is increased by increasing or decreasing a pH value of the solvent, the pH value may be increased or decreased to dissolve and add the compound.

The compound of Groups 1 to 5 used in the invention is preferably added to the image forming layer comprising the photosensitive silver halide and the non-photosensitive organic silver salt. The compound may be added to a surface protective layer, an intermediate layer, as well as the image forming layer comprising the photosensitive silver halide and the non-photosensitive organic silver salt, to be diffused to the image forming layer in the application step. The compound may be added before or after addition of a sensitizing dye. A mol value of the compound per one mol of the silver halide is preferably 1×10⁻⁹ mol to 5×10⁻¹ mol, more preferably 1×10⁻⁸ mol to 5×10⁻² mol, in a layer comprising the photosensitive silver halide emulsion.

13) Combined Use of a Plurality of Silver Halides

The photosensitive silver halide emulsion in the photosensitive material used in the invention may be used alone, or two or more kinds of them (for example, those of different average particle sizes, different halogen compositions, different crystal habits and of different conditions for chemical sensitization) may be used together. Gradation can be controlled by using plural kinds of photosensitive silver halides of different sensitivity. The relevant techniques can include those described, for example, in JP-A Nos. 57-119341, 53-106125, 47-3929, 48-55730, 46-5187, 50-73627, and 57-150841. It is preferred to provide a sensitivity difference of 0.2 or more in terms of log E between each of the emulsions.

14) Mixing Silver Halide and Organic Silver Salt

Organic silver salts are prepared by adding alkali metal salts (e.g., sodium hydroxide, potassium hydroxide) to organic acids to convert at least a part of the organic acids into alkali metal soap of the organic acids, and then by adding thereto a water-soluble silver salt (e.g., silver nitrate). Photosensitive silver halides may be added at any stage in the process of preparing the organic silver salts. As main mixing processes, there are (A) a process in which silver halides are added to organic acids in advance, admixed with alkali metal salts, and then admixed with a water-soluble silver salt; (B) a process in which alkali metal soap prepared from organic acids is mixed with silver halides, and thereto a water-soluble silver salt is added; (C) a process in which alkali metal soap is prepared from organic acids, a part thereof is converted into the silver salt, and then silver halides are added thereto, and further the remaining part is converted into the silver salt; and (D) a process in which organic silver salts are formed, and then mixed with silver halides. Of these processes, (B) and (C) are preferred over the others.

As for (B) and (C), the photosensitive silver halide is formed under the absence of the non-photosensitive organic silver salt and then mixed in the process for preparing the organic silver salt. This is because a sufficient sensitivity can not sometimes be attained by the method of forming the silver halide by adding a halogenating agent to the organic silver salt.

As for (D), the method of mixing the silver halide and the organic silver salt can include a method of mixing a separately prepared photosensitive silver halide and an organic silver salt by a high speed stirrer, ball mill, sand mill, colloid mill, vibration mill, or homogenizer, or a method of mixing a photosensitive silver halide completed for preparation at any timing in the preparation of an organic silver salt and preparing the organic silver salt. The effect of the invention can be obtained preferably by any of the methods described above.

The organic silver salt including the silver halide is preferably in the form of fine particle dispersion. For the method to disperse in fine particle, a high speed stirrer, ball mill, sand mill, colloid mill, vibration mill, or a high pressure homogenizer can be used.

15) Mixing Silver Halide into Coating Solution

In the invention, the time of adding silver halide to the coating solution for the image forming layer is preferably in the range from 180 minutes before to just prior to the coating, more preferably, 60 minutes before to 10 seconds before coating. But there is no restriction for mixing method and mixing condition as far as the effect of the invention appears sufficient. As an embodiment of a mixing method, there is a method of mixing in the tank controlling the average residence time to be desired. The average residence time herein is calculated from addition flux and the amount of solution transferred to the coater. And another embodiment of mixing method is a method using a static mixer, which is described in 8th edition of “Ekitai kongou gijutu” by N. Harnby and M. F. Edwards, translated by Kouji Takahashi (Nikkankougyou shinbunsya, 1989).

3. Reducing Agent

The reducing agent used in the invention is the compound that is capable of reducing a silver ion to form a developed silver at a thermal developing process.

As a reducing agent used in the invention, the compound represented by the following formula (R) is preferred. These compounds are illustrated below in detail.

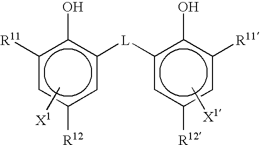

In formula (R), R¹¹ and R^{11′} each independently represent an alkyl group having 1 to 20 carbon atoms. R¹² and R^{12′} each independently represent a hydrogen atom or a group capable of substituting for a hydrogen atom on a benzene ring. L represents a —S— group or a —CHR¹³— group. R¹³ represents a hydrogen atom or an alkyl group having 1 to 20 carbon atoms. X and X¹ each independently represent a hydrogen atom or a group capable of substituting for a hydrogen atom on a benzene ring.

Each of the substituents is to be described specifically.

1) R¹¹ and R^{11′}

R¹¹ and R^{11′} each independently represent a substituted or unsubstituted alkyl group having 1 to 20 carbon atoms. The substituent for the alkyl group has no particular restriction and can include, preferably, aryl group, hydroxy group, alkoxy group, aryloxy group, alkylthio group, arylthio group, acylamino group, sulfoneamide group, sulfonyl group, phosphoryl group, acyl group, carbamoyl group, ester group, and halogen atom.

2) R¹² and R^{12′} X and X¹

R¹² and R^{12′} each independently represent a hydrogen atom or a group capable of substituting for a hydorgen atom on a benzene ring.

X and X¹ each independently represent a hydrogen atom or a group capable of substituting for a hydorgen atom on a benzene ring. Each of the groups capable of substituting for a hydrogen atom on the benzene ring can include, preferably, alkyl group, aryl group, halogen atom, alkoxy group, and acylamino group.

3) L

L represents a —S— group or a —CHR¹³— group. R¹³ represents a hydrogen atom or an alkyl group having 1 to 20 carbon atoms in which the alkyl group may have a substituent.

Specific examples of the non-substituted alkyl group for R¹³ can include, for example, methyl group, ethyl group, propyl group, butyl group, heptyl group, undecyl group, isopropyl group, 1-ethylpentyl group, and 2,4,4-trimethylpentyl group.

Examples of the substituent for the alkyl group can include, like substituent R¹¹, a halogen atom, an alkoxy group, alkylthio group, aryloxy group, arylthio group, acylamino group, sulfoneamide group, sulfonyl group, phosphoryl group, oxycarbonyl group, carbamoyl group, and sulfamoyl group.

4) Preferred Substituents

R¹¹ and R^{11′} are, preferably, a secondary or tertiary alkyl group having 3 to 15 carbon atoms and can include, specifically, isopropyl group, isobutyl group, t-butyl group, t-amyl group, t-octyl group, cyclohexyl group, cyclopentyl group, 1-methylcyclohexyl group, and 1-methylcyclopropyl group. R¹¹ and R^{11′} each represents, more preferably, tertiary alkyl group having 4 to 12 carbon atoms and, among them, t-butyl group, t-amyl group, 1-methylcyclohexyl group are further preferred, t-butyl group being most preferred.

R¹² and R^{12′} are, preferably, alkyl groups having 1 to 20 carbon atoms and can include, specifically, methyl group, ethyl group, propyl group, butyl group, isopropyl group, t-butyl group, t-amyl group, cyclohexyl group, 1-methylcyclohexyl group, benzyl group, methoxymethyl group and methoxyethyl group. More preferred are methyl group, ethyl group, propyl group, isopropyl group, and t-butyl group.

X and X¹ are, preferably, a hydrogen atom, halogen atom, or alkyl group, and more preferably, hydrogen atom.

L is preferably a group —CHR¹³—.

R¹³ is, preferably, a hydrogen atom or an alkyl group having 1 to 15 carbon atoms. The alkyl group is preferably methyl group, ethyl group, propyl group, isopropyl group and 2,4,4-trimethylpentyl group. Particularly preferred R¹³ is a hydrogen atom, methyl group, propyl group or isopropyl group.

In a case where R¹³ is a hydrogen atom, R¹² and R^{12′} each represent, preferably, an alkyl group having 2 to 5 carbon atoms, ethyl group and propyl group being more preferred and ethyl group being most preferred.

In a case where R¹³ is a primary or secondary alkyl group having 1 to 8 carbon atoms, R¹² and R^{12′} each represent preferably methyl group. As the primary or secondary alkyl group of 1 to 8 carbon atoms for R¹³, methyl group, ethyl group, propyl group and isopropyl group are more preferred, and methyl group, ethyl group, and propyl group are further preferred.

In a case where each of R¹, R^{11′} and R¹², R^{12′} is methyl group, R¹³ is preferably a secondary alkyl group. In this case, the secondary alkyl group for R¹³ is preferably isopropyl group, isobutyl group and 1-ethylpentyl group, with isopropyl group being more preferred.

The reducing agent described above show various different thermal developing performances depending on the combination of R¹¹, R^{11′} and R¹², R^{12′}, as well as R¹³. Since the thermal developing performances can be controlled by using two or more kinds of reducing agents at various mixing ratios, it is preferred to use two or more kinds of reducing agents in combination depending on the purpose.

Specific examples of the compounds represented by formula (R) according to the invention are shown below but the invention is not restricted to them.

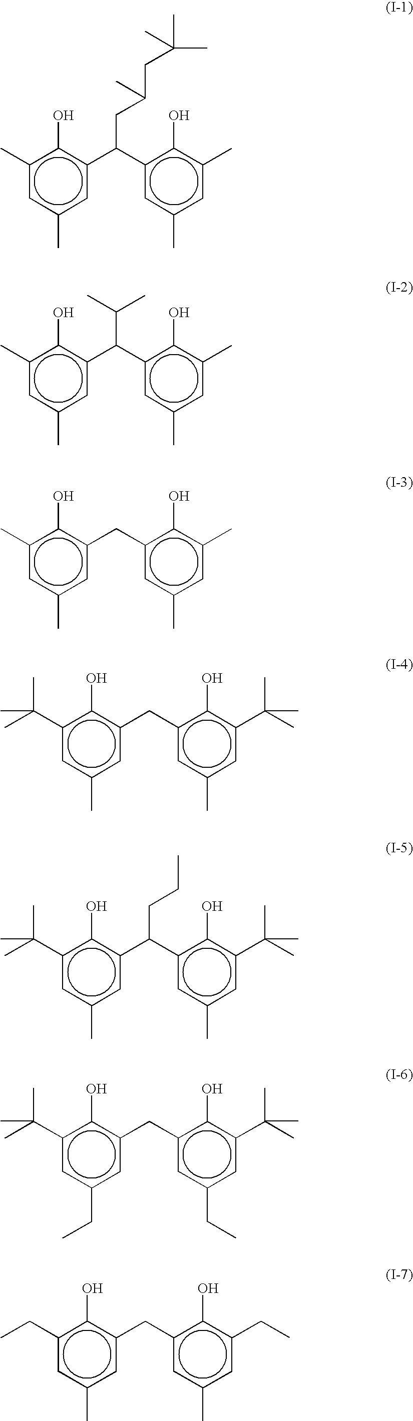

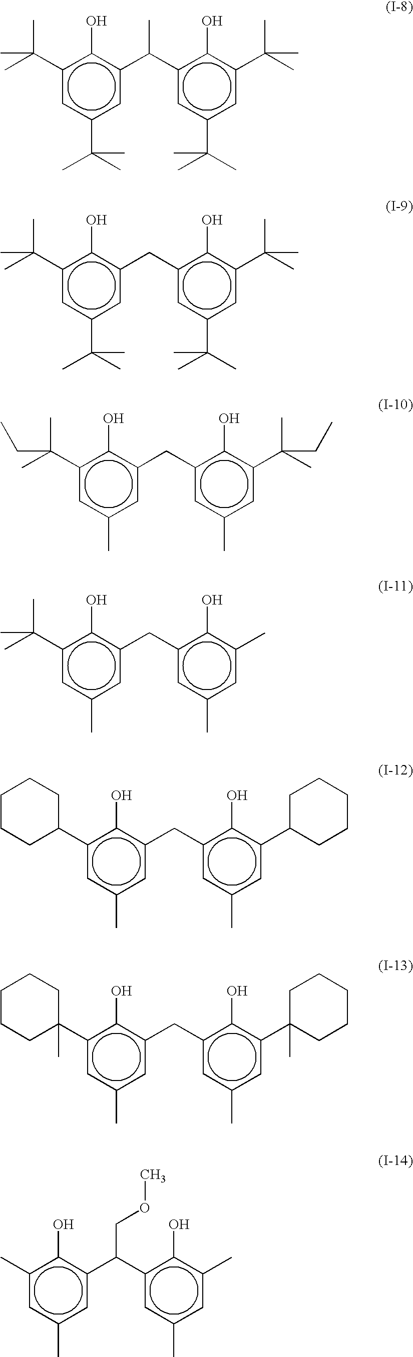

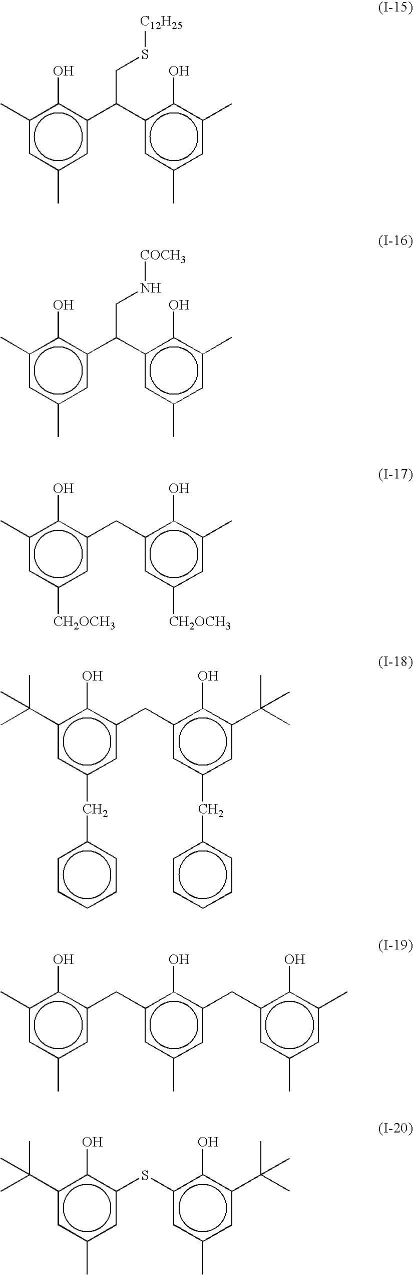

In the invention, the addition amount of the reducing agent is, preferably, from 0.01 g/m² to 5.0 g/m² and more preferably, 0.1 g/m² to 3.0 g/m². It is, preferably, contained by 5 mol % to 50 mol %, and more preferably, 10 mol % to 40 mol % per one mole of silver in the image forming layer.

The reducing agent of the invention is preferably contained in the image forming layer containing an organic silver salt and a photosensitive silver halide and the layer adjacent to the image forming layer, however it is more preferably contained in the image forming layer.

In the invention, the reducing agent may be incorporated into photosensitive material by being added into the coating solution, such as in the form of a solution, an emulsion dispersion, a solid particle dispersion, and the like. It is particularly preferable to add the reducing agent in the form of a solution, where the reducing agent is solved in the coating solution or in the organic solvent which is miscible with the coating solution.

4. Organic Silver Salt

The non-photosensitive organic silver salt particle according to the invention is relatively stable to light but serves as to supply silver ions and forms silver images when heated to 80° C. or higher under the presence of an exposed photosensitive silver halide and a reducing agent. The organic silver salt may be any organic material containing a source capable of reducing silver ions. Such non-photosensitive organic silver salt is disclosed, for example, in JP-A No. 10-62899 (paragraph Nos. 0048 to 0049), EP-A No. 0803764 A1 (page 18, line 24 to page 19, line 37), EP-A No. 0962812 A1, JP-A Nos. 11-349591, 2000-7683, and 2000-72711, and the like. A silver salt of organic acid, particularly, a silver salt of long chained fatty acid carboxylic acid (number of carbon atoms having 10 to 30, preferably, 15 to 28) is preferable. Preferred examples of the silver salt of the organic acid can include, for example, silver behenate, silver arachidinic acid, silver stearate, silver oleate, silver laurate, silver capronate, silver myristate, silver palmitate and mixtures thereof. In the present invention, among the organic silver salts, an organic silver salt with the silver behenate content of 30 mol % to 80 mol % is used. Particularly, it is preferred that the silver behenate content is 40 mol % to 70 mol %. For the remaining organic silver salt, a silver salt of a long chained fatty carboxylic acid is preferred, more preferably, a silver salt of long chained fatty carboxylic acid having 10 to 30 carbon atoms, and particularly preferably, a silver salt of long chained fatty carboxylic acid having 15 to 28 carbon atoms.

There is no particular restriction on the shape of the organic silver salt usable in the invention and it may cubic, cuboid, bar-like, needle-like, plate-like or flaky shape. Among them, a cubic, cuboid, bar-like, needle-like shaped organic silver salt is relatively preferred. A cubic, cuboid, bar-like, needle-like shaped organic silver salt is defined as shown below. An organic acid silver salt is observed under an electron microscope, calculation is made while approximating the shape of an organic acid silver salt particle to a rectangular body and assuming each side of the rectangular body as a, b, c from the shorter side (a≦b≦c). The particle which satisfies the relation: 0.9≦a/c≦1.0 is defined as a cubic shape. The particle which satisfies the relation: 0.2≦a/c<0.9 and 0.2≦b/c≦1.0 is defined as a cuboid shape. The particle which satisfies the relation: 0.1≦a/c<0.2 and 0.1≦b/c<0.3 is defined as a bar-like shape. The particle which satisfies the relation: a/c<0.1 and b/c<0.1 is defined as a needle-like shape. In the invention, more preferable shape of the organic silver salt is a bar-like shape or a needle-like shape, amd most preferred is a needle-like shape.

It is preferable to decrease the size of organic silver. In the filed of a silver halide photosensitive material, the inverse proportion between the size and covering power of a silver salt particle is well known. This relation is observed also in the photothermographic material of the invention, and it means that when the size of an organic silver particle in the image forming layer is large, the covering power decreases and image density becomes low. In the present invention, it is preferable that the short axis is 0.01 μm to 0.20 μm, the long axis is 0.10 μm to 5.0 μm, and it is more preferable that the short axis is 0.01 μm to 0.15 μm, the long axis is 0.10 μm to 4.0 μm. As the particle size distribution of the organic silver salt, mono-dispersion is preferred. In the mono-dispersion, the percentage for the value obtained by dividing the standard deviation for the length of minor axis and major axis by the minor axis and the major axis respectively is, preferably, 100% or less, more preferably, 80% or less and, further preferably, 50% or less.

The shape of the organic silver salt can be measured by determining dispersion of an organic silver salt as transmission type electron microscopic images. Another method of measuring the mono-dispersion is a method of determining of the standard deviation of the volume weighted mean diameter of the organic silver salt in which the percentage for the value defined by the volume weight mean diameter (variation coefficient), is preferably, 100% or less, more preferably, 80% or less and, further preferably, 50% or less. For determination of such a value, a commercially available laser-beam scattering grain size analyzer can be used.

The organic silver salt is prepared as shown below. The salt forming are carried out in an aqueous solvent and then the salt is dewatered, dried and then re-dispersed into a solvent such as MEK. Drying is preferably conducted in a airflow-type flash jet drier at a partial oxygen pressure of 15% by volume or less, more preferably, at 0.01% by volume to 15% by volume and, more preferably, at 0.01% by volume to 10% by volume.

While an organic silver salt in the invention can be used in a desired amount, an amount of an organic silver salt is preferably in the range of from 0.1 g/m² to 5 g/m² in terms of coating amount of Ag and more preferably in the range of from 1 g/m² to 3 g/m² in terms of coating amount of Ag.

5. Binder

As one embodiment of the photothermographic material of the invention, it is characterized that the binder has a glass transition temperature (Tg) of 45° C. or higher. It is preferable that the Tg of a binder of the invention is in the range of from 50° C. to 90° C., and further preferably from 50° C. to 80° C.

The binder used in the invention can be selected from natural resin or synthetic resin; for example, included are gelatin, polyvinyl butyral, polyvinyl acetal, polyvinyl chloride, polyvinyl acetate, cellulose acetate, polyolefin, polyester, polystyrene, polyacrylonitrile, polycarbonate, butylethyl cellulose, methacrylate copolymer, maleic anhydride ester copolymers, polystyrene, and styrene-butadiene copolymers, and the like. In the image forming layer, in particularly, polyvinyl butyral is preferably incorporated as the binder. More specifically, polyvinyl butyral is added as a binder to account for 50% by weight or more with respect to the total composition of the binder for the image forming layer.

As a matter of fact, copolymers and terpolymers are also included. The preferable total amount of polyvinyl butyral is in a range of 50% by weight or more, more preferably, is in a range of 70% by weight or more with respect to total composition for the binder incorporated in the image forming layer.

The total amount of the binders is such that, for instance, the component of the image forming layer can be sufficiently maintained within the layer. That is, the binders are used in an amount effective to function as binder. The effective range can be properly determined by those skilled in the art. In the case of holding at least an organic silver salt, the suitable ratio of binders to an orgagnic silver salts is from 15:1 to 1:3, particularly preferably, from 8:1 to 1:2 by weight.

6. Development Accelerator

In the photothermographic material of the invention a development accelerator can be added. Sulfoneamide phenolic compounds represented by the general formula (A) described in the specification of JP-A No. 2000-267222, and specification of JP-A No. 2000-330234, hindered phenolic compound represented by the general formula (II) described in JP-A No. 2001-92075, hydrazine series compounds represented by general formula (I) described in the specification of JP-A No. 10-62895 and the specification of JP-A No. 11-15116, represented by general formula (D) of JP-A No. 2002-156727 and represented by general formula (1) described in the specification of Japanese Patent Application No. 2001-074278, and phenolic or naphthalic compounds represented by general formula (2) described in the specification of JP-A No. 2001-264929 are used preferably as the development accelerator and they are added preferably. The development accelerator described above is used within a range from 0.1 mol % to 20 mol %, preferably, within a range from 0.5 mol % to 10 mol % and, more preferably, within a range from 1 mol % to 5 mol % to the reducing agent. The introduction method to the photothermographic material can include, the same method as those for the reducing agent and, it is particularly preferred to add as a solution solved in an organic solvent.

In the present invention, it is more preferred to use, among the development accelerators described above, hydrazine compounds represented by general formula (D) described in the specification of JP-A No. 2002-156727, and phenolic or naphtholic compounds represented by general formula (2) described in the specification of JP-A No. 2001-264929.

Particularly preferred development accelerators of the invention are compounds represented by the following formulae (A-1) and (A-2).
Q₁-NHNH-Q₂ Formula (A-1)

(in which Q₁ represents an aromatic group or heterocyclic group coupling at a carbon atom to —NHNH-Q₂ and Q₂ represents a carbamoyl group, acyl group, alkoxycarbonyl group, aryloxycarbonyl group, sulfonyl group or sulfamoyl group).

In formula (A-1), the aromatic group or heterocyclic group represented by Q₁ is, preferably, 5 to 7 membered unsaturated rings. Preferred examples are benzene ring, pyridine ring, pyrazine ring, pyrimidine ring, pyridazine ring, 1,2,4-triazine ring, 1,3,5-triazine ring, pyrrole ring, imidazole ring, pyrazole ring, 1,2,3-triazole ring, 1,2,4-triazole ring, tetrazole ring, 1,3,4-thiadiazole ring, 1,2,4-thiadiazole ring, 1,2,5-thiadiazole ring, 1,3,4-oxadiazole ring, 1,2,4-oxadiazole ring, 1,2,5-oxadiazole ring, thiazole ring, oxazole ring, isothiazole ring, isooxazole ring, and thiophene ring. Condensed rings in which the rings described above are condensed to each other are also preferred.

The rings described above may have substituents and in a case where they have two or more substituent groups, the substituents may be identical or different from each other. Examples of the substituents can include halogen atom, alkyl group, aryl group, carboamide group, alkylsulfoneamide group, arylsulfonamide group, alkoxy group, aryloxy group, alkylthio group, arylthio group, carbamoyl group, sulfamoyl group, cyano group, alkylsulfonyl group, arylsulfonyl group, alkoxycarbonyl group, aryloxycarbonyl group and acyl group. In a case where the substituents are groups capable of substituting, they may have further substituents and examples of preferred substituents can include halogen atom, alkyl group, aryl group, carbonamide group, alkylsulfoneamide group, arylsulfoneamide group, alkoxy group, aryloxy group, alkylthio group, arylthio group, acyl group, alkoxycarbonyl group, aryloxycarbonyl group, carbamoyl group, cyano group, sulfamoyl group, alkylsulfonyl group, arylsulfonyl group and acyloxy group.

The carbamoyl group represented by Q₂ is a carbamoyl group preferably having 1 to 50 carbon atoms and, more preferably, of 6 to 40 carbon atoms, for example, not-substituted carbamoyl, methyl carbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl} carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbaoyl, N-3-pyridylcarbamoyl and N-benzylcarbamoyl.

The acyl group represented by Q₂ is an acyl group, preferably, having 1 to 50 carbon atoms and, more preferably, 6 to 40 carbon atoms and can include, for example, formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl. Alkoxycarbonyl group represented by Q₂ is an alkoxycarbonyl group, preferably, of 2 to 50 carbon atoms and, more preferably, of 6 to 40 carbon atoms and can include, for example, methoxycarbonyl, ethoxycarbonyl, isobutyloxycarbonyl, cyclehexyloxycarbonyl, dodecyloxycarbonyl and benzyloxycarbonyl.

The aryloxy carbonyl group represented by Q₂ is an aryloxycarbonyl group, preferably, having 7 to 50 carbon atoms and, more preferably, of 7 to 40 carbon atoms and can include, for example, phenoxycarbonyl, 4-octyloxyphenoxycarbonyl, 2-hydroxymethylphenoxycarbonyl, and 4-dodecyloxyphenoxycarbonyl. The sulfonyl group represented by Q₂ is a sulfonyl group, preferably, of 1 to 50 carbon atoms and, more preferably, of 6 to 40 carbon atoms and can include, for example, methylsulfonyl, butylsulfonyl, octylsulfonyl, 2-hexadecylsulfonyl, 3-dodecyloxypropylsulfonyl, 2-octyloxy-5-tert-octylphenyl sulfonyl, and 4-dodecyloxyphenyl sulfonyl.

The sulfamoyl group represented by Q₂ is sulfamoyl group, preferably, having 0 to 50 carbon atoms, more preferably, 6 to 40 carbon atoms and can include, for example, not-substituted sulfamoyl, N-ethylsulfamoyl group, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl. The group represented by Q₂ may further have a group mentioned as the example of the substituent of 5 to 7-membered unsaturated ring represented by Q₁ at the position capable of substituting. In a case where the group has two or more substituents, such substituents may be identical or different from each other.

Then, preferred range for the compounds represented by formula (A-1) is to be described. 5 to 6 membered unsaturated ring is preferred for Q₁, and benzene ring, pyrimidine ring, 1,2,3-triazole ring, 1,2,4-triazole ring, tetrazole ring, 1,3,4-thiadiazole ring, 1,2,4-thiadiazole ring, 1,3,4-oxadiazole ring, 1,2,4-oxadiazole ring, thioazole ring, oxazole ring, isothiazole ring, isooxazole ring and a ring in which the ring described above is condensed with a benzene ring or unsaturated hetero ring are further preferred. Further, Q₂ is preferably a carbamoyl group and, particularly, a carbamoyl group having hydrogen atom on the nitrogen atom is particularly preferred.

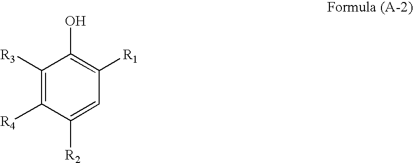

In formula (A-2), R₁ represents an alkyl group, acyl group, acylamino group, sulfoneamide group, alkoxycarbonyl group, and carbamoyl group. R₂ represents a hydrogen atom, halogen atom, alkyl group, alkoxy group, aryloxy group, alkylthio group, arylthio group, acyloxy group and carbonate ester group. R₃, R₄ each represents a group capable of substituting for a hydrogen atom on a benzene ring which is mentioned as the example of the substituent for formula (A-1). R₃ and R₄ may join to each other to form a condensed ring.

R₁ is, preferably, an alkyl group having 1 to 20 carbon atoms (for example, methyl group, ethyl group, isopropyl group, butyl group, tert-octyl group, or cyclohexyl group), acylamino group (for example, acetylamino group, benzoylamino group, methylureido group, or 4-cyanophenylureido group), carbamoyl group (for example, n-butylcarbamoyl group, N,N-diethylcarbamoyl group, phenylcarbamoyl group, 2-chlorophenylcarbamoyl group, or 2,4-dichlorophenylcarbamoyl group), acylamino group (including ureido group or urethane group) being more preferred. R₂ is, preferably, a halogen atom (more preferably, chlorine atom, bromine atom), alkoxy group (for example, methoxy group, butoxy group, n-hexyloxy group, n-decyloxy group, cyclohexyloxy group or benzyloxy group), and aryloxy group (phenoxy group or naphthoxy group).

R₃ is, preferably a hydrogen atom, halogen atom or an alkyl group having 1 to 20 carbon atoms, the halogen atom being most preferred. R₄ is preferably a hydrogen atom, alkyl group or an acylamino group, with the alkyl group or the acylamino group being more preferred. Examples of the preferred substituent thereof are identical with those for R₁. In a case where R₄ is an acylamino group, R₄ may preferably be joined with R₃ to form a carbostyryl ring.

In a case where R₃ and R₄ in formula (A-2) are joined to each other to form a condensed ring, a naphthalene ring is particularly preferred as the condensed ring. The same substituent as the example of the substituent referred to for formula (A-1) may be joined to the naphthalene ring. In a case where formula (A-2) is a naphtholic compound, R₁, is, preferably, a carbamoyl group. Among them, benzoyl group is particularly preferred. R₂ is, preferably, an alkoxy group or aryloxy group and, particularly, preferably an alkoxy group.

Preferred specific examples for the development accelerator of the invention are to be described below. The invention is not restricted to them. 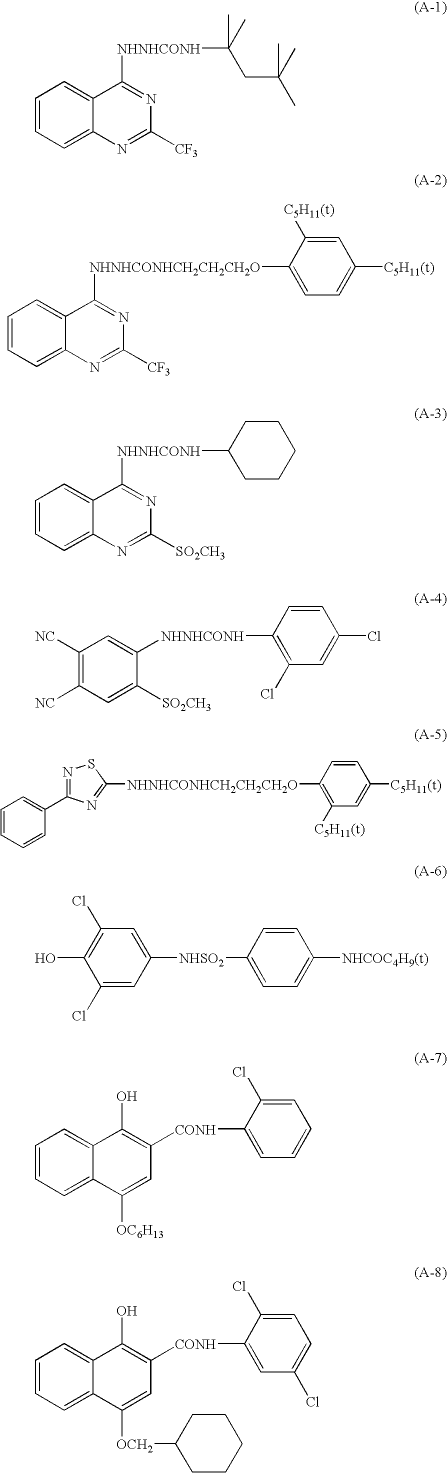 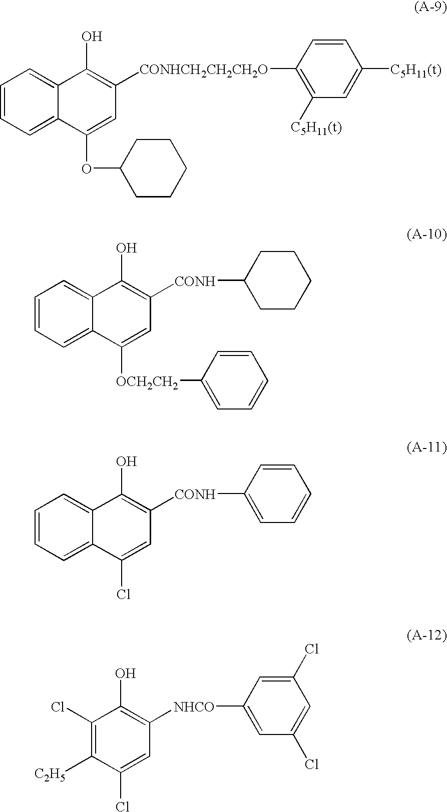
7. Hydrogen Bonding Compound

In the invention, in the case that the reducing agent has an aromatic hydroxyl group (—OH) or an amino group, particularly in the case that the reducing agent is a bisphenol described above, it is preferred to use in combination, a non-reducing compound having a group capable of reacting with these groups of the reducing agent, and that is also capable of forming a hydrogen bond therewith.

As a group forming a hydrogen bond with a hydroxyl group or an amino group, there can be mentioned a phosphoryl group, a sulfoxido group, a sulfonyl group, a carbonyl group, an amido group, an ester group, an urethane group, an ureido group, a tertiary amino group, a nitrogen-containing aromatic group, and the like. Particularly preferred among them is phosphoryl group, sulfoxido group, amido group (not having >N—H moiety but being blocked in the form of >N—Ra (where, Ra represents a substituent other than H)), urethane group (not having >N—H moiety but being blocked in the form of >N—Ra (where, Ra represents a substituent other than H)), and ureido group (not having >N—H moiety but being blocked in the form of >N—Ra (where, Ra represents a substituent other than H)).

In the invention, particularly preferable as the hydrogen bonding compound is the compound expressed by formula (D) shown below.

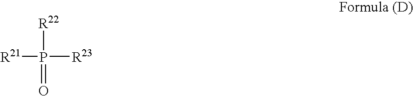

In formula (D), R²¹ to R²³ each independently represent an alkyl group, an aryl group, an alkoxy group, an aryloxy group, an amino group, or a heterocyclic group, which may be substituted or not substituted.

In the case R²¹ to R²³ contain a substituent, examples of the substituents include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, a phosphoryl group, and the like, in which preferred as the substituents are an alkyl group or an aryl group, e.g., methyl group, ethyl group, isopropyl group, t-butyl group, t-octyl group, phenyl group, a 4-alkoxyphenyl group, a 4-acyloxyphenyl group, and the like.

Specific examples of an alkyl group expressed by R²¹ to R²³ include methyl group, ethyl group, butyl group, octyl group, dodecyl group, isopropyl group, t-butyl group, t-amyl group, t-octyl group, cyclohexyl group, 1-methylcyclohexyl group, benzyl group, phenetyl group, 2-phenoxypropyl group, and the like.

As aryl groups, there can be mentioned phenyl group, cresyl group, xylyl group, naphthyl group, 4-t-butylphenyl group, 4-t-octylphenyl group, 4-anisidyl group, 3,5-dichlorophenyl group, and the like.

As alkoxyl groups, there can be mentioned methoxy group, ethoxy group, butoxy group, octyloxy group, 2-ethylhexyloxy group, 3,5,5-trimethylhexyloxy group, dodecyloxy group, cyclohexyloxy group, 4-methylcyclohexyloxy group, benzyloxy group, and the like.

As aryloxy groups, there can be mentioned phenoxy group, cresyloxy group, isopropylphenoxy group, 4-t-butylphenoxy group, naphthoxy group, biphenyloxy group, and the like.

As amino groups, there can be mentioned are dimethylamino group, diethylamino group, dibutylamino group, dioctylamino group, N-methyl-N-hexylamino group, dicyclohexylamino group, diphenylamino group, N-methyl-N-phenylamino, and the like.

Preferred as R²¹ to R²³ are an alkyl group, an aryl group, an alkoxy group, and an aryloxy group. Concerning the effect of the invention, it is preferred that at least one or more of R²¹ to R²³ are an alkyl group or an aryl group, and more preferably, two or more of them are an alkyl group or an aryl group. From the viewpoint of low cost availability, it is preferred that R²¹ to R²³ are of the same group.

Specific examples of hydrogen bonding compounds represented by formula (D) of the invention and others are shown below, but it should be understood that the invention is not limited thereto.

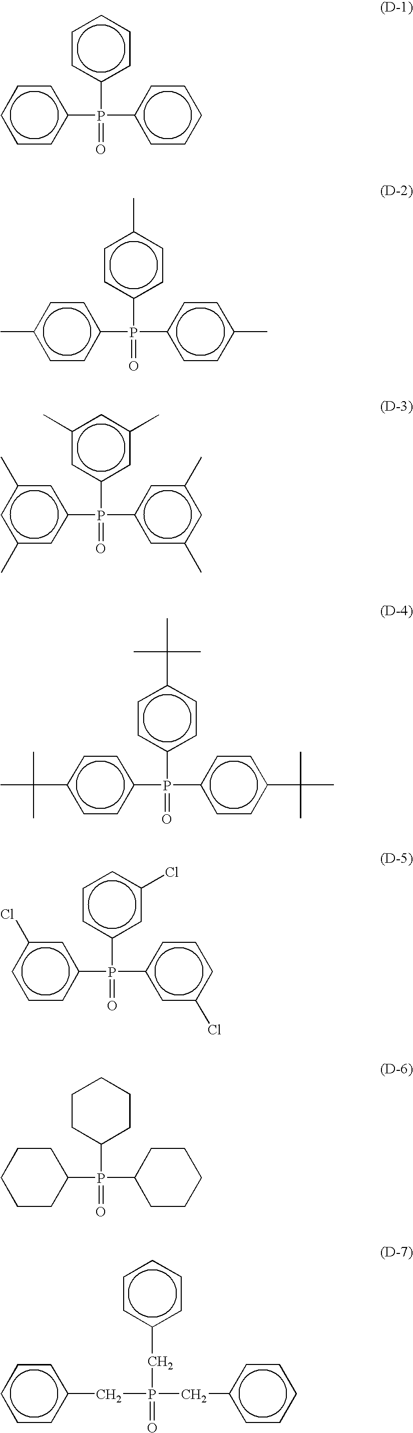

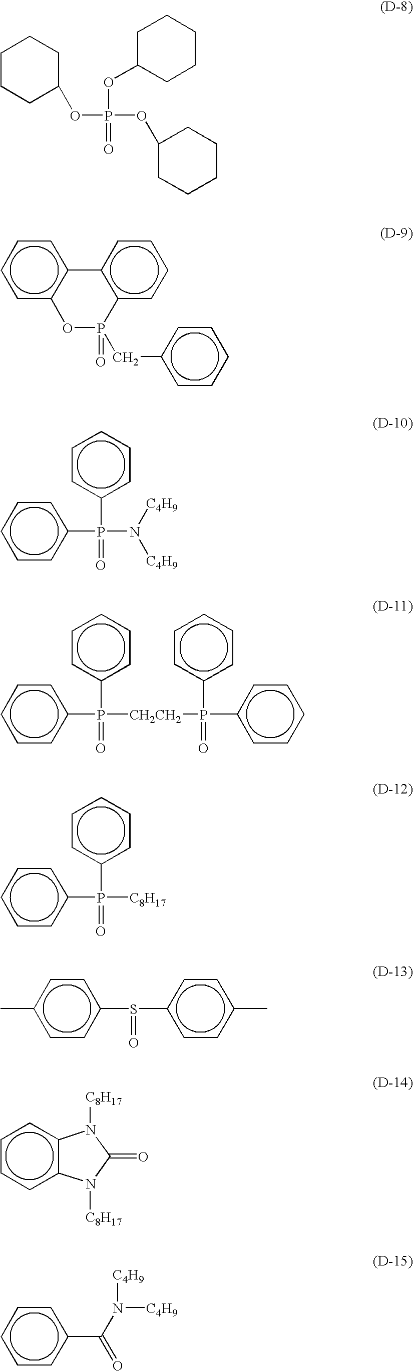

Specific examples of hydrogen bonding compounds other than those enumerated above can be found in those described in European Patent No. 1096310, JP-A No. 2002-156727 and Japanese Patent Application No. 2001-124796.

The compound expressed by formula (D) in the invention can be used in the photothermographic material by being incorporated into the coating solution in the form of solution, emulsion dispersion, or similar to the case of reducing agent. In the solution, these compounds forms a hydrogen-bonded complex with a compound having a phenolic hydroxyl group, and can be isolated as a complex in crystalline state depending on the combination of the reducing agent and the compound expressed by formula (D).

The compound expressed by formula (D) in the invention is preferably used in a range of from 1 mol % to 200 mol %, more preferably from 10 mol % to 150 mol %, and most preferably, from 20 mol % to 100 mol %, with respect to the reducing agent.

8. Other Additives

1) Mercapto Compounds, Disulfides and Thiones

In the invention, mercapto compounds, disulfide compounds, and thione compounds may be added in order to control the development by suppressing or enhancing development, to improve spectral sensitization efficiency, or to improve storage properties before and after development. It is preferred to include the compound expressed by Ar—SM or Ar—S—S—Ar. In the formula, M represents a hydrogen atom or an alkali metal atom; Ar represents an aromatic ring, or a condensed aromatic ring, having one or more nitrogen, sulfur, oxygen, selenium, or tellurium atom.

For example, preferable is benzimidazole, naphthoimidazole, benzthiazole, naphthothiazole, benzoxazole, naphthoxazole, benzselenazole, benztellurazole, imidazole, oxazole, pyrrazole, triazole, thiadiazole, tetrazole, triazine, pyrimidine, pyridazine, pyrazine, pyridine, purine, quinoline, or quinazolinone. Benzimidazole, benzthiazole or benztellurazole is more preferable.

These aromatic ring may have a substituent selected from, for example, a halogen (e.g., Br and Cl), a hydroxyl group, an amino group, a carboxy group, an alkyl group (e.g., preferably, such having 1 to 4 carbon atoms), an alkoxy group (e.g., preferably, such having 1 to 4 carbon atoms), and an aryl group (which may have a sustituent).

The addition amount of these compounds is preferably in a range of from 0.001 mol to 1.0 mol, and more preferably, 0.003 mol to 0.1 mol, per one mol of silver in the image forming layer.

2) Toner

In the photothermographic material of the present invention, the addition of a toner is preferred. The description of the toner can be found in JP-A No. 10-62899 (paragraph Nos. 0054 to 0055), EP-A No. 0803764A1 (page 21, lines 23 to 48), JP-A Nos. 2000-356317 and 2000-187298. Preferred are phthalazinones (phthalazinone, phthalazinone derivatives and metal salts thereof, e.g., 4-(1-naphthyl)phthalazinone, 6-chlorophthalazinone, 5,7-dimethoxyphthalazinone and 2,3-dihydro-1,4-phthalazinedione); combinations of phthalazinones and phthalic acids (e.g., phthalic acid, 4-methylphthalic acid, 4-nitrophthalic acid, diammonium phthalate, sodium phthalate, potassium phthalate and tetrachlorophthalic anhydride); phthalazines(phthalazine, phthalazine derivatives and metal salts thereof, e.g., 4-(1-naphthyl)phthalazine, 6-isopropylphthalazine, 6-ter-butylphthalazine, 6-chlorophthalazine, 5,7-dimethoxyphthalazine and 2,3-dihydrophthalazine); combinations of phthalazines and phthalic acids. In the case used together with the silver halide having a high silver iodide content, particularly preferred is a combination of phthalazines and phthalic acids.

The addition amount of toner is preferably in a range of from 0.1 mol % to 50 mol %, and more preferably 0.5 mol % to 20 mol %, per one mol of silver in the image forming layer.

3) Antifoggant

In the invention, the compounds represented by formula (H) described below are preferably used as the antifoggant.
Q-(Y)n-C(Z₁)(Z₂)X Formula (H)

In formula (H), Q represents an alkyl group, an aryl group, or a heterocyclic group; Y represents a divalent connecting group; n represents 0 or 1; Z₁ and Z₂ each respectively represent a halogen atom; and X represents hydrogen atom or an electron attracting group.

In formula (H), Q preferably is a phenyl group substituted by an electron-attracting group whose Hammett substitution coefficient up yields a positive value. For the details of Hammett substitution coefficient, reference can be made to Journal of Medicinal Chemistry, Vol. 16, No. 11 (1973), pp. 1207 to 1216, and the like.

As such electron-attracting groups, examples include, halogen atoms (fluorine atom (σp value: 0.06), chlorine atom (σp value: 0.23), bromine atom (σp value: 0.23), iodine atom (σp value: 0.18)), trihalomethyl groups (tribromomethyl (σp value: 0.29), trichloromethyl (σp value: 0.33), trifluoromethyl (σp value: 0.54)), a cyano group (σp value: 0.66), a nitro group (σp value: 0.78), an aliphatic aryl or heterocyclic sulfonyl group (for example, methanesulfonyl (σp value: 0.72)), an aliphatic aryl or heterocyclic acyl group (for example, acetyl (σp value: 0.50) and benzoyl (σp value: 0.43)), an alkinyl (e.g., C≡CH (σp value: 0.23)), an aliphatic aryl or heterocyclic oxycarbonyl group (e.g., methoxycarbonyl (σp value: 0.45) and phenoxycarbonyl (σp value: 0.44)), a carbamoyl group (σp value: 0.36), sulfamoyl group (σp value: 0.57), sulfoxido group, heterocyclic group, and phosphoryl group.

Preferred range of the σp value is from 0.2 to 2.0, and more preferably, from 0.4 to 1.0.

Preferred as the electron-attracting groups are a carbamoyl group, an alkoxycarbonyl group, an alkylsulfonyl group, an alkylphosphoryl group, a carboxyl group, an alkylcarbonyl group, and an arylcarbonyl group, particularly preferred among them are a carbamoyl group, an alkoxycarbonyl group, an alkylsulfonyl group, an alkylphosphoryl group, and most preferred among them is a carbamoyl group.

X preferably is an electron-attracting group, more preferably, a halogen atom, an aliphatic aryl or heterocyclic sulfonyl group, an aliphatic aryl or heterocyclic acyl group, an aliphatic aryl or heterocyclic oxycarbonyl group, carbamoyl group, or sulfamoyl group; particularly preferred among them is a halogen atom.

Among halogen atoms, preferred are chlorine atom, bromine atom, and iodine atom; more preferred are chlorine atom and bromine atom; and particularly preferred is bromine atom.

Y preferably represents —C(═O)—, —SO—, or —SO₂—; more preferably, —C(═O)— or —SO₂—; and particularly preferred is —SO₂—. n represents 0 or 1, and preferred is 1.

Specific examples of the compounds expressed by formula (H) of the invention are shown below.

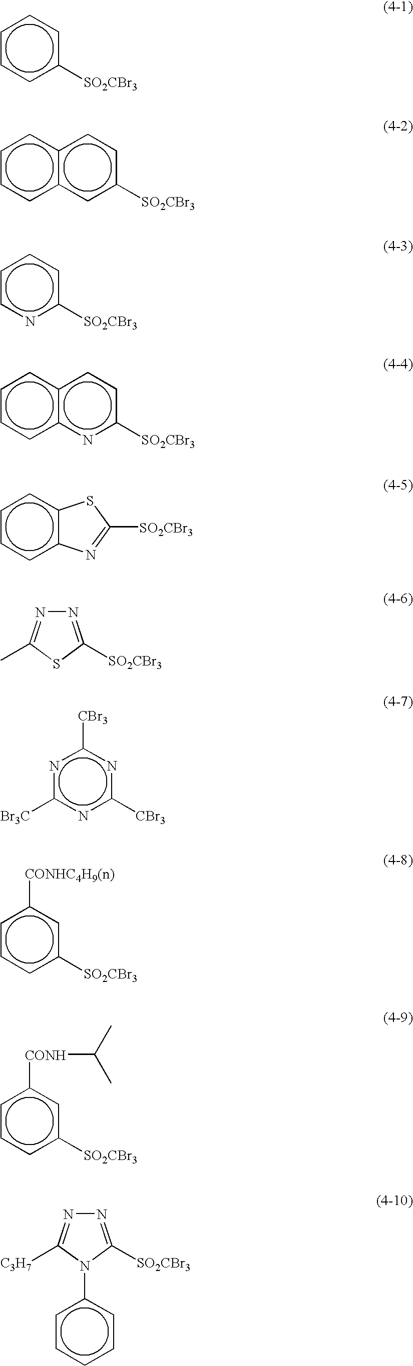

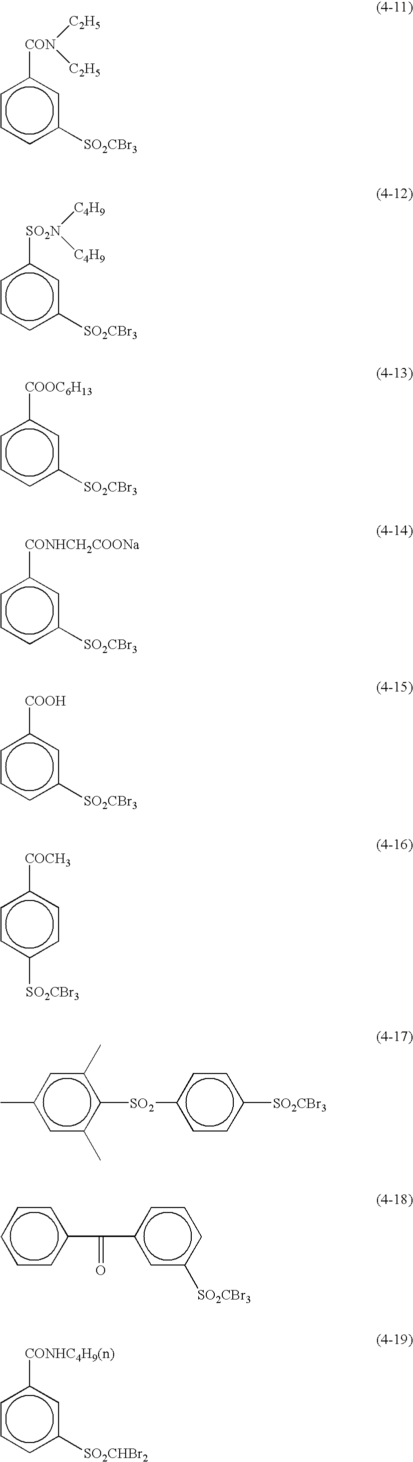

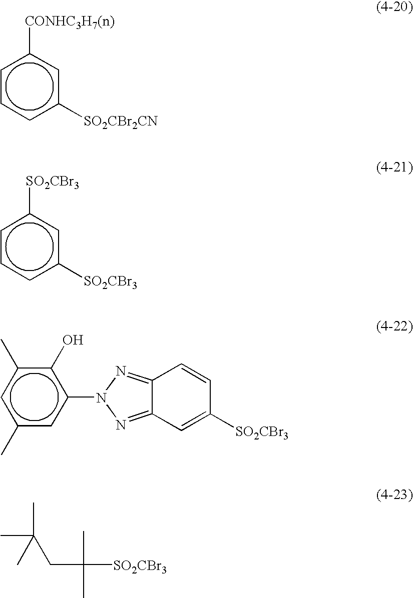

A compound expressed by the formula (H) in the invention is preferably used in the range of from 10⁻⁴ mol to 0.8 mol per one mole of a non-photosensitive silver salt in an image forming layer, more preferably used in the range of from 10⁻³ mol to 0.1 mol and still more preferably used in the range of from 5×10⁻³ mol to 0.05 mol.

Particularly, in a case where a silver halide having a composition of a high silver iodide content, an amount of addition of a compound expressed by formula (H) is important in order to obtain a sufficient anti-fogging effect and the compound is most preferably used in the range of from 5×10⁻³ mol to 0.03 mol.

In the invention, a method of incorporating a compound expressed by formula (H) into a photosensitive material is described in a method of incorporating a reducing agent described above.

A melting point of a compound expressed by formula (H) is preferably 200° C. or lower and more preferably 170° C. or lower.

Examples of other organic polyhalogen compounds used in the invention are disclosed in paragraphs Nos. 0111 to 0112 of JP-A No. 11-65021. Preferable examples thereof are an organic polyhalogen compound expressed by the formula (P) described in JP-A No. 11-87297, an organic polyhalogen compound expressed by general formula (II) described in JP-A No. 10-339934 and an organic polyhalogen compound described in Japanese Patent Application No. 11-205330.

4) Other Antifoggants

Examples of antifoggants and stabilizers or precursors thereof suitable for independent use or combined use include the thiazolium salts disclosed in U.S. Pat. Nos. 2,131,038 and 2,694,716, the azaindenes disclosed in U.S. Pat. Nos. 2,886,487 and 2,444,605, the compounds disclosed in JP-A No. 9-329865 and U.S. Pat. No. 6,083,681, the mercury salts disclosed in U.S. Pat. No. 2,728,663, the urazoles disclosed in U.S. Pat. No. 3,287,135, the sulfocatechols disclosed in U.S. Pat. No. 3,235,652, the oximes, the nitrones and nitroindazoles disclosed in GBP No. 623448, the polyvalent metal salts disclosed in U.S. Pat. No. 2,839,405, the thiuronium salts disclosed in U.S. Pat. No. 3,220,839, the palladium, platinum and gold salts disclosed in U.S. Pat. Nos. 2,566,263 and 2,597,915, the halogen-substituted organic compounds disclosed in U.S. Pat. Nos. 4,108,665 and 4,442,202, the triazines disclosed in U.S. Pat. Nos. 4,128,557, 4,137,079, 4,138,365 and 4,459,350, and the phosphorus compounds disclosed in U.S. Pat. No. 4,411,985.

In some cases, it is advantageous that the present photothermographic material contains in its photosensitive layer a mercury(II) salt as an antifoggant. The mercury(II) salts appropriate for this purpose are mercury(II) acetate and mercury(II) bromide. The suitable amount of mercury used in the invention is in the range of 1 nanomole to 1 millimole, preferably 10 nanomoles to 100 micromoles, per one mole of coated silver.

The present photothermographic material may contain benzoic acids for the purposes of sensitivity increase and fog prevention. The benzoic acids used for these purposes may include any of benzoic acid derivatives. Examples of a benzoic acid derivative having a favorable structure include the compounds disclosed in U.S. Pat. Nos. 4,784,939 and 4,152,160, and JP-A Nos. 9-281687, 9-329864 and 9-329865. The benzoic acids used in the invention may be added to any part of the photothermographic material, but it is preferable to add them to a layer arranged on the photosensitive layer side, particularly to the layer containing organic silver salt. As to the addition time of benzoic acids, the acids may be added at any stage in the process of preparing a coating solution. In the case of adding benzoic acids to the organic silver salt-containing layer, the benzoic acids may be added at any stage during a period from the preparation of the organic silver salts to the preparation of the coating solution. However, it is preferable that the benzoic acids be added during the period from the conclusion of the preparation of organic silver salts to just before the coating operation. The benzoic acids may be added according to any method. For instance, a method of adding them in the form of a powder, a solution or a dispersion of fine particles can be adopted. On the other hand, a mixture may be prepared from the benzoic acids and other additives, such as a sensitizing dye, a reducing agent and a toner, and added as a solution thereof. In the invention, the benzoic acids may be added in any amount, but it is appropriate to add them in an amount of 1 micromole to 2 moles, preferably 1 millimole to 0.5 mole, per one mole of silver.

The present photothermographic material may contain azolium salts for the purpose of fog prevention. Examples of an azolium salt usable for such a purpose include the compounds represented by formula (XI) in JP-A No. 59-193447, the compounds disclosed in JP-B No. 55-12581, and the compounds represented by formula (II) in JP-A No. 60-153039. Although the azolium salts may be added to any part of the photothermographic material, it is preferable to add them to a layer arranged on the photosensitive layer side, especially to the layer containing organic silver salts.

As to the addition time of azolium salts, the salts may be added at any stage in the process of preparing a coating solution. In the case of adding azolium salts to the organic silver salt-containing layer, the azolium salts may be added at any stage during a period from the preparation of the organic silver salts to the preparation of the coating solution. However, it is preferable that the azolium salts be added during the period from the conclusion of the preparation of organic silver salts to just before the coating operation. The azolium salts may be added according to any method. For instance, a method of adding them in the form of a powder, a solution or a dispersion of fine particles can be adopted. On the other hand, a mixture may be prepared from the azolium salts and other additives, such as a sensitizing dye, a reducing agent and a toner, and added as a solution thereof.

In the invention, the azolium salts may be added in any amount, but it is appropriate to add them in an amount of 1×10⁻⁶ mole to 2 moles, preferably 1×10⁻³ mole to 0.5 mole, per one mole of silver.

5) Plasticizer and Lubricant

Plasticizers and lubricants usable in the photothermographic material of the invention are described in paragraph No. 0117 of JP-A No. 11-65021. Lubricants are described in paragraph Nos. 0061 to 0064 of JP-A No. 11-84573 and in paragraph Nos. 0049 to 0062 of Japanese Patent Application No. 11-106881.

6) Dyes and Pigments

From the viewpoint of improving image tone, of preventing the generation of interference fringes and of preventing irradiation on laser exposure, various types of dyes and pigments may be used in the photosensitive layer of the invention.

The photosensitive layer of the invention preferably has an absorption of 0.1 to 0.6, and more preferably, 0.2 to 0.5, at the exposing wavelength. In the case absorption is large, Dmin increases to make images difficult to discriminate, and in the case absorption is low, sharpness becomes impaired. Any methods may be employed to impart absorption to the photosensitive layer of the invention, but it is preferred to use a dye. Usable as the dyes are any of those satisfying the absorption conditions above; for instance, there can be mentioned pyrazoloazole dyes, anthraquinone dyes, azo dyes, azomethine dyes, oxonol dyes, carbocyanine dyes, styryl dyes, triphenylmethane dyes, indoaniline dyes, indophenol dyes, squalilium dyes, and the like. As preferred dyes for use in the invention, there can be mentioned an anthraquinone dye (e.g., compounds 1 to 9 described in JP-A No. 5-341441, compounds 3-6 to 3-18 and 3-23 to 3-38 described in JP-A No. 5-165147, and the like), an azomethine dye (e.g., compounds 17 to 47 described in JP-A No. 5-341441), an indoaniline dye (e.g., compounds 11 to 19 described in JP-A No. 5-289227, compound 47 described in JP-A No. 5-341441, compounds 2-10 to 2-11 described in JP-A No. 5-165147), an azo dye (e.g., compounds 10 to 16 described in JP-A No. 5-341441), and squalilium dye (e.g., compounds 1 to 20 described in JP-A No. 10-104779, and compounds 1a to 3d disclosed in U.S. Pat. No. 5,380,635). These dyes can be added by any means, for instance, in the form of solution, emulsion, solid-dispersed fine particle dispersion, or mordanted by polymer mordant, and the like. The addition amount of these dyes or pigments is determined depending on the targeted absorption; in general, it is preferably used in an amount of 1 μg to 1 g per 1 m².

Further, the light-absorbing substances as disclosed in U.S. Pat. Nos. 3,253,921, 2,274,782, 2,527,583 and 2,956,879 can be included as filter dyes in a surface protective layer. In addition, the dyes can be mordanted as described in U.S. Pat. No. 3,282,699. It is appropriate that the filter dyes be used in an amount to provide an absorbance of 0.1 to 3, particularly preferably 0.2 to 1.5, at the exposure wavelengths.

In the present photothermographic material, it is appropriate that the light absorption by any part other than the layer containing photosensitive silver halide grains be from 0.1 to 3.0 at the exposure wavelengths, preferably from 0.3 to 2.0 in respect of anti-halation. The part having absorption at the exposure wavelengths is preferably a layer arranged on the side of the support opposing to the layer containing photosensitive silver halide grains (e.g., a back layer, an undercoating or subbing layer on the back of the support, a protective layer for a back layer), or a layer between the support and the layer containing photosensitive silver halide grains (e.g., an undercoating or subbing layer).

Additionally, the present photosensitive silver halide grains are spectrally sensitized in the infrared region. In causing the part other than the layer containing photosensitive silver halide grains to have absorption, any method may be adopted. Therein, however, it is preferable to control the absorption maximum in the visible region to 0.3 or below. The dyes used therefor can be dyes similar to those used for causing the photosensitive silver halide layer to have absorption, or they may be the same as or different from the dyes used in the photosensitive silver halide layer.

7) Ultra-High Contrast Promoting Agent

In order to form ultra-high contrast image suitable for use in graphic arts, it is preferred to add an ultra-high contrast promoting agent into the image forming layer. Details on the ultra-high contrast promoting agents, method of their addition and addition amount can be found in paragraph No. 0118 of JP-A No. 11-65021, paragraph Nos. 0136 to 0193 of JP-A No. 11-223898, as compounds expressed by formulae (H), (1) to (3), (A), and (B) in Japanese Patent Application No. 11-87297, as compounds expressed by formulae (III) to (V)(specific compound: chemical No. 21 to chemical No. 24) in Japanese Patent Application No. 11-91652; as an ultra-high contrast accelerator, description can be found in paragraph No. 0102 of JP-A No. 11-65021, and in paragraph Nos. 0194 to 0195 of JP-A No. 11-223898.

In the case of using formic acid or formates as a strong fogging agent, it is preferably incorporated into the side having thereon the image forming layer containing photosensitive silver halide, at an amount of 5 mmol or less, preferably, one mmol or less per one mol of silver.

In the case of using an ultra-high contrast promoting agent in the photothermographic material of the invention, it is preferred to use an acid resulting from hydration of diphosphorus pentaoxide, or its salt in combination. Acids resulting from the hydration of diphosphorus pentaoxide or salts thereof include metaphosphoric acid (salt), pyrophosphoric acid (salt), orthophosphoric acid (salt), triphosphoric acid (salt), tetraphosphoric acid (salt), hexametaphosphoric acid (salt), and the like. Particularly preferred acids obtainable by the hydration of diphosphorus pentaoxide or salts thereof include orthophosphoric acid (salt) and hexametaphosphoric acid (salt). Specifically mentioned as the salts are sodium orthophosphate, sodium dihydrogen orthophosphate, sodium hexametaphosphate, ammonium hexametaphosphate, and the like.

The addition amount of the acid obtained by hydration of diphoshorus pentaoxide or the salt thereof (i.e., the coverage per 1 m² of the photosensitive material) may be set as desired depending on the sensitivity and fogging, but preferred is an amount of 0.1 mg/m² to 500 mg/m², and more preferably, of 0.5 mg/m² to 100 mg/m².

9. Layer Structure, and Other Components

The present photothermographic material can have non-photosensitive layers in addition to the image forming layer. The non-photosensitive layers can be classified by their locations under the following four groups: (a) surface protective layers provided on the image forming layer (on the side distant from the support), (b) intermediate layers provided between a plurality of image forming layers and between an image forming layer and the protective layer, (c) undercoating layers provided between an image forming layer and the support, and (d) back layers provided on the side opposing to the image forming layer.

Further, a layer functioning as an optical filter can be provided, and it is classified as the layer belonging to the group (a) or (b). The antihalation layer is provided as the layer belonging to the group (c) or (d) in the photothermographic material.

1) Surface Protective Layer

In the present photothermographic material, a surface protective layer can be provided for the purpose of preventing adhesion of the image forming layer. The surface protective layer may be a single layer or a multiple layer.

The binder used in the surface protective layer may be any polymer. Examples of a polymer usable as the binder include polyester, gelatin, polyvinyl alcohol and cellulose derivatives. Among these polymers, cellulose derivatives are preferred over the others. Examples of cellulose derivatives are recited below, but cellulose derivatives usable in the invention should not be construed as being limited to these examples. Specifically, the cellulose derivatives include cellulose acetate, cellulose acetate butyrate, cellulose propionate, hydroxypropyl cellulose, hydroxypropylmethyl cellulose, methyl cellulose, hydroxyethyl cellulose, carboxymethyl cellulose and mixtures thereof. The suitable thickness of the surface protective layer is from 0.1 μm to 10 μm, preferably from 1 μm to 5 μm.

In the surface protective layer, any abherent may be used. Examples of an abherent usable herein include wax, liquid paraffin, silica particles, styrene-containing elastomeric block copolymers (e.g., styrene-butadiene-styrene block copolymer, styrene-isoprene-styrene block copolymer), cellulose acetate, cellulose acetate butyrate, cellulose propionate, and mixtures thereof.

2) Antihalation Layer

Descriptions on the antihalation layer can be found in paragraph Nos. 0123 to 0124 of JP-A No. 11-65021, in JP-A Nos. 11-223898, 9-230531, 10-36695, 10-104779, 11-231457, 11-352625, 11-352626, and the like.

The antihalation layer contains an antihalation dye having its absorption at the wavelength of the exposure light. In the case the exposure wavelength is in the infrared region, an infrared-absorbing dye may be used, and in such a case, preferred are dyes having no absorption in the visible region.

In the case of preventing halation from occurring by using a dye having absorption in the visible region, it is preferred that the color of the dye would not substantially reside after image formation, and is preferred to employ a means for bleaching color by the heat of thermal development; in particular, it is preferred to add a thermal bleaching dye and a base precursor to the non-photosensitive layer to impart function as an antihalation layer. Those techniques are described in JP-A No. 11-231457 and the like.

The amount of adding the thermal bleaching dye is determined depending on the usage of the dye. In general, it is used at an amount as such that the optical density (absorbance) exceeds 0.1 when measured at the desired wavelength. The optical density is preferably in a range of from 0.2 to 2. The usage of dyes to obtain optical density in the above range is generally from 0.001 g/m² to 1 g/m².

By thermal bleaching the dye in such a manner, the optical density after thermal development can be lowered to 0.1 or lower. Two types or more of thermal bleaching dyes may be used in combination in a photothermographic material. Similarly, two types or more of base precursors may be used in combination.

In the case of thermal decolorization by the combined use of a decoloring dye and a base precursor, it is advantageous from the viewpoint of thermal decolorization efficiency to further use the substance capable of lowering the melting point by at least 3° C. when mixed with the base precursor (e.g., diphenylsulfone, 4-chlorophenyl(phenyl)sulfone) as disclosed in JP-A No. 11-352626.

3) Back Layer

Back layers usable in the invention are described in paragraph Nos. 0128 to 0130 of JP-A No. 11-65021.

Any type of polymer may be used as the binder for the back layer. Suitable as the binder are those that are transparent or translucent, and that are generally colorless, such as natural resin or polymer and their copolymers; synthetic resin or polymer and their copolymer; or media forming a film; for example, included are gelatin, rubber, poly(vinyl alcohol), hydroxyethyl cellulose, cellulose acetate, cellulose acetate butyrate, poly(vinyl pyrrolidone), casein, starch, poly(acrylic acid), poly(methylmethacrylic acid), poly(vinyl chloride), poly(methacrylic acid), styrene-maleic anhydride copolymers, styrene-acrylonitrile copolymers, styrene-butadiene copolymers, poly(vinyl acetal)(e.g., poly(vinyl formal) and poly(vinyl butyral)), poly(ester), poly(urethane), phenoxy resin, poly(vinylidene chloride), poly(epoxide), poly(carbonate), poly(vinyl acetate), poly(olefin), cellulose esters, and poly(amide). A binder may be used with water, an organic solvent or emulsion to form a coating solution.

In the invention, coloring matters having maximum absorption in the wavelength range of from 300 nm to 450 nm may be added in order to improve a color tone of developed images and a deterioration of the images during aging. Such coloring matters are described in, for example, JP-A Nos. 62-210458, 63-104046, 63-103235, 63-208846, 63-306436, 63-314535, and 01-61745, Japanese Patent Application No. 11-276751, and the like. Such coloring matters are generally added in the range of from 0.1 mg/m² to 1 g/m², preferably to the back layer provided to the side opposite to the photosensitive layer.

4) Matting Agent

A matting agent may be preferably added to the surface protective layer or to the back layer in order to improve transportability.

The matness on the image forming layer surface is not restricted as far as star-dust trouble occurs, but the matness of 200 seconds to 10000 seconds is preferred, particularly preferred, 300 seconds to 8000 seconds as Beck's smoothness. Beck's smoothness can be calculated easily, by seeing Japan Industrial Standared (JIS) P8119 “The method of testing Beck's smoothness for papers and sheets using Beck's test apparatus”, or TAPPI standard method T479.

The matt degree of the back layer in the invention is preferably in a range of 250 seconds or less and 10 seconds or more; more preferably, 180 seconds or less and 50 seconds or more; most preferably, 500 seconds or less and 40 seconds or more when expressed by Beck smoothness.

In the invention, the matting agent is incorporated preferably in the outermost surface layer of the photothermographic material or a layer functioning as the outermost surface layer, or a layer near to the outer surface, and a layer that functions as the so-called protective layer.

The matting agent in the present invention is generally an organic or an inorganic fine particle insoluble to the coating solution. For example, the organic matting agent described in U.S. Pat. Nos. 1,939,213, 2,701,245, 2,322,037, 3,262,782, 3,539,344 and 3,767,448, and the like, the inorganic matting agent described in the specifications of U.S. Pat. Nos. 1,260,772, 2,192,241, 3,257,206, 3,370,951, 3,523,022 and 3,769,020, and the like. These are well known in the said industry. As the organic compound usable as a matting agent, aqueous dispersed vinyl polymers such as polymethyl acrylate, polymethyl methacrylate, polyacrylonitrile, acrylonitrile/α-methylstyrene copolymer, polystyrene, styrene/divinylbenzene copolymer, polyvinyl acetate, polyethylene carbonate, polytetrafluoroethylene and the like, cellulose derivatives such as methylcellulose, cellulose acetate, cellulose acetate propionate and the like, starch derivatives such as carboxy starch, carboxynitrophenyl starch, reaction product of urea—formaldehyde—starch and the like, hardened gelatin by known hardener and the like, hardened gelatin as a fine hollow capsule particle by a coacervated hardening are preferably used. As examples of inorganic compound, silicon dioxide, titanium dioxide, magnesium dioxide, aluminium oxide, barium sulfate, calcium carbonate, silver chloride and silver bromide desensitized by known method, glass, diatomaceous earth and the like are preferably used. The different kind of compound can be used by mixing with the above matting agent if necessary. There is no limitation according to the size and form of matting agent, an arbitrary particle size can be used. In this invention, particle size of matting agent is preferably 0.1 μm to 30 μm. And the size distribution can be any of narrow and wide. On the other side, as a matting agent effects greatly to haze and surface gloss, it is preferred that the particle size, the shape and the size distribution are arranged in the suitable condition in proportion to the need at the making time of the matting agent or at the mixing time of the plural matting agents.

5) Hardener

A hardener can be used in each of image forming layer, protective layer, back layer, and the like.

As examples of the hardener, descriptions of various methods can be found in pages 77 to 87 of T. H. James, “THE THEORY OF THE PHOTOGRAPHIC PROCESS, FOURTH EDITION” (Macmillan Publishing Co., Inc., 1977). Preferably used are, in addition to chromium alum, sodium salt of 2,4-dichloro-6-hydroxy-s-triazine, N,N-ethylene bis(vinylsulfonacetamide), and N,N-propylene bis(vinylsulfonacetamide), polyvalent metal ions described in page 78 of the above literature and the like, polyisocyanates described in U.S. Pat. No. 4,281,060, JP-A No. 6-208193 and the like, epoxy compounds of U.S. Pat. No. 4,791,042 and the like, and vinyl sulfone based compounds of JP-A No. 62-89048.

The hardener is added as a solution, and the solution is added to the coating solution for forming the protective layer 180 minutes before coating to just before coating, preferably 60 minutes before to 10 seconds before coating. However, so long as the effect of the invention is sufficiently exhibited, there is no particular restriction concerning the mixing method and the conditions of mixing.

As specific mixing methods, there can be mentioned a method of mixing in the tank, in which the average stay time calculated from the flow rate of addition and the feed rate to the coater is controlled to yield a desired time, or a method using static mixer as described in Chapter 8 of N. Harnby, M. F. Edwards, A. W. Nienow (translated by Koji Takahashi) “Liquid Mixing Technology” (Nikkan Kogyo Shinbun, 1989), and the like.

6) Surfactant

The photothermographic material of the invention may contain a surfactant for the purpose of improvement on coatability and a charging property. Examples of surfactants may include a nonionic surfactant, an anionic surfactant, a cationic surfactant and a fluorocarbon surfactant, any of which may be properly used. Concrete examples and patent related documents in which examples are described are as follows: fluorocarbon polymer surfactants described in JP-A No. 62-170950, U.S. Pat. No. 5,380,644 and the like; fluorocarbon surfactants described in JP-A Nos. 60-244945, 63-188135 and the like; polysiloxane based surfactants described in U.S. Pat. No. 3,885,965 and the like; and polyalkylene oxides and anionic surfactants described in JP-A 6-301140 and the like.

In the invention, preferably used are fluorocarbon surfactants. Specific examples of fluorocarbon surfactants can be found in those described in JP-A Nos. 10-197985, 2000-19680, and 2000-214554. Polymer fluorocarbon surfactants described in JP-A 9-281636 can be also used preferably. The usage of fluorocarbon surfactant described in JP-A No. 2000-206560 is particularly preferred.

7) Coating Solvent

Examples of the solvent include those described in Shin Han Yozai Pocketbook (New Edition, Solvent Pocketbook), Ohm Sha (1994), however, the present invention is not limited thereto. The solvent for use in the present invention preferably has a boiling point of 40° C. to 180° C. Specific examples of the solvent include hexane, cyclohexane, toluene, methanol, ethanol, isopropanol, acetone, methyl ethyl ketone, ethyl acetate, 1,1,1-trichloroethane, tetrahydrofuran, triethylamine, thiophene, trifluoroethanol, perfluoropentane, xylene, n-butanol, phenol, methyl isobutyl ketone, cyclohexanone, butyl acetate, diethyl carbonate, chlorobenzene, dibutyl ether, anisole, ethylene glycol diethyl ether, N,N-dimethylformamide, morpholine, propanesultone, perfluorotributylamine and water.

8) Antistatic Agent

The photothermographic material of the invention preferably contains an electrically conductive layer including metal oxides or electrically conductive polymers. The antistatic layer may serve as an undercoat layer, or a back surface protective layer, and the like, but can also be placed specially. Examples of the antistatic layer in the invention include described in paragraph No. 0135 of JP-A No. 11-65021, JP-A Nos. 56-143430, 56-143431, 58-62646, and 56-120519, in paragraph Nos. 0040 to 0051 of JP-A No. 11-84573, U.S. Pat. No. 5,575,957, and in paragraph Nos. 0078 to 0084 of JP-A No. 11-223898.

9) Support

Typical support includes a polyester film, undercoated polyester film, poly(ethylene terephthalate) film, poly(ethylene naphthalate) film, cellulose nitrate film, cellulose ester film, poly(vinyl acetal) film, polycarbonate film, and related or resin-like material, as well as glass, paper, metal, and the like. Flexible base material, particularly such that are partially acetylized, or baryta coated and/or α-olefin polymer laminated supports are used; in particular, paper supports coated with α-olefin polymer having 2 to 10 carbon atoms such as polyethylene, polypropylene, ethylene-butene copolymer, and the like, are typically used. The support may be transparent or opaque, but preferred is transparent.

As the transparent support, favorably used is polyester, particularly, polyethylene terephthalate, which is subjected to heat treatment in the temperature range of from 130° C. to 185° C. in order to relax the internal strain caused by biaxial stretching and remaining inside the film, and to remove strain ascribed to heat shrinkage generated during thermal development.

In the case of a photothermographic material for medical use, the transparent support may be colored with a blue dye (for instance, dye-1 described in the Example of JP-A No. 8-240877), or may be uncolored. Examples of the support are described in paragraph No. 0134 of JP-A No. 11-65021.

As to the support, it is preferred to apply undercoating technology, such as water-soluble polyester described in JP-A No. 11-84574, a styrene-butadiene copolymer described in JP-A No. 10-186565, a vinylidene chloride copolymer described in JP-A No. 2000-39684 and in paragraph Nos. 0063 to 0080 of Japanese Patent Application No. 11-106881, and the like.

10) Other Additives

Furthermore, antioxidant, stabilizing agent, plasticizer, UV absorbent, or a coating aid may be added to the photothermographic material. Each of the additives is added to either of the photosensitive layer or the non-photosensitive layer. Reference can be made to WO No. 98/36322, EP No. 803764A1, JP-A Nos. 10-186567 and 10-18568, and the like.

11) Coating Method

The photothermographic material of the invention may be coated by any method. More specifically, various types of coating operations inclusive of extrusion coating, slide coating, curtain coating, immersion coating, knife coating, flow coating, or an extrusion coating using the type of hopper described in U.S. Pat. No. 2,681,294 are used. Preferably used is extrusion coating or slide coating described in pages 399 to 536 of Stephen F. Kistler and Petert M. Shweizer, “LIQUID FILM COATING” (Chapman & Hall, 1997), and most preferably used is extrusion coating.

12) Wrapping Material

In order to suppress fluctuation from occurring on the photographic performance during a preservation of the photosensitive material of the invention before thermal development, or in order to improve curling or winding tendencies, it is preferred that a wrapping material having low oxygen transmittance and/or vapor transmittance is used. Preferably, oxygen transmittance is 50 mL/atm/m²·day or lower at 25° C., more preferably, 10 mL/atm/m²/day or lower, and most preferably, 1.0 mL/atm/m²/day or lower. Preferably, vapor transmittance is 10 g/atm/m²/day or lower, more preferably, 5 g/atm/m²/day or lower, and most preferably, 1 g/atm/m²/day or lower. As specific examples of a wrapping material having low oxygen transmittance and/or vapor transmittance, reference can be made to, for instance, the wrapping material described in JP-A Nos. 8-254793 and 2000-206653.

13) Other Applicable Techniques

Techniques which can be used for the photothermographic material of the invention also include those in EP No. 803764A1, EP No. 883022A1, WO No. 98/36322, JP-A Nos. 56-62648, 58-62644, JP-A Nos. 09-43766, 09-281637, 09-297367, 09-304869, 09-311405, 09-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, Japanese Patent Application Nos. 2000-187298, 2000-10229, 2000-47345, 2000-206642, 2000-98530, 2000-98531, 2000-112059, 2000-112060, 2000-112104, 2000-112064 and 2000-171936.

14) Color Image Formation

As a method of obtaining a color image using the photothermographic material of the invention, there is a method described in JP-A No. 7-13295, p. 10, left column line 48 to line 11, left column line 40. As stabilizers for color dye images, those exemplified in GBP No. 1326889, U.S. Pat. Nos. 3,432,300, 3,698,909, 3,574,627, 3,573,050, 3,764,337 and 4,042,394 can also be used.

In the case of a multi-color photothermographic material, in general, image forming layers are mutually discriminated and maintained by using a functional or non-functional barrier layer between the image forming layers as described in U.S. Pat. No. 4,460,681.

10. Image Forming Method

1) Exposure

Although the photosensitive material of the invention may be subjected to exposure by any methods, laser beam is preferred as an exposure light source. Particularly, silver halide emulsion of high content of silver iodide had a problem having low photosensitivity, but this problem was solved with the use of high illuminance like laser beam. And it made clear that it needs small amount of energy to record an image. Using thus strong light in a short time made it possible to achieve photosensitivity to the purpose.

Especially, for giving the exposure intensity to provide maximum density (Dmax), the light intensity on the surface of the photographic material is preferably in the range of 0.1 W/mm² to 100 W/mm², more preferably 0.5 W/mm² to 50 W/mm², most preferably 1 W/mm² to 50 W/mm².

As a laser beam according to the invention, preferably used is a gas laser (Ar⁺, He—Ne, or He—Cd), a YAG laser, a pigment laser, or a laser diode. A laser diode and a second harmonics generator element can also be used. Preferred laser is determined corresponding to the peak absorption wavelength of spectral sensitizer and the like, but preferred is a He—Ne laser of red through infrared emission, or a red laser diode; or a Ar⁺, a He—Ne, or a He—Cd laser of blue through green emission, or a blue laser diode. Meanwhile, modules having a SHG (Second Hermonic Generator) chip and a laser diode which are integrated, or blue laser diode have been espcially developed recently, and thus laser output devices for short wavelength region have attracted the attention. Blue laser diode has been expected as a light source with increasing demand hereafter because image recording with high definition is possible, and increased recording density, as well as stable output with longer operating life are enabled. The peak wavelength of laser beam is 300 nm to 500 nm, preferably 400 nm to 500 nm, for blue; and 600 nm to 900 nm, preferably 620 nm to 850 nm, for red to near infrared.

Laser beam which oscillates in a longitudinal multiple modulation by a method such as high frequency superposition is also preferably employed.

2) Thermal Development

Although the development of the photothermographic material of the invention is usually performed by elevating the temperature of the photothermographic material exposed imagewise, any method may be used for this thermal development process. The temperature for the development is preferably 80° C. to 250° C., and more preferably 100° C. to 140° C. Time period for the development is preferably 1 second to 180 seconds, and more preferably 10 seconds to 90 seconds.

In the process for the thermal development, plate type heater process is preferred. Preferable process for the thermal development by a plate type heater may be a process described in JP-A NO. 11-133572, which discloses a thermal developing device in which a visible image is obtained by bringing a photothermographic material with a formed latent image into contact with a heating means at a thermal development region, wherein the heating means comprises a plate heater, and plurality of retainer rollers are oppositely provided along one surface of the plate heater, the thermal developing device is characterized in that thermal development is performed by passing the photothermographic material between the retainer rollers and the plate heater. It is preferred that the plate heater is divided into 2 to 6 portions, with the leading end having the lower temperature by 1° C. to 10° C.

Such a process is also described in JP-A NO. 54-30032, which allows for excluding moisture and organic solvents included in the photothermographic material out of the system, and also allows for suppressing the change of shapes of the support of the photothermographic material upon rapid heating of the photothermographic material.

3) System

Examples of a medical laser imager equipped with a light exposing part and a thermal developing part include Fuji Medical Dry Laser Imager FM-DP L. In connection with FM-DP L, description is found in Fuji Medical Review No. 8, pages 39 to 55. It goes without mentioning that those techniques may be applied as the laser imager for the photothermographic material of the invention. In addition, the present photothermographic material can be also applied as a photothermographic material for the laser imager used in “AD network” which was proposed by Fuji Film Medical Co., Ltd. as a network system accommodated to DICOM standard.

11. Application of the Invention

The image forming method in which the photothermographic material of the invention is used is preferably employed as image forming methods for photothermographic materials for use in medical imaging, photothermographic materials for use in industrial photographs, photothermographic materials for use in graphic arts, as well as for COM, through forming black and white images by silver imaging.

### EXAMPLES

The present invention is specifically explained by way of Examples below, which should not be construed as limiting the invention thereto.

### Example 1

1. Preparation of PET Support

Both surfaces of the PET film which was colored blue at the density 0.17 and had a thickness of 175 μm were treated to corona discharge treatment of 8 W/m²·min.

2. Coating of Back layer

In 830 g of MEK, 84.2 g of cellulose acetate butyrate (CAB381-20, produced by Eastman Chemical Co.) and 4.5 g of polyester resin (Vitel PE2200B, produced by Bostic Co.) were added and dissolved while stirring was carried out. To the solution, 43.2 g of methanol having dissolved therein 4.5 g of a fluorocarbon surfactant (Surflon KH40, product by Asahi Glass Co., Ltd.) and 2.3 g of another fluorocarbon surfactant (Megafac F120K, product by Dainippon Ink & Chemicals Inc.) was added. The resulting solution was thoroughly stirred until these were dissolved. Finally, 75 g of silica (Siloid 64X6000, product by W.R. Grace Co.) dispersed in methyl ethyl ketone to a concentration of 1% by weight using a dissolver-type homogenizer was added and the mixture was stirred to prepare a coating solution for a back layer.

The thus-prepared coating solution for the back layer was coated and dried by an extrusion coater, so as to provide a dry thickness of 3.5 μm. Drying was performed for 5 minutes using air having a temperature of 100° C. and a dew point of 10° C.

3. Image Forming Layer and Surface Protective Layer

1) Preparation of Silver Halide Emulsion

<<Preparation of Silver Halide Emulsion-1>>

To 1420 mL of distilled water was added 4.3 mL of a 1% by weight potassium iodide solution. Further, a liquid added with 3.5 mL of 0.5 mol/L sulfuric acid and 36.7 g of phthalated gelatin was kept at 42° C. while stirring in a stainless steel reaction pot, and thereto were added total amount of: solution A prepared through diluting 22.22 g of silver nitrate by adding distilled water to give the volume of 195.6 mL; and solution B prepared through diluting 21.8 g of potassium iodide with distilled water to give the volume of 218 mL, over 9 minutes at a constant flow rate. Thereafter, 10 mL of a 3.5% by weight aqueous solution of hydrogen peroxide was added thereto, and 10.8 mL of a 10% by weight aqueous solution of benzimidazole was further added.

Moreover, a solution C prepared through diluting 51.86 g of silver nitrate by adding distilled water to give the volume of 317.5 mL and a solution D prepared through diluting 60 g of potassium iodide with distilled water to give the volume of 600 mL were added. A controlled double jet method was executed through adding total amount of the solution C at a constant flow rate over 120 minutes, accompanied by adding the solution D while maintaining the pAg at 8.1. Hexachloroiridium (III) potassium salt was added to give 1×10⁻⁴ mol per one mol of silver at 10 minutes post initiation of the addition of the solution C and the solution D in its entirety. Moreover, at 5 seconds after completing the addition of the solution C, a potassium iron (II) hexacyanide aqueous solution was added at a total amount of 3×10⁻⁴ mol per one mol of silver. The mixture was adjusted to the pH of 3.8 with 0.5 mol/L sulfuric acid. After stopping stirring, the mixture was subjected to precipitation/desalting/water washing steps. The mixture was adjusted to the pH of 5.9 with 1 mol/L sodium hydroxide to produce a silver halide dispersion having the pAg of 8.0.

The above-mentioned silver halide dispersion was kept at 38° C. with stirring, and thereto was added 5 mL of a 0.34% by weight methanol solution of 1,2-benzoisothiazoline-3-one, followed by elevating the temperature to 47° C. At 20 minutes after elevating the temperature, sodium benzene thiosulfonate in a methanol solution was added at 7.6×10⁻⁵ mol per one mol of silver. At additional 5 minutes later, a tellurium sensitizer C in a methanol solution was added at 2.9×10⁻⁴ mol per one mol of silver and subjected to aging for 91 minutes. Thereto was added 1.3 mL of a 0.8% by weight N,N′-dihydroxy-N″,N″-diethylmelamine in methanol, and at additional 4 minutes thereafter, 5-methyl-2-mercaptobenzimidazole in a methanol solution at 4.8×10⁻³ mol per one mol of silver, 1-phenyl-2-heptyl-5-mercapto-1,3,4-triazole in a methanol solution at 5.4×10⁻³ mol per one mol of silver were added to produce a silver halide emulsion-1.

Grains in thus prepared silver halide emulsion were pure silver iodide grains having a mean sphere equivalent diameter of 0.040 μm, a variation coefficient of 18%. Grain size and the like were determined from the average of 1000 grains using an electron microscope.

Further, as “a compound that can be one-electron-oxidized to provide a one-electron oxidation product, which releases one or more electrons”, the compounds Nos. 2, 20 and 26 were added respectively in the amount of 2×10⁻³ mol per one mol of silver halide.

Thereafter, as “a compound having an adsorptive group and a reducible group”, the compounds Nos. (19), (49), and (71) were added respectively in the amount of 8×10⁻³ mol per one mol of silver halide, as shown in Tables 2 and 3.

<<Preparation of Silver Halide Emulsion-2>>

To 1421 mL of distilled water was added 3.1 mL of a 1% by weight potassium bromide solution. Further, a liquid added with 3.5 mL of 0.5 mol/L sulfuric acid and 31.7 g of phthalated gelatin was kept at 34° C. while stirring in a stainless steel reaction pot, and thereto were added total amount of: solution A prepared through diluting 22.22 g of silver nitrate by adding distilled water to give the volume of 95.4 mL; and solution B prepared through diluting 15.3 g of potassium bromide and 0.8 g of potassium iodide with distilled water to give the volume of 97.4 mL, over 45 seconds at a constant flow rate. Thereafter, 10 mL of a 3.5% by weight aqueous solution of hydrogen peroxide was added thereto, and 10.8 mL of a 10% by weight aqueous solution of benzimidazole was further added.

Moreover, a solution C prepared through diluting 51.86 g of silver nitrate by adding distilled water to give the volume of 317.5 mL and a solution D prepared through diluting 60 g of potassium iodide with distilled water to give the volume of 600 mL were added. A controlled double jet method was executed through adding total amount of the solution C at a constant flow rate over 120 minutes, accompanied by adding the solution D while maintaining the pAg at 6.3. Hexachloroiridium (III) potassium salt was added to give 1×10⁻⁴ mol per one mol of silver at 10 minutes post initiation of the addition of the solution C and the solution D in its entirety. Moreover, at 5 seconds after completing the addition of the solution C, a potassium iron (II) hexacyanide aqueous solution was added at a total amount of 3×10⁻⁴ mol per one mol of silver. The mixture was adjusted to the pH of 3.8 with 0.5 mol/L sulfuric acid. After stopping stirring, the mixture was subjected to precipitation/desalting/water washing steps. The mixture was adjusted to the pH of 5.9 with 1 mol/L sodium hydroxide to produce a silver halide dispersion having the pAg of 8.0.

Other conditions were established similar to the preparation of silver halide emulsion-1 to produce a silver halide emulsion-2. Grains in thus prepared silver halide emulsion were grains, where 70 mol % of silver iodide layer was joining to 30 mol % of silver bromide layer, having a mean sphere equivalent diameter of 0.040 μm, a variation coefficient of 10%. The portion wich has a silver iodide structure had a light absorption due to strong direct transition.

Further, as “a compound that can be one-electron-oxidized to provide a one-electron oxidation product, which releases one or more electrons”, the compounds Nos. 2, 20 and 26 were added respectively in the amount of 2×10⁻³ mol per one mol of silver halide.

Thereafter, as “a compound having an adsorptive group and a reducible group”, the compounds Nos. (19), (49), and (71) were added respectively in the amount of 8×10⁻³ mol per one mol of silver halide, as shown in Tables 2 and 3.

<<Preparations of Silver Halide Emulsion-3>>

Preparation of silver halide emulsion-3 was conducted in a similar manner to the preparation of silver halide emulsion-2 except that; changing the addition amount of potassium iodide and potassium bromide in the step of preparation of silver halide dispersion, and controlling the temperature in the step of grain growth in order to control the grain size.

Grains in thus prepared silver halide emulsion were silver iodobromide grains containing 3.5 mol % of silver iodide. The grains had a mean sphere equivalent diameter of 0.040 μm.

Further, as “a compound that can be one-electron-oxidized to provide a one-electron oxidation product, which releases one or more electrons”, the compounds Nos. 2, 20 and 26 were added respectively in the amount of 2×10⁻³ mol per one mol of silver halide.

Thereafter, as “a compound having an adsorptive group and a reducible group”, the compound Nos. (19), (49), and (71) were added respectively in the amount of 8×10⁻³ mol per one mol of silver halide, as shown in Tables 2 and 3.

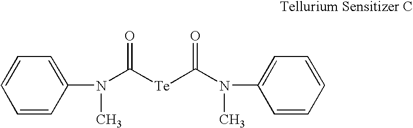

2) Preparations of Powdery Organic Silver Salt

<<Preparations of Powdery Organic Silver Salt A1 to D1>>

To 4720 mL of purified water were added behenic acid, arachidic acid and stearic acid at 0.7552 mol in total with a ratio presented in Table 1. After dissolving at 80° C., 540.2 mL of a 1.5 N aqueous sodium hydroxide solution was added to the solution, and thereto was added 6.9 mL of concentrated nitric acid, followed by cooling to 55° C. to obtain a solution of sodium salt of organic acid. While keeping the temperature of the sodium salt of organic acid solution at 55° C., 45.3 g of the aforementioned silver halide emulsion-1 and 450 mL of purified water were added thereto. The mixture was stirred with a homogenizer manufactured by IKA JAPAN Co. (ULTRA-TURRAXT-25) at 13200 rpm (corresponding to 21.1 kHz of mechanical vibration frequency) for 5 minutes. Then, 702.6 mL of a 1 mol/L silver nitrate solution was added thereto over 2 minutes, followed by stirring for 10 minutes to obtain an organic silver salt dispersion A1 to D1. Thereafter, the resulting organic silver salt dispersion was transferred to a washing vessel, and thereto was added deionized water followed by stirring. The mixture was allowed to stand still so that the organic silver salt dispersion was floatated, and thus water soluble salts present in the bottom part were removed. Then, washing with deionized water and drainage of the waste water was repeated until the electric conductivity of the waste water became 2 μS/cm. After performing centrifugal dewatering, drying in a circulating dryer was performed with warm air having the oxygen partial pressure of 10% by volume at 40° C. until weight loss did not take place to obtain the powdery organic silver salts A1 to D1.

TABLE 1

| Organic silver | Behenic acid | Arachidinic acid | Stearic acid |
|---|---|---|---|
| salt | (mol %) | (mol %) | (mol %) |
| A | 25 | 55 | 20 |
| B | 54 | 29 | 17 |
| C | 60 | 28 | 12 |
| D | 90 | 10 | 0 |

<<Preparations of Powdery Organic Silver Salt A2 to D2>>

Preparations of powdery organic silver salt A2 to D2 were conducted in the similar manner to the preparations of powdery organic silver salt A1 to D1, except that using silver halide emulsion-2 instead of using silver halide emulsion-1.

<<Preparations of Powdery Organic Silver Salt A3 to D3>>

Preparations of powdery organic silver salt A3 to D3 were conducted in the similar manner to the preparations of powdery organic silver salt A1 to D1, except that using silver halide emulsion-3 instead of using silver halide emulsion-1.

3) Preparation of Solution of Organic Silver Salt Dispersion Containing Photosensitive Emulsion

Polyvinyl butyral powder (Monsanto Co., Butvar B-79: Tg=67° C.) in an amount of 14.57 g was dissolved in 1457 g of methyl ethyl ketone (MEK), and thereto was gradually added 500 g of either one of the aforementioned powdery organic silver salts while stirring with a dissolver DISPERMAT CA-40M type manufactured by VMA-GETZMANN Co., and thoroughly mixed to yield a slurry. The slurry was subjected to two passes dispersion with a GM-2 pressure type homogenizer manufactured by SMT Limited to prepare a photosensitive emulsion fluid dispersion. Upon this operation, the pressure for treatment with first-pass was set to be 280 kg/cm², whilst the pressure for treatment with second-pass was set to be 560 kg/cm².

4) Preparations of Coating Solutions for Image Forming Layer

<<Preparations of Coating Solutions for Image Forming Layer-1, -3, -5, -7, -9, -11, -13, -15, -17, -19, -21, -23, -25 to -36>>

MEK was added in an amount of 15.1 g to aforementioned solution of photosensitive emulsion dispersion (50 g), and the mixture was kept at 21° C. while stirring with a dissolver type homogenizer at 1000 rpm. Thereto was added 390 μL of a 10% by weight methanol solution of an aggregate of: two molecules of N,N-dimethyl acetamide/one molecule of oxalic acid/one molecule of bromine, followed by stirring for 1 hour. Furthermore, thereto was added 494 μL of a 10% by weight methanol solution of calcium bromide, and the mixture was stirred for 20 minutes. Subsequently, 167 mg of a methanol solution containing 15.9% by weight of dibenzo-18-crown-6 and 4.9% by weight of potassium acetate was added to the mixture, followed by stirring for 10 minutes. Then, thereto was added 2.6 g of a MEK solution of 18.3% by weight 2-chlorobenzoic acid, 34.2% by weight salicylic acid-p-toluenesulfonate and 4.5% by weight 5-methyl-2-mercaptobenzimidazole, followed by stirring for one hour.

Thereafter, the mixture was cooled to 13° C., and stirred for additional 30 minutes. After adding 13.31 g of polyvinyl butyral (Monsanto Co., Butvar B-79) while keeping the temperature at 13° C., followed by stirring for 30 minutes, 1.08 g of a 9.4% by weight tetrachlorophthalic acid solution was added thereto, followed by stirring for 15 minutes. While keeping stirring, 10.0 g of a 20% by weight MEK solution of the reducing agent 1,1-bis(2-hydroxy-3,5-dimetylphenyl)-2-methylpropane and a 1.1% by weight MEK solution of 4-methyl phthalic acid were added, then was subsequently added 1.5 g of 10% by weight Desmodur N3300 (Mobay, aliphatic isocyanate). Further, thereto was added 4.27 g of an MEK solution of 7.4% by weight tribromomethyl-2-azaphenylsulfone and 7.2% by weight phthalazine to obtain coating solutions for image forming layer-1, -3, -5, -7, -9, -11, -13, -15, -17, -19, -21, -23, -25 to -36.

<<Preparations of Coating Solutions for Image Forming Layer-2, -4, -6, -8, -10, -12, -14, -16, -18, -20, -22, and -24>>

Preparations of coating solutions for image forming layer-, -2, -4, -6, -8, -10, -12, -14, -16, -18, -20, -22, and -24 were conducted in the similar manner to the preparations of abovementioed coating solution for image forming layer, except that using SBR (-St(75)-Bu(24)-AA(1)-: Tg=29° C.) instead of using powdery polyvinyl butyral (Tg=67° C.) as a binder.

5) Preparation of Coating Solution for Surface Protective Layer

To 865 g of MEK was added, while stirring was continued, 96 g of cellulose acetate butyrate (manufactured by Eastman Chemical, CAB 171-15), 4.5 g of polymethyl methacrylate (manufactured by Rohm & Haas, PARALOID A-21), 1.5 g of 1,3-di(vinylsulfonyl)-2-propanol, 1.0 g of benzotriazole and 1.0 g of a fluorocarbon surfactant (manufactured by Asahi Glass Co., Ltd., SURFLON KH40), and dissolved, then, 30 g of a dispersion prepared by dispersing 13.6% by weight of cellulose acetate butyrate (manufactured by Eastman Chemical, CAB 171-15) and 9% by weight of calcium carbonate (manufactured by Speciality Minerals, Super-Pflex 200) in MEK by a dissolver type homogenizer at 8000 rpm for 30 minutes was added and stirring was carried out, to prepare a coating solution for surface protective layer.

6) Coating

Coating solutions for image forming layer-1 to -36 and a coating solution for a surface protective layer described above were simultaneously applied to form multiple layers on the opposite surface to a back layer of a support by an extrusion coater, to produce photothermographic material-1 to -36. The image forming layer was coated so as to be an amount of silver coated as 1.9 g/m² and the surface protective layer to be a dry film thickness as 2.5 μm. Then, it was dried using an air of the temperature of 75° C. and a due point of 10° C. over 10 minutes.

4. Exposure and Development

A NLMV 3000E laser diode fabricated by Nichia Corporation was mounted as a laser diode beam source. Exposures of photothermographic material-1 to -36 were performed while setting or altering a photothermographic material surface intensity at 0 mW/mm² and from 1 mW/mm² to 1000 mW/mm². A light-emission wavelength of laser beam was 405 nm.

Then, development was conducted at 124° C. for 15 seconds using an automatic developing machine having a heat drum so that the surface protective layer of the photothermographic material and the drum surface came into contact. In this operation, the room for exposure and development had a temperature of 23° C. and a relative humidity of 50% RH.

5. Evaluation of Photographic Properties

The dentisy of the image obtained was measured with a densitometer, and a photographic characteristic curve representing a relationship between the common logarithm (log E) of a light exposure and the density was prepared.

Evaluations were conducted as described below.

1) Evaluation of Fog

The optical density of the unexposed part was evaluated.

2) Evaluation of Sensitivity

A sensitivity is defined as a reciprocal of an exposure value at which an optical density of Dmin(fog)+1.0 is obtained. A sensitivity of the photothermographic material-1 is set to 100 and relative sensitivity value was shown. A larger relative sensitivity value means a higher sensitivity.

3) Evaluation of Dark Stability

The developed images of the sample-1 to -36 were kept in condition of 60° C. and relative humidity of 50% for 72 hours. As for the photothermographic material which is inferior in dark stability, the fog degree of the unexposed part was increased. The fog increment amount at Dmin part after the above keeping with respect to the fog before keeping (ΔDmin) was defined as dark stability.

The results obtained are shown in Tables 2 and 3.

TABLE 2

| | | | Compound having | | | | | | |
|---|---|---|---|---|---|---|---|---|---|
| | Silver halide emulsion | | adsorptive group | Silver salt of fatty acid | | | | | Dark |
| Photothermographic | | Silver iodide | and reducible | | Silver behenate | | | | stability |
| material No. | | content (mol %) | group | | content (mol %) | Binder (Tg) | Sensitivity | Fog | (Δ Dmin) |
| 1 | 1 | 100 | — | A | 25 | PVB(67° C.) | 100 | 0.24 | 0.10 |
| 2 | 1 | 100 | — | A | 25 | SBR(29° C.) | 105 | 0.30 | 0.14 |
| 3 | 1 | 100 | — | B | 54 | PVB(67° C.) | 95 | 0.18 | 0.03 |
| 4 | 1 | 100 | — | B | 54 | SBR(29° C.) | 100 | 0.28 | 0.10 |
| 5 | 1 | 100 | — | C | 60 | PVB(67° C.) | 90 | 0.18 | 0.02 |
| 6 | 1 | 100 | — | C | 60 | SBR(29° C.) | 95 | 0.26 | 0.09 |
| 7 | 1 | 100 | — | D | 90 | PVB(67° C.) | 65 | 0.18 | 0.02 |
| 8 | 1 | 100 | — | D | 90 | SBR(29° C.) | 70 | 0.24 | 0.09 |
| 9 | 1 | 100 | (19)(71) | A | 25 | PVB(67° C.) | 230 | 0.30 | 0.10 |
| 10 | 1 | 100 | (19)(71) | A | 25 | SBR(29° C.) | 235 | 0.35 | 0.14 |
| 11 | 1 | 100 | (19)(71) | B | 54 | PVB(67° C.) | 190 | 0.19 | 0.03 |
| 12 | 1 | 100 | (19)(71) | B | 54 | SBR(29° C.) | 195 | 0.33 | 0.10 |
| 13 | 1 | 100 | (19)(71) | C | 60 | PVB(67° C.) | 170 | 0.19 | 0.02 |
| 14 | 1 | 100 | (19)(71) | C | 60 | SBR(29° C.) | 175 | 0.31 | 0.09 |
| 15 | 1 | 100 | (19)(71) | D | 90 | PVB(67° C.) | 110 | 0.19 | 0.02 |
| 16 | 1 | 100 | (19)(71) | D | 90 | SBR(29° C.) | 115 | 0.29 | 0.09 |
| 17 | 1 | 100 | (19)(49)(71) | A | 25 | PVB(67° C.) | 260 | 0.30 | 0.10 |
| 18 | 1 | 100 | (19)(49)(71) | A | 25 | SBR(29° C.) | 265 | 0.35 | 0.14 |
| 19 | 1 | 100 | (19)(49)(71) | B | 54 | PVB(67° C.) | 220 | 0.19 | 0.03 |
| 20 | 1 | 100 | (19)(49)(71) | B | 54 | SBR(29° C.) | 225 | 0.33 | 0.10 |

TABLE 3

| | | | Compound having | | | | | | |
|---|---|---|---|---|---|---|---|---|---|
| | Silver halide emulsion | | adsorptive group | Silver salt of fatty acid | | | | | Dark |
| Photothermographic | | Silver iodide | and reducible | | Silver behenate | | | | stability |
| material No. | | content (mol %) | group | | content (mol %) | Binder (Tg) | Sensitivity | Fog | (Δ Dmin) |
| 21 | 1 | 100 | (19)(49)(71) | C | 60 | PVB(67° C.) | 200 | 0.19 | 0.02 |
| 22 | 1 | 100 | (19)(49)(71) | C | 60 | SBR(29° C.) | 205 | 0.31 | 0.09 |
| 23 | 1 | 100 | (19)(49)(71) | D | 90 | PVB(67° C.) | 135 | 0.19 | 0.02 |
| 24 | 1 | 100 | (19)(49)(71) | D | 90 | SBR(29° C.) | 140 | 0.29 | 0.09 |
| 25 | 2 | 70 | — | A | 25 | PVB(67° C.) | 80 | 0.23 | 0.12 |
| 26 | 2 | 70 | — | C | 60 | PVB(67° C.) | 75 | 0.18 | 0.04 |
| 27 | 2 | 70 | — | D | 90 | PVB(67° C.) | 50 | 0.18 | 0.04 |
| 28 | 2 | 70 | (19)(49)(71) | A | 25 | PVB(67° C.) | 220 | 0.30 | 0.12 |
| 29 | 2 | 70 | (19)(49)(71) | C | 60 | PVB(67° C.) | 180 | 0.19 | 0.04 |
| 30 | 2 | 70 | (19)(49)(71) | D | 90 | PVB(67° C.) | 115 | 0.19 | 0.04 |
| 31 | 3 | 3.5 | — | A | 25 | PVB(67° C.) | 50 | 0.23 | 0.17 |
| 32 | 3 | 3.5 | — | C | 60 | PVB(67° C.) | 45 | 0.18 | 0.06 |
| 33 | 3 | 3.5 | — | D | 90 | PVB(67° C.) | 35 | 0.18 | 0.06 |
| 34 | 3 | 3.5 | (19)(49)(71) | A | 25 | PVB(67° C.) | 130 | 0.30 | 0.17 |
| 35 | 3 | 3.5 | (19)(49)(71) | C | 60 | PVB(67° C.) | 100 | 0.19 | 0.06 |
| 36 | 3 | 3.5 | (19)(49)(71) | D | 90 | PVB(67° C.) | 65 | 0.19 | 0.06 |

As shown in Tables 2 and 3, the photothermographic material-11, -13, -19, -21, -29 and -35 of the invention, has a high sensitivity with a low fogging while exhibiting excellent in dark stability. In the case where the content of silver behenate is 30 mol % or less and the sample comprises a compound having an adsorptive group and a reducible group, the increment amount of fogging is large, but in the case where the content of silver behenate is 30 mol % or more the increase of fog is almost not observed and high sensitivity has obtained. This effect of the content of silver behenate upon the photothermographic material comprising a compound having an adsorptive group and a reducible group was an unexpected result.

It was an unexpected result that quite a low increment of fogging and a high sensitivity are obtained by use of a compound having an adsorptive group and a reducible group in the case the glass transition temperature (Tg) of the binder is 45° C. or more.

Thus, the best effect of the invention was obtained by concomitant use of a silver behenate in a content of 30 mol % to 80 mol %, a binder having Tg of 45° C. or more and a compound having an adsorptive group and a reducible group.

Further, in the case where the silver halide having high silver iodide content is used, a photothermographic material excellent in dark stability was obtained.

### Example 2

1. Preparation of PET Support, and Undercoating

1-1. Film Manufacturing

PET having IV (intrinsic viscosity) of 0.66 (measured in phenol/tetrachloroethane=6/4 (weight ratio) at 25° C.) was obtained according to a conventional manner using terephthalic acid and ethylene glycol. The product was pelletized, dried at 130° C. for 4 hours, melted at 300° C., and the dye BB having the following structure was included at 0.04% by weight. Thereafter, the mixture was extruded from a T-die and rapidly cooled to form a non-tentered film having such a thickness that the thickness should become 175 μm after tentered and thermal fixation.

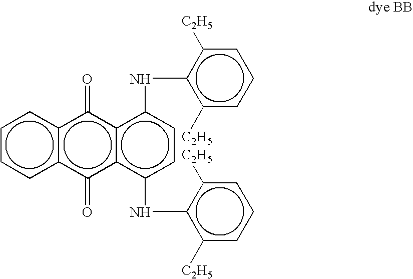

The film was stretched along the longitudinal direction by 3.3 times using rollers of different peripheral speeds, and then stretched along the transverse direction by 4.5 times using a tenter machine. The temperatures used for these operations were 110° C. and 130° C., respectively. Then, the film was subjected to thermal fixation at 240° C. for 20 seconds, and relaxed by 4% along the transverse direction at the same temperature. Thereafter, the chucking parts were slit off, and both edges of the film were knurled. Then the film was rolled up at the tension of 4 kg/cm² to obtain a roll having the thickness of 175 μm.

1-2. Surface Corona Discharge Treatment

Both surfaces of the support were treated at room temperature at 20 m/minute using Solid State Corona Discharge Treatment Machine Model 6 KVA manufactured by Piller GmbH. It was proven that treatment of 0.375 kV·A·minute/m² was executed, judging from the readings of current and voltage on that occasion. The frequency upon this treatment was 9.6 kHz, and the gap clearance between the electrode and dielectric roll was 1.6 mm.

2. Preparation and Coating of Coating Solution for Back Layer

To 830 g of MEK were added 84.2 g of cellulose acetate butyrate (Eastman Chemical, CAB381-20) and 4.5 g of a polyester resin (Bostic Co., Vitel PE2200B) with stirring, and dissolved. To this dissolved solution was added 0.30 g of dye-1, and thereto were added 4.5 g of a fluorocarbon surfactant (Asahi Glass Co., Ltd., Surflon HK40) which had been dissolved in 43.2 g of methanol, and 2.3 g of another fluorocarbon surfactant (Dai-Nippon Ink & Chemicals, Inc., Megafac(R) F120K). The mixture was thoroughly stirred until dissolution was completed. Finally, 75 g of silica (W. R. Grace Co., Siloid 64X6000) dispersed in methyl ethyl ketone at a concentration of 1% by weight with a dissolver type homogenizer was added thereto followed by stirring to prepare a coating solution for the back layer.

Thus prepared coating solution for the back layer was coated on the support with an extrusion coater so that the dry film thickness became 3.5 μm and dried. Drying was executed by an air of the temperature of 100° C., and a dew point of 10° C. over 5 minutes.

3. Image Forming Layer and Surface Protective Layer

3-1. Preparation of Materials for Coating

1) Preparation of Silver Halide Emulsion-11

To a first solution kept at 34° C., which was prepared by dissolving 30 g of phthalated gelatin and 71.4 mg of potassium bromide in 1500 mL of deionized water and adjusted to a pH of 5.0 with 3 mol/L of nitric acid, a solution obtained by dissolving 27.4 g of potassium bromide and 3.3 g of potassium iodide in 275 mL of deionized water and a solution obtained by dissolving 42.5 g of silver nitrate in 364 mL of deionized water were simultaneously added over 9.5 minutes. Thereafter, a solution obtained by dissolving 179 g of potassium bromide and 10 mg of potassium secondary hexachloroiridate in 812 mL of deionized water and a solution obtained by dissolving 127 g of silver nitrate in 1090 mL of deionized water were simultaneously mixed over 28.5 minutes. Here, the pAg was kept constant using a pAg feedback control loop described in Research Disclosure No. 17643, and U.S. Pat. Nos. 3,415,650, 3,782,954 and 3821002. The obtained emulsion was washed and desalted. The average grain size was measured by a transmission electron microscope (TEM) and found to be 0.045 μm.

In the obtained core/shell type silver iodobromide emulsion, the iodine content in the core was 8 mol %, the iodine content in the shell was 0 mol %, the total iodine content was 2 mol % and the iridium content was 2.1×10⁻⁵ mol per one mol of silver halide.

2) Preparation of Silver Halide Emulsion-12 (Comparative Silver Halide)

Preparation of silver halide emulsion-12 for comparision was conducted in a similar manner to the preparation of silver halide emulsion-11, except not using potassium secondary hexachloroiridate.

3) Preparation of Silver Halide Emulsion-13

Preparation of silver halide emulsion-13 was conducted in a similar manner to the preparation of silver halide emulsion-11, except that controlling the amount of potassium bromide and potassium iodide to prepare an uniform silver iodobromide emulsion having silver iodide content of 40 mol %. And by controlling the temperature, the grain size was controlled to be the same as the grain size of silver halide emulsion-11.

4) Preparation of Silver Halide Emulsion-14 (Comparative Silver Halide)

Preparation of silver halide emulsion-14 for comparision was conducted in a similar manner to the preparation of silver halide emulsion-13, except that not using potassium secondary hexachloroiridate.

5) Preparation of Silver Halide Emulsion-15

Preparation of silver halide emulsion-15 was conducted in a similar manner to the preparation of silver halide emulsion-11, except that using potassium iodide instead of using potassium bromide and potassium iodide to prepare a pure silver iodide emulsion having silver iodide content of 100 mol %. And by controlling the temperature, the grain size was controlled to be the same as the grain size of silver halide emulsion-11.

6) Preparation of Silver Halide Emulsion-16 (Comparative Silver Halide)

Preparation of silver halide emulsion-16 for comparision was conducted in a similar manner to the preparation of silver halide emulsion-15, except not using potassium secondary hexachloroiridate.

7) Preparations of Dispersion of Powdery Organic Silver Salt

(Preparations of Dispersion of Powdery Organic Silver Salt-11 to -16)

This is the preparation of a dispersion of organic silver salt containing photosensitive silver halide grains.

688 g of a fatty acid having a composition of 42 mol % of behenic acid, 34 mol % of arachidic acid and 24 mol % of stearic acid was dissolved in 13 L of water at 80° C., and mixed for 15 minutes, then, liquid prepared by dissolving 89.18 g of sodium hydroxide in 1.5 L of water of 80° C. was added, and mixed for 5 minutes to form a dispersion solution. At 80° C., to this dispersion solution was added liquid prepared by diluting 19 mL of concentrated nitric acid with 50 mL of water, and the dispersion solution was cooled to 55° C. and stirred for 25 minutes, then, kept at 55° C.

Dilute emulsion-11 to -16 were prepared by dissolving 700 g of the above-mentioned silver halide emulsion-11 to -16 (containing 1 mol of silver halide) in 1.25 L of water at 42° C.

To aforementioned dispersion solution was added in an amount corresponding to 0.10 mol of each of dilute emulsion-11 to -16, and stirred for 5 minutes. Further, 336.5 g of silver nitrate was dissolved in 2.5 L of water, and the resulted solution was added at 55° C. over 10 minutes.

Then, the resulted organic silver salt dispersion was transferred into a water-washing vessel, and de-ionized water was added to this and the mixture was stirred, then, allowed to stand still to allow the organic silver salt dispersion to float and separate, and the lower water-soluble salts were removed. Then, washing with de-ionized water and drainage were repeated until the conductivity of the drain reached 2 μS/cm, and centrifugal dehydration was performed. Then, drying with warm air having an oxygen partial pressure of 10% by volume was performed at 45° C. in a circulating dryer until the weight loss did not occur.

In this manner, the dispersion of powdery organic silver salt-11 to -16 containing silver halide were prepared.

(Preparations of Dispersion of Powdery Organic Silver Salt-A)

This is the preparation of a dispersion of organic silver salt which does not contain photosensitive silver halide grains.

In 13 L of water, 118 g of Humko-type fatty acid 9718 (product by Witco, Memphis, Tenn.) and 570 g of Humko-type fatty acid 9022 were dissolved at 80° C. and mixed for 15 minutes. Thereto, a solution obtained by dissolving 89.18 g of sodium hydroxide in 1.5 L of water at 80° C. was added and mixed for 5 minutes to form a dispersion solution. To this dispersion solution, a solution obtained by diluting 19 mL of concentrated nitric acid with 50 mL of water was added at 80° C. and the resulting dispersion solution was cooled to 55° C. and stirred for 25 minutes. Thereafter, 336.5 g of silver nitrate dissolved in 2.5 L of water was added at 55° C. over 10 minutes. The obtained organic silver salt dispersion was transferred to a washing vessel and after adding deionized water, stirred and left standing to float and separate the organic silver salt dispersion and water-soluble salts in the lower part were removed. Subsequently, centrifugal dehydration was performed by repeating washing with deionized water and discharging of water until the electrical conductivity of discharged water became 2 μS/cm. Then, drying with warm air having an oxygen partial pressure of 10% by volume was performed at 45° C. in a circulating dryer until the weight loss did not occur.

In this manner, the dispersion of powdery organic silver salt-A not containing silver halide was prepared.

8) Redispersion of Organic Silver Salt into Organic Solvent

(Preparation of Redispersion of Organic Silver Salt-11 to -16)

In 780 g of methyl ethyl ketone (MEK), 209 g of the dispersion of powdery organic silver salt-11 to -16 described above and 11 g of polyvinyl butyral powder (Butvar B-79, product by Monsant) were dissolved. The resulting solution was stirred by a dissolver DISPERMAT Model CA-40M manufactured by VMA-GETZMANN and then left standing overnight at 7° C. to obtain a slurry.

This slurry was dispersed through two paths in a pressure-type homogenizer Model GM-2 manufactured by SMT Co. to prepare redispersion of organic silver salt-11 to -16.

(Preparations of Redispersion of Organic Silver Salt-17 to -22)

In 780 g of methyl ethyl ketone (MEK), 209 g of the dispersion of powdery organic silver salt-A prepared above and 11 g of polyvinyl butyral powder (Butvar B-79, product by Monsant) were dissolved. Thereto, each of the silver halide emulsion-11 to -16 prepared above was added in an amount corresponding to 0.023 mol as the silver halide amount. The resulting solution was stirred by a dissolver DISPERMAT Model CA-40M manufactured by VMA-GETZMANN and then left standing overnight at 7° C. to obtain a slurry.

This slurry was dispersed through two paths in a pressure-type homogenizer Model GM-2 manufactured by SMT Co. to prepare redispersion of organic silver salt-17 to -22.

3-2. Preparations of Coating Solutions

1) Preparation of Coating Solution for Image Forming Layer

Corresponding to each of the photothermographic material, as shown in Tables 5 to 7, 507 g of the redispersion of organic silver salt-17 to -22 prepared above was stirred at 13° C. for 15 minutes and thereto, 3.9 mL of a methanol solution containing 10% by weight of pyridinium hydrobromide perbromide (PHP) was added. After stirring for 2 hours, 5.2 mL of a methanol solution containing 11% by weight of calcium bromide was added. The stirring was continued for 30 minutes and then, 117 g of Butvar B-79 was added. After further stirring for 30 minutes, 27.3 g of 1,1-bis(2-hydroxy-3,5-dimethylphenyl)-2-methylpropane and 2.73 g of 3-tribromomethylsulfonyl-quinoline were added, and stirring was further continued for 15 minutes. Thereafter, as shown in Tables 5 to 7, sensitizing dye-1 or sensitizing dye-2 was added to each of the photothermographic material in an amount of 1×10⁻³ mol per one mol of silver halide and the solution was stirred for 15 minutes. Thereto, a solution obtained by dissolving 1.39 g of Desmodur N3300 (aliphatic isocyanate, produced by MOBEY) in 12.3 g of MEK was added and the resulting solution was stirred for 15 minutes and then heated at 21° C. for 15 minutes.

To 100 g of the obtained dispersion solution, the compounds No. 2, 20, and 26 of Groups 1 to 5 of the present invention were added to each of the photothermographic material shown in Tables 5 to 7 respectively in an amount of 1×10⁻³ mol per one mol of silver halide, and further the compounds having an adsorptive group and a reducible group No. (19), (49) and (71) of the present invention were added to each of the photothermographic material shown in Tables 5 to 7 respectively in an amount of 8×10⁻³ mol per one mol of silver halide, then 0.47 g of 4-chlorobenzophenone-2-carboxylic acid and 0.043 g of 5-methyl-2-mercaptobenzimidazole were added and stirred at 21° C. for one hour. Subsequently, 0.368 g, of phthalazine, 0.123 g of tetrachlorophthalic acid and 2 g of dye-1 were added to obtain a coating solution for image forming layer.

The additives used to each samples are shown in Table 4.

TABLE 4

| | Additive | | |
|---|---|---|---|
| | | | Compound having |
| Sample | | Compound of | adsorptive group |
| No. | Sensitizer | Groups 1 to 5 | and reducible group |
| 101˜112 | sensitizing dye-1 | — | — |
| 113˜124 | sensitizing dye-1 | — | (19)(49)(71) |
| 125˜136 | sensitizing dye-1 | (2)(20)(26) | (19)(49)(71) |
| 137˜148 | sensitizing dye-2 | (2)(20)(26) | (19)(49)(71) |

2) Preparation of Coating Solution for Surface Protective Layer

In 512 g of MEK, 61 g of methanol, 48 g of cellulose acetate butyrate (CAB171-15, product by Eastman Chemical), 2.08 g of 4-methylphthalic acid, 3.3 g of an MEK solution containing 16% by weight of fluorocarbon polymer surfactant C, 1.9 g of polymethyl methacrylate (Acryloid A-21, product by Rhom & Haas), 2.5 mL of a methanol solution containing 1% by weight of benzotriazole, and 0.5 g of 1,3-di(vinylsulfonyl)-2-propanol were mixed at room temperature to prepare a coating solution for surface protective layer.

3-3. Preparations of Photothermographic Material-101 to -148

The coating solution for image forming layer and the coating solution for surface protective layer, which were prepared as above, were simultaneously coated by a dual knife coater on the surface opposite the back layer of the support where the back layer was coated, to prepare photothermographic material-101 to -148. The coating solution for image forming layer was coated to have a dry thickness of 18.3 μm and the coating solution for surface protective layer was coated to have a dry thickness of 3.4 μm. The coating apparatus used was composed of two knife coating blades standing side by side. The support was cut into a length matching the volume of solution used and then the knives each with a hinge were elevated and disposed at a position on a coater floor. Subsequently, the knives were lowered and fixed to a predetermined position. The height of the knives was adjusted by using a wedge which is controlled by a screw knob and measured by an ammeter. Knife No. 1 was elevated to a space corresponding to the thickness as a total of the thickness of support and the desired wet thickness of image-forming layer (Layer No. 1), and Knife No. 2 was elevated to a height equal to the total thickness of support+wet thickness of image-forming layer (Layer No. 1)+desired thickness of surface protective layer (Layer No. 2). Thereafter, drying was performed using an air having a temperature of 75° C. and a dew point of 10° C. for 15 minutes.

Compounds used in Examples are shown below. 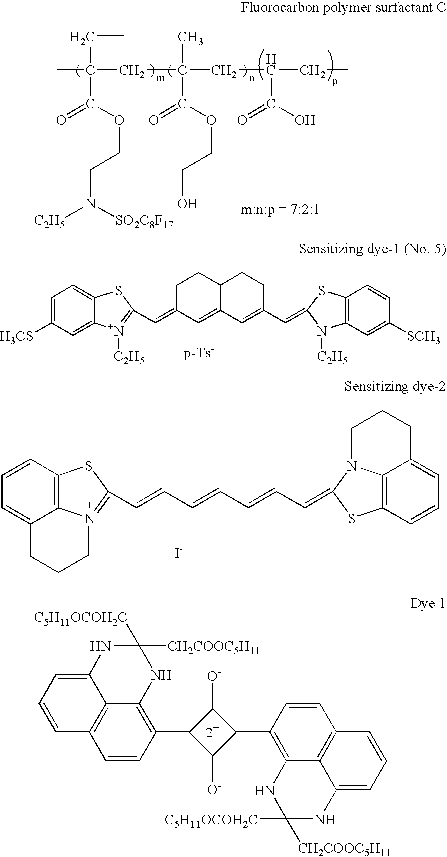
3-4. Exposure and Development

An exposure machine was experimentally produced using, as the exposure light source, a semiconductor laser formed into a longitudinal multiple mode of a wavelength from 800 nm to 820 nm by means of high frequency superposition. Using this exposure machine, Sample-101 to -148 prepared above were exposed by scanning the laser ray on the image forming layer surface. At this time, an image was recorded by setting the scanning laser ray at an incident angle of 750 to the exposed surface of the photothermographic material. Thereafter, each of the samples was thermal-developed at 124° C. for 15 seconds using an automatic developing machine having a heat drum while contacting the protective layer of the photosensitive material with the drum surface. The obtained image was evaluated by a densitometer.

(Sensitivity)

The density of the unexposed area was defined to be fog (Dmin).

The sensitivity was expressed by a reciprocal of the exposure amount of giving an optical density of fog+1.0 and shown by a relative value to the sensitivity of Sample-101 which was taken as 100.

(Image Stability)

The thermal developed samples were each cut into a half-cut size (43 cm in length×35 cm in width), stored for 24 hours in an environment of 30° C. and 70% RH under a fluorescent lamp of 1,000 Lux and then evaluated on the increase of fog density in the Dmin area (ΔDmin₁). The smaller ΔDmin₁ means better in image stability.

(Storability)

The prepared samples were each cut into a half-cut size, and was wrapped with the following packaging material under an environment of 35° C. and 60% RH, and stored for one week at an ambient temperature. After that, exposure and developing treatment was executed and photographic property was evaluated.

Packaging Material

PET 10 μm/PE 12 μm/aluminum foil 9 μm/Ny 15 μm/polyethylene 50 μm containing carbon at 3% by weight, oxygen permeability: 0.02 mL/atm/m²/day, 25° C., vapor permeability: 0.10 g/atm/m²/day, 25° C.

The density of fog after aforementioned storage was measured and defined as aging characteristic. It is preferred to have no increment of fog.
ΔDmin₂=fog degree after storage−fog degree before storage

The results obtained are shown in Tables 5 to 7.

TABLE 5

| Photother- | Silver | | Silver | Compound having | Compound | Redispersion | | | | |
|---|---|---|---|---|---|---|---|---|---|---|
| mographic | halide | | iodide | adsorptive group | of | of organic | | | Image | Stora- |
| material | emul- | Iridium | content | and reducible | Groups | silver | | Sensi- | stability | bility |
| No. | sion | (mol/molAg) | (mol %) | group | 1 to 5 | salt | Sensitizer | tivity | (Δ Dmin1) | (Δ Dmin2) |
| 101 | 11 | 2.1 × 10⁻⁵ | 2 | — | — | 11 | sensitizing dye-1 | 100 | 0.15 | 0.03 |
| 102 | 12 | — | 2 | — | — | 12 | sensitizing dye-1 | 70 | 0.18 | 0.03 |
| 103 | 13 | 2.1 × 10⁻⁵ | 40 | — | — | 13 | sensitizing dye-1 | 105 | 0.10 | 0.03 |
| 104 | 14 | — | 40 | — | — | 14 | sensitizing dye-1 | 73 | 0.13 | 0.03 |
| 105 | 15 | 2.1 × 10⁻⁵ | 100 | — | — | 15 | sensitizing dye-1 | 110 | 0.06 | 0.03 |
| 106 | 16 | — | 100 | — | — | 16 | sensitizing dye-1 | 78 | 0.09 | 0.03 |
| 107 | 11 | 2.1 × 10⁻⁵ | 2 | — | — | 17 | sensitizing dye-1 | 60 | 0.13 | 0.01 |
| 108 | 12 | — | 2 | — | — | 18 | sensitizing dye-1 | 40 | 0.16 | 0.02 |
| 109 | 13 | 2.1 × 10⁻⁵ | 40 | — | — | 19 | sensitizing dye-1 | 63 | 0.09 | 0.02 |
| 110 | 14 | — | 40 | — | — | 20 | sensitizing dye-1 | 42 | 0.12 | 0.02 |
| 111 | 15 | 2.1 × 10⁻⁵ | 100 | — | — | 21 | sensitizing dye-1 | 70 | 0.06 | 0.02 |
| 112 | 16 | — | 100 | — | — | 22 | sensitizing dye-1 | 45 | 0.08 | 0.02 |
| 113 | 11 | 2.1 × 10⁻⁵ | 2 | (19)(49)(71) | — | 11 | sensitizing dye-1 | 200 | 0.06 | 0.01 |
| 114 | 12 | — | 2 | (19)(49)(71) | — | 12 | sensitizing dye-1 | 90 | 0.16 | 0.03 |
| 115 | 13 | 2.1 × 10⁻⁵ | 40 | (19)(49)(71) | — | 13 | sensitizing dye-1 | 210 | 0.04 | 0.01 |
| 116 | 14 | — | 40 | (19)(49)(71) | — | 14 | sensitizing dye-1 | 93 | 0.11 | 0.03 |
| 117 | 15 | 2.1 × 10⁻⁵ | 100 | (19)(49)(71) | — | 15 | sensitizing dye-1 | 230 | 0.02 | 0.01 |
| 118 | 16 | — | 100 | (19)(49)(71) | — | 16 | sensitizing dye-1 | 98 | 0.09 | 0.03 |

TABLE 6

| Photother- | Silver | | Silver | Compound having | Compound | Redispersion | | | | |
|---|---|---|---|---|---|---|---|---|---|---|
| mographic | halide | | iodide | adsorptive group | of | of organic | | | Image | Stora- |
| material | emul- | Iridium | content | and reducible | Groups | silver | | Sensi- | stability | bility |
| No. | sion | (mol/molAg) | (mol %) | group | 1 to 5 | salt | Sensitizer | tivity | (Δ Dmin1) | (Δ Dmin2) |
| 119 | 11 | 2.1 × 10⁻⁵ | 2 | (19)(49)(71) | — | 17 | Sensitizing dye-1 | 120 | 0.05 | 0.01 |
| 120 | 12 | — | 2 | (19)(49)(71) | — | 18 | Sensitizing dye-1 | 50 | 0.15 | 0.02 |
| 121 | 13 | 2.1 × 10⁻⁵ | 40 | (19)(49)(71) | — | 19 | Sensitizing dye-1 | 125 | 0.03 | 0.01 |
| 122 | 14 | — | 40 | (19)(49)(71) | — | 20 | Sensitizing dye-1 | 55 | 0.10 | 0.02 |
| 123 | 15 | 2.1 × 10⁻⁵ | 100 | (19)(49)(71) | — | 21 | Sensitizing dye-1 | 135 | 0.01 | 0.01 |
| 124 | 16 | — | 100 | (19)(49)(71) | — | 22 | Sensitizing dye-1 | 60 | 0.07 | 0.02 |
| 125 | 11 | 2.1 × 10⁻⁵ | 2 | (19)(49)(71) | (2)(20)(26) | 11 | Sensitizing dye-1 | 300 | 0.05 | 0.01 |
| 126 | 12 | — | 2 | (19)(49)(71) | (2)(20)(26) | 12 | Sensitizing dye-1 | 100 | 0.16 | 0.03 |
| 127 | 13 | 2.1 × 10⁻⁵ | 40 | (19)(49)(71) | (2)(20)(26) | 13 | Sensitizing dye-1 | 310 | 0.04 | 0.01 |
| 128 | 14 | — | 40 | (19)(49)(71) | (2)(20)(26) | 14 | Sensitizing dye-1 | 105 | 0.10 | 0.03 |
| 129 | 15 | 2.1 × 10⁻⁵ | 100 | (19)(49)(71) | (2)(20)(26) | 15 | Sensitizing dye-1 | 330 | 0.02 | 0.01 |
| 130 | 16 | — | 100 | (19)(49)(71) | (2)(20)(26) | 16 | Sensitizing dye-1 | 110 | 0.07 | 0.03 |
| 131 | 11 | 2.1 × 10⁻⁵ | 2 | (19)(49)(71) | (2)(20)(26) | 17 | Sensitizing dye-1 | 180 | 0.04 | 0.01 |
| 132 | 12 | — | 2 | (19)(49)(71) | (2)(20)(26) | 18 | Sensitizing dye-1 | 60 | 0.13 | 0.03 |
| 133 | 13 | 2.1 × 10⁻⁵ | 40 | (19)(49)(71) | (2)(20)(26) | 19 | Sensitizing dye-1 | 190 | 0.02 | 0.01 |
| 134 | 14 | — | 40 | (19)(49)(71) | (2)(20)(26) | 20 | Sensitizing dye-1 | 65 | 0.09 | 0.03 |
| 135 | 15 | 2.1 × 10⁻⁵ | 100 | (19)(49)(71) | (2)(20)(26) | 21 | Sensitizing dye-1 | 210 | 0.01 | 0.01 |
| 136 | 16 | — | 100 | (19)(49)(71) | (2)(20)(26) | 22 | Sensitizing dye-1 | 70 | 0.06 | 0.03 |

TABLE 7

| Photother- | Silver | | Silver | Compound having | Compound | Redispersion | | | | |
|---|---|---|---|---|---|---|---|---|---|---|
| mographic | halide | | iodide | adsorptive group | of | of organic | | | Image | Stora- |
| material | emul- | Iridium | content | and reducible | Groups | silver | | Sensi- | stability | bility |
| No. | sion | (mol/molAg) | (mol %) | group | 1 to 5 | salt | Sensitizer | tivity | (ΔDmin1) | (ΔDmin2) |
| 137 | 11 | 2.1 × 10⁻⁵ | 2 | (19)(49)(71) | (2)(20)(26) | 11 | sensitizing dye-2 | 250 | 0.07 | 0.01 |
| 138 | 12 | — | 2 | (19)(49)(71) | (2)(20)(26) | 12 | sensitizing dye-2 | 95 | 0.19 | 0.03 |
| 139 | 13 | 2.1 × 10⁻⁵ | 40 | (19)(49)(71) | (2)(20)(26) | 13 | sensitizing dye-2 | 260 | 0.06 | 0.01 |
| 140 | 14 | — | 40 | (19)(49)(71) | (2)(20)(26) | 14 | sensitizing dye-2 | 100 | 0.13 | 0.03 |
| 141 | 15 | 2.1 × 10⁻⁵ | 100 | (19)(49)(71) | (2)(20)(26) | 15 | sensitizing dye-2 | 280 | 0.03 | 0.01 |
| 142 | 16 | — | 100 | (19)(49)(71) | (2)(20)(26) | 16 | sensitizing dye-2 | 105 | 0.09 | 0.03 |
| 143 | 11 | 2.1 × 10⁻⁵ | 2 | (19)(49)(71) | (2)(20)(26) | 17 | sensitizing dye-2 | 150 | 0.06 | 0.01 |
| 144 | 12 | — | 2 | (19)(49)(71) | (2)(20)(26) | 18 | sensitizing dye-2 | 50 | 0.16 | 0.03 |
| 145 | 13 | 2.1 × 10⁻⁵ | 40 | (19)(49)(71) | (2)(20)(26) | 19 | sensitizing dye-2 | 155 | 0.03 | 0.01 |
| 146 | 14 | — | 40 | (19)(49)(71) | (2)(20)(26) | 20 | sensitizing dye-2 | 55 | 0.12 | 0.03 |
| 147 | 15 | 2.1 × 10⁻⁵ | 100 | (19)(49)(71) | (2)(20)(26) | 21 | sensitizing dye-2 | 180 | 0.01 | 0.01 |
| 148 | 16 | — | 100 | (19)(49)(71) | (2)(20)(26) | 22 | sensitizing dye-2 | 60 | 0.09 | 0.03 |

As seen in these results shown in Tables 5 to 7, the photothermographic material-113, -115, -117, 119, -121, -123, -125, -127, -129, -131, -133, -135, -137, -139, -141, -143, -145 and -147 of the present invention maintains high sensitivity and exhibits excellent image stability and excellent storability. Particularly, using the compound having an adsorptive group and a reducible group gives an effect of maitaining high sensitivity and excellent image stability, however the effect was small in the case using silver halide emulsion not containing iridium, but in the case using silver halide emulsion containing iridium, the effect was evident and that was an unexpected result.

The effect of the present invention becomes more excellent by using the compound Groups 1 to 5 of the compound that can be one-electron-oxidized to provide a one-electron oxidation product which releases one or more electrons. Also in the case where sensitizing dye-1 which corresponds to formulae (3a) to (3d) is used, the result was excellent. And in the case the silver halide grains are iodized at the time when the non-photosensitive organic silver was formed, an excellent result of high sensitivity can be obtained.

As for silver halide, using siver halide with high content of silver iodide, an excellent result with good image stability can be obtained.

### Example 3

1) Preparation of Photosensitive Silver Halide Emulsion-17

In 900 mL of water, 7.5 g of ossein gelatin having an average molecular weight of 100,000 and 10 mg of potassium bromide were dissolved. The resulting solution was adjusted to a temperature of 35° C. and a pH of 3.0 and thereto, 370 mL of an aqueous solution containing 74 g of silver nitrate and 370 mL of an aqueous solution containing potassium bromide and potassium iodide at a molar ratio of 98/2 and containing iridium chloride in an amount of 1×10⁻⁴ mol per one mol of silver were added by a controlled double jet method over 10 minutes while keeping the pAg at 7.7. Thereafter, 0.3 g of 4-hydroxy-6-methyl-1,3,3a,7-tetrazaindene was added and the pH was adjusted to 5 with sodium hydroxide to obtain a cubic silver iodobromide grain having an average grain size of 0.06 μm, a standard deviation in the grain size of 12% and a (100) face percentage of 87%. This emulsion was desalted by adding a gelatin coagulant and thereby flocculating and precipitating silver halide grains, 0.1 g of phenoxyethanol was added thereto, and the pH and the pAg were adjusted to 5.9 and 7.5, respectively, thereby obtaining photosensitive silver halide emulsion-17.

The temperature of the thus-obtained photosensitive silver halide emulsion was elevated to 55° C. and 5×10⁻⁵ mol of Compound A was added. Subsequently, 7×10⁻⁵ mol of ammonium thiocyanate and 5.3×10⁻⁵ mol of chloroauric acid were added thereto. Furthermore, 0.3 mol % of silver iodide fine grain was added. After ripening for 100 minutes, the emulsion was cooled to 38° C. to complete the chemical sensitization. Here, the amount added is an amount per one mol of silver halide.
Compound A:

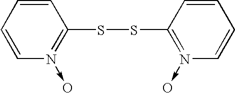

2) Preparation of Photosensitive Silver Halide Emulsion-18 (Comparative Silver Halide)

Preparation of photosensitive silver halide emulsion-18 for comparision was conducted in the similar manner to the preparation of photosensitive silver halide emulsion-17, except not using iridium chloride.

3) Preparation of Powdery Organic Silver Salt

In 4720 mL of pure water, 111.4 g of behenic acid, 83.3 g of arachidinic acid and 54.9 g of stearic acid were added and dissolved at 80° C. To this mixture, 540.2 mL of an aqueous 1.5N sodium hydroxide solution was added and after 6.9 mL of concentrated nitric acid was added, the resulting solution was cooled to 55° C. to obtain a sodium salt solution of an organic acid. While keeping the sodium salt solution of an organic acid at a temperature of 55° C., silver halide emulsion-17 or -18 (containing 0.038 mol of silver) prepared above and 450 mL of pure water were added and the resulting solution was stirred. To this solution, 760.6 mL of a 1 mol/L silver nitrate solution was added over 2 minutes and the solution was further stirred for 20 minutes, thereby obtaining an organic silver salt dispersion. The obtained organic silver salt dispersion was transferred to a washing vessel and after adding deionized water, stirred and then left standing to float and separate the organic silver salt dispersion, and water-soluble salts in the lower part were removed. Subsequently, centrifugal dehydration was performed by repeating washing with deionized water and discharging of water until the electrical conductivity of discharged water became 2 μS/cm. Then, drying with warm air having an oxygen partial pressure of 10% by volume was performed at 40° C. in a circulating dryer until weight loss did not occur and thereby powdery organic silver salt containing photosensitive silver halide was obtained.

4) Preparation of Dispersion of Organic Silver Salt containing Photosensitive Silver Halide

In 1457 g of methyl ethyl ketone (MEK), 14.57 g of polyvinyl butyral powder (Butvar B-79, product by Monsant) was dissolved. While stirring the resulting solution by a dissolver-type homogenizer, 500 g of powdery organic silver salt prepared above was gradually added and thoroughly mixed to form a slurry.

This slurry was dispersed using a media dispersing machine filled in 80% by volume with 1 mm Zr beads (product by Toray Industries, Inc.) at a peripheral speed of 13 m and a retention in mill time of 0.5 minutes to obtain dispersion of organic silver salt.

5) Preparation of Coating Solution for Image Forming Layer

In 500 g of the dispersion of organic silver salt containing photosensitive silver halide prepared above, 100 g of MEK was added while stirring in a nitrogen stream. The resulting solution was kept at 24° C. Thereto, 2.5 mL of a 10% by weight methanol solution of Antifoggant 1 shown below was added and stirred for 15 minutes. Furthermore, 1.8 mL of a solution containing a dye adsorption promoter shown below and potassium acetate at a mixing ratio of 1:5 (by weight) and having a dye adsorption promoter concentration of 20% by weight was added and stirred for 15 minutes. Thereafter, 7 mL of a mixed solution of infrared sensitizing dye (No. 41), 4-chloro-2-benzoyl benzoic acid and 5-methyl-2-mercapto-benzimidazole as a supersensitizer (mixing ratio=1:250:20 by weight; concentration of infrared sensitizing dye: 0.1 by weight methanol solution).

Then, the compound having an adsorptive group and a reducible group of the present invention Nos. (19), (49) and (71) were added to each of the photothermographic material as shown in Table 8 respectively in an amount of 8×10⁻³ mol per one mol of silver halide, and further the compounds Nos. 2, 20 and 26 of Group 1 to 5 were added respectively in an amount of 2×10⁻³ mol per one mol of silver halide and stirred for one hour. After lowering the temperature to 13° C., the solution was further stirred for 30 minutes. While keeping the solution at 13° C., 48 g of polyvinyl butyral was added and thoroughly dissolved. Thereafter, the following additives were added. All these oparations were done under a current of nitrogen.

| | | |
|---|---|---|
| Phthalazine | 1.5 | g |
| Tetrachlorophthalic acid | 0.5 | g |
| 4-Methylphthalic acid | 0.5 | g |
| Dye 2 | 2.0 | g |
| Reducing agent (1,1-bis(2-hydroxy-3,5- | 15 | g |
| dimethylphenyl)-3,5,5-trimethylhexane) | | |
| Desmodur N3300 (aliphatic isocyanate, | 1.10 | g |
| produced by MOBEY) | | |
| 2-(tribromomethylsulfonyl)-pyridine | 1.55 | g |
| Antifoggant 2 | 0.9 | g |

Dye Adsorption Promoter: 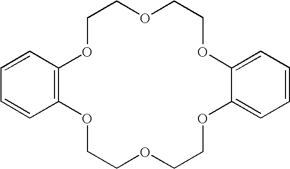
Antifoggant 1: 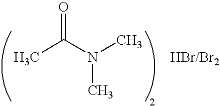
Dye 2: 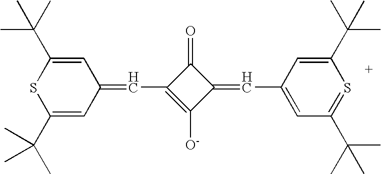
Antifoggant 2:

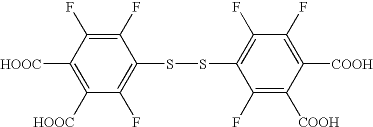

6) Preparations of Photothermographic Material-149 to -168

Image Forming Layer: The solution for image forming layer prepared above was coated on the support opposite the back layer of the same support as in Example 2 where the back layer was coated, such that the coated silver amount became 1.8 g/m² to prepare the photothermographic material-149 to -168.

Surface Protective Layer: The coating solution shown below was coated to have a wet thickness of 100 μm.

| Acetone | 175 | mL |
|---|---|---|
| 2-Propanol | 40 | mL |
| Methanol | 15 | mL |
| Cellulose acetate | 8 | g |
| Phthalazine | 1.5 | g |
| 4-Methylphthalic acid | 0.72 | g |
| Tetrachlorophthalic acid | 0.22 | g |
| Tetrachlorophthalic anhydride | 0.5 | g |
| Monodisperse silica having an average | 1% by | |
| particle size of 4 μm (standard | weight | |
| deviation: 20%) | based on | |
| | binder | |
| Fluorocarbon Polymer Surfactant C same | 0.5 | g |
| as in Example 2 | | |

7) Evaluation of Performance

As for each of the photothermographic material-149 to -168, exposure and thermal development were executed and evaluations were performed in the same manner as in Example 2. Results are shown in Table 8.

TABLE 8

| | | | Compound having | | | | |
|---|---|---|---|---|---|---|---|
| Photothermographic | Silver halide | Iridium | adsorptive group and | Compound of | | Image stability | Storability |
| material No. | emulsion | (mol/molAg) | reducible group | Groups 1 to 5 | Sensitivity | (Δ Dmin1) | (Δ Dmin2) |
| 149 | 17 | 1 × 10⁻⁴ | — | — | 120 | 0.15 | 0.05 |
| 150 | 17 | 1 × 10⁻⁴ | — | (2)(20)(26) | 170 | 0.10 | 0.04 |
| 151 | 18 | — | — | — | 90 | 0.18 | 0.04 |
| 152 | 18 | — | — | (2)(20)(26) | 100 | 0.13 | 0.03 |
| 153 | 17 | 1 × 10⁻⁴ | (19) | — | 180 | 0.06 | 0.02 |
| 154 | 17 | 1 × 10⁻⁴ | (19) | (2)(20)(26) | 230 | 0.05 | 0.01 |
| 155 | 18 | — | (19) | — | 120 | 0.15 | 0.04 |
| 156 | 18 | — | (19) | (2)(20)(26) | 130 | 0.12 | 0.03 |
| 157 | 17 | 1 × 10⁻⁴ | (49) | — | 170 | 0.06 | 0.02 |
| 158 | 17 | 1 × 10⁻⁴ | (49) | (2)(20)(26) | 220 | 0.05 | 0.01 |
| 159 | 18 | — | (49) | — | 110 | 0.15 | 0.04 |
| 160 | 18 | — | (49) | (2)(20)(26) | 120 | 0.12 | 0.03 |
| 161 | 17 | 1 × 10⁻⁴ | (71) | — | 180 | 0.06 | 0.02 |
| 162 | 17 | 1 × 10⁻⁴ | (71) | (2)(20)(26) | 230 | 0.05 | 0.01 |
| 163 | 18 | — | (71) | — | 120 | 0.15 | 0.04 |
| 164 | 18 | — | (71) | (2)(20)(26) | 130 | 0.12 | 0.03 |
| 165 | 17 | 1 × 10⁻⁴ | (19)(49)(71) | — | 250 | 0.05 | 0.01 |
| 166 | 17 | 1 × 10⁻⁴ | (19)(49)(71) | (2)(20)(26) | 320 | 0.04 | 0.01 |
| 167 | 18 | — | (19)(49)(71) | — | 120 | 0.13 | 0.03 |
| 168 | 18 | — | (19)(49)(71) | (2)(20)(26) | 130 | 0.10 | 0.03 |

As seen in the results shown in Table 8, the photothermographic material-153, -154, -157, 158, -161, -162, -165 and -166 of the present invention maintain high sensitivity and exhibits excellent image stability and excellent storability. Particularly, using the compound having an adsorptive group and a reducible group gives an effect of maitaining high sensitivity and excellent image stability, however the effect was small in the case using silver halide emulsion not containing iridium, but in the case using silver halide emulsion containing iridium the effect was particular evident. This effect by using the compound having an adsorptive group and a reducible group in combination with iridium was the one that could not be expected from conventional knowledge.

What is claimed is:

1. A photothermographic material comprising, on a support, a photosensitive silver halide, a non-photosensitive organic silver salt, a reducing agent and a binder, wherein the photothermographic material comprises a compound having a group adsorptive to silver halide and a reducible group or a precursor of the compound, a silver behenate content of the non-photosensitive organic silver salt is at least 30% by mole and less than 80% by mole, and the binder has a glass transition temperature (Tg) of 45° C. or higher.

2. The photothermographic material according to claim 1, wherein a silver iodide content of the photosensitive silver halide is 5% by mole or more.

3. The photothermographic material according to claim 2, wherein the silver iodide content of the photosensitive silver halide is 30% by mole or more.

4. The photothermographic material according to claim 3, wherein the silver iodide content of the photosensitive silver halide is 70% by mole or more.

5. The photothermographic material according to claim 4, wherein the silver iodide content of the photosensitive silver halide is 90% by mole or more.

6. The photothermographic material according to claim 1, wherein an average grain size of the photosensitive silver halide is 5 nm to 80 nm.

7. The photothermographic material according to claim 6, wherein the average grain size of the photosensitive silver halide is 10 nm to 55 nm.

8. The photothermographic material according to claim 1, wherein the binder comprises polyvinyl butyral in an amount of 50% by weight or more.

9. A photothermographic material comprising, on a support, an image forming layer comprising at least a photosensitive silver halide, a non-photosensitive organic silver salt, a reducing agent and a binder, wherein the photothermographic material comprises a compound having an adsorptive group and a reducible group, or a precursor of the compound, and the photosensitive silver halide comprises iridium.

10. The photothermographic material according to claim 9, wherein the amount of iridium is 1×10⁻⁸ mol to 1×10⁻¹ mol per one mol of the silver halide.

11. The photothermographic material according to claim 10, wherein the amount of iridium is 1×10⁻⁶ mol to 1×10⁻³ mol per one mol of the silver halide.

12. The photothermographic material according to claim 9, wherein the photothermographic material comprises a compound that can be one-electron-oxidized to provide a one-electron oxidation product which releases one or more electrons due to a subsequent reaction.

13. The photothermographic material according to claim 12, wherein the compound that can be one-electron-oxidized is selected from the following compounds of Groups 1 to 5:
(Group 1) a compound that can be one-electron-oxidized to provide a one-electron oxidation product which further releases at least two electrons, due to being subjected to a subsequent bond cleavage reaction;
(Group 2) a compound that has at least two groups adsorptive to the silver halide and can be one-electron-oxidized to provide a one-electron oxidation product which further releases one electron, due to being subjected to a subsequent bond cleavage reaction;
(Group 3) a compound that can be one-electron-oxidized to provide a one-electron oxidation product, which further releases at least one electron after being subjected to a subsequent bond formation;
(Group 4) a compound that can be one-electron-oxidized to provide a one-electron oxidation product which further releases at least one electron after a subsequent intramolecular ring cleavage reaction; and
(Group 5) a compound represented by X—Y, in which X represents a reducible group and Y represents a leaving group, and convertable by one-electron-oxidizing the reducible group to a one-electron oxidation product which can be converted into an X radical by eliminating the leaving group in a subsequent X—Y bond cleavage reaction, one electron being released from the X radical.

14. The photothermographic material according to claim 9, wherein the photothermographic material comprises at least one spectral sensitizer represented by any one of the following formulae (3a) to (3d): 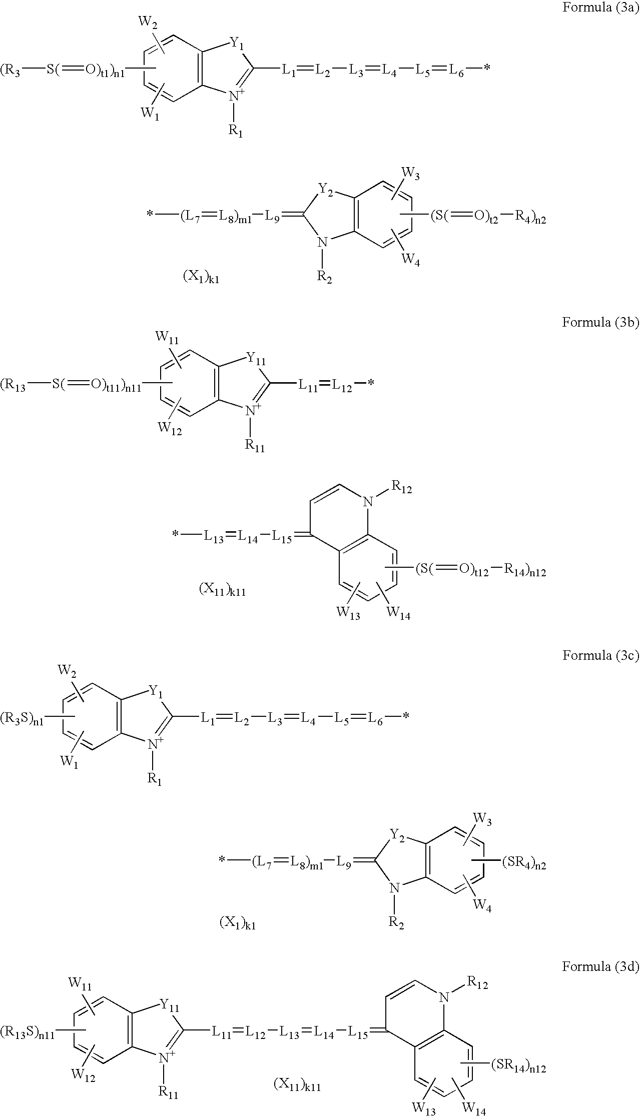
wherein, Y₁, Y₂ and Y₁₁ each represent an oxygen atom, a sulfur atom, a selenium atom or a —CH═CH— group; L₁ to L₉ and L₁₁ to L₁₅ each represent a methine group; R₁, R₂, R₁₁ and R₁₂ each represent an aliphatic group; R₃, R₄, R₁₃ and R₁₄ each represent a lower alkyl group, a cycloalkyl group, an alkenyl group, an aryl group or a heterocyclic group; W₁, W₂, W₃, W₄, W₁₁, W₁₂, W₁₃ and W₁₄ each represent a hydrogen atom or a substituent, or alternatively together represent a group of nonmetallic atoms required to form a condensed ring by bonding between W₁ and W₂, W₃ and W₄, W₁₁ and W₁₂, and W₁₃ and W₁₄, respectively, or a group of nonmetallic atoms required to form a 5- or 6-membered condensed ring R₃ and W₁, R₃ and W₂, R₁₃ and W₁₁, R₁₃ and W₁₂, R₄ and W₃, R₄ and W₄, R₁₄ and W₁₃, and R₁₄ and W₁₄, respectively; X₁ and X₁₁ each represent an ion necessary for neutralizing a charge in a molecule; k1 and k11 each represent a number of ions necessary for neutralizing a charge in a molecule; m1 represents 0 or 1; n1, n2, n11 and n12 each represent 0, 1 or 2, provided that at least one of n1 and n2 represents 1 or 2, and that at least one of n11 and n12 represents 1 or 2; and that t1, t2, t11 and t12 each represent 1 or 2.

15. The photothermographic material according to claim 9, wherein the image forming layer is formed by coating the support with a coating solution for an image forming layer prepared by at least the following 1) and 2):
1) preparing the photosensitive silver halide; and
2) preparing the non-photosensitive organic silver salt.

16. The photothermographic material according to claim 15, wherein the photosensitive silver halide is added while preparing the non-photosensitive organic silver salt.

17. The photothermographic material according to claim 9, wherein a silver iodide content of the photosensitive silver halide is 5% by mole or more.

18. The photothermographic material according to claim 17, wherein the silver iodide content of the photosensitive silver halide is 40% by mole or more.
